(19) United States
(12) Patent Application Publication
(10) Pub. No.: US 2013/0271905 A1
(43) Pub. Date: Oct. 17, 2013

(54) SYSTEMS AND METHODS FOR PROVIDING DYNAMIC COMPUTING SYSTEMS

(71) Applicant: Jason A. Sullivan, Youngstown, OH (US)

(72) Inventor: Jason A. Sullivan, Youngstown, OH (US)

(21) Appl. No.: 13/674,797

(22) Filed: Nov. 12, 2012

Related U.S. Application Data
(63) Continuation-in-part of application No. 13/154,325, filed on Jun. 6, 2011.
Application No. 13/154,325 is a continuation-in-part of application No. 12/795,439, filed on Jun. 7, 2010.
Application No. 12/795,439 is a continuation of application No. 11/827,360, filed on Jul. 9, 2007, now Pat. No. 7,733,635.
Application No. 11/827,360 is a continuation of application No. 10/692,005, filed on Oct. 22, 2003, now Pat. No. 7,242,574.
Application No. 13/154,325 is a continuation-in-part of application No. 12/843,304, filed on Jul. 26, 2010.
Application No. 12/843,304 is a continuation of application No. 11/483,956, filed on Jul. 10, 2006, now Pat. No. 7,764,506.
Application No. 11/483,956 is a division of application No. 10/691,114, filed on Oct. 22, 2003, now Pat. No. 7,075,784.
Application No. 13/154,325 is a continuation-in-part of application No. 12/906,836, filed on Oct. 18, 2010, now Pat. No. 8,405,969.
Application No. 12/906,836 is a continuation of application No. 11/833,852, filed on Aug. 3, 2007, now Pat. No. 7,817,412.
Application No. 11/833,852 is a continuation of application No. 10/691,473, filed on Oct. 22, 2003, now Pat. No. 7,256,991.
(60) Provisional application No. 61/558,422, filed on Nov. 10, 2011.
(60) Provisional application No. 60/420,127, filed on Oct. 22, 2002.
(60) Provisional application No. 60/455,789, filed on Mar. 19, 2003.
(60) Provisional application No. 60/420,127, filed on Oct. 22, 2002.
(60) Provisional application No. 60/455,789, filed on Mar. 19, 2003.
(60) Provisional application No. 60/420,127, filed on Oct. 22, 2002.
(60) Provisional application No. 60/455,789, filed on Mar. 19, 2003.
(60) Provisional application No. 61/407,904, filed on Oct. 28, 2010.
(60) Provisional application No. 61/352,349, filed on Jun. 7, 2010.
(60) Provisional application No. 61/352,351, filed on Jun. 7, 2010.
(60) Provisional application No. 61/352,357, filed on Jun. 7, 2010.
(60) Provisional application No. 61/352,359, filed on Jun. 7, 2010.
(60) Provisional application No. 61/352,363, filed on Jun. 7, 2010.
(60) Provisional application No. 61/352,369, filed on Jun. 7, 2010.
(60) Provisional application No. 61/352,378, filed on Jun. 7, 2010.
(60) Provisional application No. 61/352,379, filed on Jun. 7, 2010.
(60) Provisional application No. 61/352,362, filed on Jun. 7, 2010.
(60) Provisional application No. 61/352,368, filed on Jun. 7, 2010.
(60) Provisional application No. 61/352,372, filed on Jun. 7, 2010.
(60) Provisional application No. 61/352,384, filed on Jun. 7, 2010.
(60) Provisional application No. 61/352,381, filed on Jun. 7, 2010.
(60) Provisional application No. 61/352,358, filed on Jun. 7, 2010.
(60) Provisional application No. 61/352,383, filed on Jun. 7, 2010.

(51) Int. Cl. G06F 1/16

(52) U.S. Cl. CPC G06F 1/16
USPC 361/679.02

(57) ABSTRACT

The present invention relates to systems and methods for providing a universal computing system. Implementations include a modular motherboard having two or more electronic circuit boards that are connected to form a motherboard. The two or more electronic circuit boards each include a security key structure on a connector for providing a keyed connector therebetween. Computing components may be provided on two of the major surfaces of the first electronic circuit board circuit board. Components are disclosed in which the computing system will not turn on unless the first printed circuit board is electrically connected to the second printed circuit board. A heat sink is disclosed that may be used in the universal computing system. A customizable encasement is disclosed. An expandable memory device is disclosed.

### RELATED APPLICATIONS

This application claims priority to U.S. Provisional Patent Application Ser. No. 61/558,422 filed Nov. 10, 2011, entitled “SYSTEMS AND METHODS FOR PROVIDING DYNAMIC COMPUTING SYSTEMS” and this application is a continuation in part of U.S. patent application Ser. No. 13/154,325 filed Jun. 6, 2011, entitled “SYSTEMS AND METHODS FOR PROVIDING A UNIVERSAL COMPUTING SYSTEM,” which is a continuation in part of U.S. patent application Ser. No. 12/795,439 filed Jun. 7, 2010, entitled “SYSTEMS AND METHODS FOR PROVIDING A ROBUST COMPUTER PROCESSING UNIT,” which claims priority to U.S. patent application Ser. No. 11/827,360, which was filed on Jul. 9, 2007 and entitled “SYSTEMS AND METHODS FOR PROVIDING A ROBUST COMPUTER PROCESSING UNIT,” and issued on Jun. 8, 2010 as U.S. Pat. No. 7,733,635, which claims priority to U.S. patent application Ser. No. 10/692,005, which was filed on Oct. 22, 2003 and entitled “ROBUST CUSTOMIZABLE COMPUTER PROCESSING SYSTEM,” and which issued on Jul. 10, 2007 as U.S. Pat. No. 7,242,574, which claims priority to U.S. Provisional Patent Application Ser. No. 60/420,127, filed Oct. 22, 2002, entitled, “NON-PERIPHERALS PROCESSING CONTROL UNIT HAVING IMPROVED HEAT DISSIPATING PROPERTIES” and also claims priority to U.S. Provisional Patent Application Ser. No. 60/455,789, filed Mar. 19, 2003, entitled, “SYSTEMS AND METHODS FOR PROVIDING A DURABLE AND DYNAMICALLY MODULAR PROCESSING UNIT,” which are all expressly incorporated herein by reference in their entireties.

U.S. patent application Ser. No. 13/154,325 is also a continuation in part of U.S. patent application Ser. No. 12/843,304, filed Jul. 26, 2010, entitled “SYSTEMS AND METHODS FOR PROVIDING A DYNAMICALLY MODULAR PROCESSING UNIT,” which claims priority to U.S. patent application Ser. No. 11/483,956 filed Jul. 10, 2006, entitled “SYSTEMS AND METHODS FOR PROVIDING A DYNAMICALLY MODULAR PROCESSING UNIT,” which is a divisional application of U.S. patent application Ser. No. 10/691,114 filed Oct. 22, 2003, entitled “SYSTEMS AND METHODS FOR PROVIDING A DYNAMICALLY MODULAR PROCESSING UNIT,” now issued as U.S. Pat. No. 7,075,784 which claims priority to U.S. Provisional Patent Application Ser. No. 60/420,127 filed Oct. 22, 2002 entitled “NON-PERIPHERALS PROCESSING CONTROL UNIT HAVING IMPROVED HEAT DISSIPATING PROPERTIES” and to U.S. Provisional Patent Application Ser. No. 60/455,789 filed Mar. 19, 2003 entitled “SYSTEMS AND METHODS FOR PROVIDING A DURABLE AND DYNAMICALLY MODULAR PROCESSING UNIT,” which are all incorporated herein by reference, and is related to issued U.S. Pat. No. 7,256,991 filed Oct. 22, 2003, entitled “NON-PERIPHERALS PROCESSING CONTROL MODULE HAVING IMPROVED HEAT DISSIPATING PROPERTIES”, and is related to issued U.S. Pat. No. 7,242,574 filed Oct. 22, 2003, entitled “ROBUST CUSTOMIZABLE COMPUTER PROCESSING SYSTEM”, which are all expressly incorporated herein by reference in their entireties.

U.S. patent application Ser. No. 13/154,325 is also a continuation in part of U.S. patent application Ser. No. 12/906,836 filed Oct. 18, 2010, entitled “NON-PERIPHERALS PROCESSING CONTROL MODULE HAVING IMPROVED HEAT DISSIPATING PROPERTIES”, which claims priority to U.S. patent application Ser. No. 11/833,852, filed Aug. 3, 2007, entitled “NON-PERIPHERALS PROCESSING CONTROL MODULE HAVING IMPROVED HEAT DISSIPATING PROPERTIES,” which is a continuation application of U.S. patent application Ser. No. 10/691,473, filed Oct. 22, 2003, entitled “NON-PERIPHERALS PROCESSING CONTROL MODULE HAVING IMPROVED HEAT DISSIPATING PROPERTIES,” now issued as U.S. Pat. No. 7,256,991, which claims priority to U.S. Provisional Application Ser. No. 60/420,127, filed Oct. 22, 2002, entitled “NON-PERIPHERALS PROCESSING CONTROL UNIT HAVING IMPROVED HEAT DISSIPATING PROPERTIES,” and to U.S. Provisional Application Ser. No. 60/455,789, filed Mar. 19, 2003, entitled “SYSTEMS AND METHODS FOR PROVIDING A DURABLE AND DYNAMICALLY MODULAR PROCESSING UNIT,” which are all expressly incorporated herein by reference in their entireties.

U.S. patent application Ser. No. 13/154,325 also claims priority to the following provisional applications: Ser. No. 61/407,904 (Attorney Docket Number: 11072.268) titled “MODULAR VIRTUALIZATION IN COMPUTER SYSTEMS” filed Oct. 28, 2010, Ser. No. 61/352,349 (Attorney Docket Number: 11072.239) titled “SYSTEMS AND METHODS FOR OPTIMIZING MEMORY PERFORMANCE” filed Jun. 7, 2010, Ser. No. 61/352,351 (Attorney Docket Number: 11072.240) titled “SYSTEMS AND METHODS FOR PROVIDING MULTI-LINK DYNAMIC PCIE PARTITIONING” filed Jun. 7, 2010, Ser. No. 61/352,357 (Attorney Docket Number: 11072.241) titled “TRACKING APPARATUS” filed Jun. 7, 2010, Ser. No. 61/352,359 (Attorney Docket Number: 11072.242) titled “MINIATURIZED POWER SUPPLY” filed Jun. 7, 2010, Ser. No. 61/352,363 (Attorney Docket Number: 11072.243) titled “SYSTEMS AND METHODS FOR PROVIDING MULTI-LINK DYNAMIC VIDEO PARTITIONING” filed Jun. 7, 2010, Ser. No. 61/352,369 (Attorney Docket Number: 11072.244) titled “SYSTEMS AND METHODS FOR PROVIDING A PIN GRID ARRAY TO BALL GRID ARRAY ADAPTER” filed Jun. 7, 2010, Ser. No. 61/352,378 (Attorney Docket Number: 11072.245) titled “SYSTEMS AND METHODS FOR ACTIVATING MULTICOLOR LIGHT EMITTING DIODES” filed Jun. 7, 2010, Ser. No. 61/352,379 (Attorney Docket Number: 11072.246) titled “SYSTEMS AND METHODS FOR PROVIDING CONNECTIVITY” filed Jun. 7, 2010, Ser. No. 61/352,362 (Attorney Docket Number: 11072.247) titled “SYSTEMS AND METHODS FOR INTELLIGENT AND FLEXIBLE MANAGEMENT AND MONITORING OF COMPUTER SYSTEMS” filed Jun. 7, 2010, Ser. No. 61/352,368 (Attorney Docket Number: 11072.248) titled “MULTI-LINK DYNAMIC BUS PARTITIONING” filed Jun. 7, 2010, Ser. No. 61/352,372 (Attorney Docket Number: 11072.249) titled “MULTI-LINK DYNAMIC STORAGE PARTITIONING” filed Jun. 7, 2010, Ser. No. 61/352,384 (Attorney Docket Number: 11072.250) titled “LOAD BALANCING MODULAR COOLING SYSTEM” filed Jun. 7, 2010, Ser. No. 61/352,381 (Attorney Docket Number: 11072.251) titled “SYSTEMS AND METHODS FOR WIRELESSLY RECEIVING COMPUTER SYSTEM DIAGNOSTIC INFORMATION” filed Jun. 7, 2010, Ser. No. 61/352,358 (Attorney Docket Number: 11072.252) titled “SYSTEMS AND METHODS FOR PROVIDING A CUSTOMIZABLE COMPUTER PROCESSING UNIT” filed Jun. 7, 2010, Ser. No. 61/352,383 (Attorney Docket Number: 11072.253) titled “SYSTEMS AND METHODS FOR MOUNTING” filed Jun. 7, 2010, which are all expressly incorporated herein by reference in their entireties.

### BACKGROUND

1. Field of the Invention

The present invention relates to computer processors and processing systems, computer housings, and computer encasement modules. In particular, the present invention relates to a non-peripherals-based computer processor and processing system configured within a proprietary encasement module and having a proprietary electrical printed circuit board configuration and other electrical components existing in a proprietary design. Still further, the present invention relates to a robust customizable computer processing unit and system designed to introduce intelligence into various structures, devices, systems, and other items said items, as well as to provide unique computer operating environments.

2. Background

As one of the most influential technologies in either the modern or historical world, computers and computer systems have significantly altered the way we conduct and live our lives, and have accelerated technological advancement to an exponential growth pace. Indeed, computers and computing systems play an indispensable role in driving invention, enabling lightning speed technological advancement, simplifying tasks, recording and storing data, connecting the world, as well as numerous other applications in virtually every industry and every country around the world. Indeed, the computer has become an indispensable tool for individuals, businesses, and governments alike. Since its inception, the computer and computing systems have undergone significant evolutionary changes. The small, powerful modern systems in use today are virtually incomparable to their ancestral counterparts of yesteryear.

Although the evolution of the processing capabilities of computers and computing systems reveals an exponential growth pattern, the physical and structural characteristics of these systems, namely the cases or encasement modules housing such electrical components as the processing (printed circuit boards, mother boards, etc.) and the peripheral components (hard drives, CD/DVD-ROM drives, sound cards, video cards, etc.) has unfortunately been limited to marginal improvement, with design considerations dictated by needed functionality, workability, and various component inclusion and associated design constraints. Computers and computing systems of today have not been able to shed the large, bulky encasement modules that support the processing and other components.

Conventional computer systems and their encasement modules, namely desktops, servers, and other similar computers or computing systems, while very functional and very useful, are large and bulky due to several reasons, one being that they are designed to comprise all of the components and peripheral devices necessary to operate the computer system, except the various external devices such as a monitor, a keyboard, a mouse, and the like. Indeed, partly to blame for the proliferation and slow evolution of the large and bulky computer encasement module is the perceived convenience of bundling both processing components and peripheral components within a neat, easy-to-use, single package. Such encasement modules have a rather large footprint, are heavy, and do not lend themselves to mobility or environmental adaptability. However, little has been done to move away from this and such systems are commonplace and accepted. For example, server systems are typically found within some type of area or space or room specifically designed to house the box-like structure; desktop computers occupy a significant amount of space of workstations, with their presence sometimes concealed within desks; or, some computers are left out in the open because there is nowhere else to place them.

While obviously there are a significant number of advantages and benefits, there are several problems or flaws, both inherent and created, associated with conventional computers and computing systems and the encasement modules comprising such. First, they are aesthetically displeasing as they take up space, require multiple cords, and generally look out of place with furniture and other décor. Second, they are noisy and produce or radiate large amounts of noise and heat when in operation as generated from the processing and peripheral components contained therein. Third, they provide fertile ground for dust, debris, insects, and various other foreign objects. Fourth, they are difficult to keep clean, particularly the internal components. Fifth, they produce a great deal of radiation in the form of electromagnetic interference. Sixth, they do not lend themselves to environmental or situational adaptability, meaning they are one-dimensional in function, namely to perform only computing functions. Seventh, they are not easily scalable, meaning that it is difficult to couple multiple computers together to achieve increased processing capabilities, especially without ample space or real estate. Eighth, the size and number of existing components require forced cooling systems, such as one or multiple fans, to dissipate heat from the interior of the system. Ninth, they comprise a peripheral-based system that requires all the peripherals to be operable simultaneously without giving the user the ability to interchange any one peripheral or all of the peripherals as desired. Tenth, while some peripheral devices may be interchangeable, some are not. These peripherals, such as the hard drive, are permanent, fixed structures.

Another significant disadvantage with conventional computers and computing systems is their inability to be easily adaptable to various environments or placed into existing systems, devices, etc. to enable a “smart” system. Conventional computers sit on the floor or in a desk and operate in a limited manner. In addition, conventional computers are not designed to be integrated within or as part of a structure or device to introduce intelligence into the structure or device. Still further, conventional computers do not possess any significant load bearing capabilities that allow them to serve as support members, nor do they lend themselves to providing customizable work station environments.

Lastly, the means for dissipating heat or means for cooling the components of conventional computers and computing systems presents several disadvantages. In almost all cases, heat dissipation or cooling is achieved by some type of forced cooling system. This typically means placing or mounting one or more blowers or fans within the interior and providing means for ventilating the circulated air, such as by forming slits within the walls of the encasement module. Indeed, most of the computer encasements currently in existence require the use of a forced cooling system to dissipate heat and to cool the interior of the computer where the processing components are located to preserve or maintain acceptable temperatures for component operation. Moreover, as most of the peripheral devices used are found within the interior, the encasement modules tend to be rather large, having a relatively large interior volume of space. As a result, the thermal discharge from the processing components is essentially trapped within this volume of space because there is no way for the air to escape. Therefore, various mechanical devices, such as blowers or fans, are incorporated into conventional encasement modules to circulate the air and dissipate heat from the interior to the outside air, which causes undesirable increase in temperature in the room where the computer is located.

Accordingly, what is needed is a robust computer and computer system that is capable of being customized to perform computing functions within a wide range of new and existing environments to provide increased adaptability, usability, and functionality within these environments.

### SUMMARY

In light of the deficiencies in conventional computers and computing systems discussed above, the present invention provides a new and novel computer and computing system that improves upon these designs. Particularly, the preferred exemplary embodiments of the present invention improve upon existing computers and computing systems and methods, and can, in some instances, be used to overcome one or more problems associated with or related to such existing systems and methods.

In accordance with the invention as embodied and broadly described herein, the present invention features a robust customizable computing system comprising: a processing control unit; an external object; and means for operably connecting the processing control unit to the external object, the processing control unit introducing intelligence into the external object, thus causing the external object to perform smart functions.

In a preferred embodiment, the processing control unit comprises: (a) an encasement module comprising a main support chassis having a plurality of wall supports and a plurality of junction centers containing means for supporting a computer component therein, a dynamic back plane that provides support for connecting peripheral and other computing components directly to a system bus without requiring an interface, means for enclosing the main support chassis and providing access to an interior portion of the encasement module; (b) one or more computer processing components disposed within the junction centers of the encasement module; and (c) means for cooling the interior portion of the encasement module.

As provided above, embodiments of the present invention are extremely versatile. As further examples, the processing control unit may be used to physically support and/or provide processing to various fixtures, devices, and/or inanimate objects, such a lighting fixture, an electrical outlet, a house appliance, or a breaker box. As provided herein, at least some embodiments of the present invention embrace a processing unit that functions as an engine that drives and controls the operation of a variety of components, structures, assemblies, equipment modules, etc. and enables smart functions within these.

Embodiments of the present invention embrace a platform that may be employed in association with all types of enterprise applications, particularly computer and/or electrical enterprises. The platform allows for a plurality of modifications that may be made with minimal impact to the processing control unit, thereby enhancing the usefulness of the platform across all types of applications and environments. Moreover, the processing control unit may function alone or may be associated with other similar processing control units in a robust customizable computing system to provide enhanced processing capabilities.

While the methods and processes of the present invention have proven to be particularly useful in the area of personal computing enterprises, those skilled in the art can appreciate that the methods and processes of the present invention can be used in a variety of different applications and in a variety of different areas of manufacture to yield robust customizable enterprises, including enterprises for any industry utilizing control systems or smart-interface systems and/or enterprises that benefit from the implementation of such devices. Examples of such industries include, but are not limited to, automotive industries, avionic industries, hydraulic control industries, auto/video control industries, telecommunications industries, medical industries, special application industries, and electronic consumer device industries. Accordingly, the systems and methods of the present invention provide massive computing power to markets, including markets that have traditionally been untapped by current computer techniques.

The present invention further features a method for introducing intelligence into an external object and enabling smart functions therein. The method comprises: obtaining an external object; operably connecting a processing control unit to the external object; and initiating one or more computing functions within the processing control unit to cause the external object to perform smart functions.

These and other features and advantages of the present invention will be set forth or will become more fully apparent in the description that follows. The features and advantages may be realized and obtained by means of the instruments and combinations provided herein. Furthermore, the features and advantages of the invention may be learned by the practice of the invention or will be obvious from the description, as set forth hereinafter.

### BRIEF DESCRIPTION OF THE DRAWINGS

In order to set forth the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a block diagram that provides a representative modular processing unit connected to peripherals to provide a representative computing enterprise in accordance with the present invention;

FIG. 2 illustrates a representative embodiment of a durable and dynamically modular processing unit;

FIG. 3A illustrates another view of the embodiment of FIG. 2 having a non-peripheral based encasement, a cooling process (e.g., thermodynamic convection cooling, forced air, and/or liquid cooling), an optimized layered printed circuit board configuration, optimized processing and memory ratios, and a dynamic back plane that provides increased flexibility and support to peripherals and applications;

FIGS. 3B-3C illustrate other representative embodiments;

FIG. 4 illustrates a representative enterprise wherein a dynamically modular processing unit, having a non-peripheral based encasement, is employed alone in a personal computing enterprise;

FIG. 5 illustrates a representative enterprise wherein a dynamically modular processing unit, having a non-peripheral based encasement, is employed in another representative computing enterprise;

FIG. 6 illustrates another representative enterprise similar to FIG. 5 that includes additional peripherals, such as removable drives or other modular peripherals;

FIG. 7 illustrates another representative enterprise wherein a dynamically modular processing unit is utilized in an electronic enterprise;

FIG. 8 illustrates another representative enterprise, wherein a dynamically modular processing unit is utilized as a handheld enterprise;

FIG. 9 illustrates a utilization of the embodiment of FIG. 8 in another representative enterprise;

FIG. 10 illustrates another representative handheld enterprise having a non-peripheral based encasement combined with an external flip-up I/O peripheral;

FIG. 11 illustrates another view of the embodiment of FIG. 10;

FIG. 12 illustrates a representative enterprise wherein a dynamically modular processing unit is employed in a representative consumer electrical device;

FIG. 13 illustrates another representative enterprise wherein a dynamically modular processing unit is employed in a representative electrical device;

FIG. 14 illustrates a representative enterprise wherein one or more dynamically modular processing units are employed in another electrical device;

FIG. 15 illustrates a representative enterprise wherein one or more dynamically modular processing units are employed in another representative device;

FIG. 16 illustrates a representative enterprise wherein multiple dynamically modular processing units, each having a non-peripheral based encasement, are oriented and employed in a computing enterprise to provide increased processing capabilities;

FIG. 17 illustrates a representative embodiment of a modular motherboard having a motherboard connector;

FIG. 18 illustrates a representative embodiment of a modular motherboard connector;

FIG. 19 illustrates a three-dimensional representative embodiment of a modular motherboard connector;

FIG. 20 illustrates another three-dimensional representative embodiment of a modular motherboard connector;

FIG. 21 illustrates a modular motherboard according to one embodiment of the present invention;

FIG. 22 illustrates the modular motherboard of FIG. 21 with two portions of the modular motherboard assembled, according to one embodiment of the present invention;

FIG. 23 illustrates the modular motherboard of FIG. 22 with all three portions of the modular motherboard assembled, according to one embodiment of the present invention;

FIG. 24 illustrates the modular motherboard of FIG. 23 with a back plate, according to one embodiment of the present invention;

FIG. 25 illustrates the modular motherboard of FIG. 24 with a computer chassis, according to one embodiment of the present invention;

FIG. 26 illustrates the modular motherboard of FIG. 24 with an endplate, according to one embodiment of the present invention;

FIG. 27 illustrates a perspective view of an assembled, non-peripherals computer encasement according to one embodiment of the present invention;

FIG. 28 illustrates another perspective view of the assembled non-peripherals computer encasement according to one embodiment of the present invention;

FIG. 29 illustrates a perspective view of a representative embodiment of a disassembled non-peripherals computer encasement, and particularly a main support chassis according to one embodiment of the present invention;

FIG. 30 illustrates an exploded side view of the main support chassis, as well as a plurality of inserts and a dynamic backplane according to one embodiment of the present invention;

FIG. 31 illustrates an end plate as designed to be coupled to an end of the main support chassis according to one embodiment of the present invention;

FIG. 32 illustrates an end cap designed to fit over and/or couple to an edge portion of the main support chassis according to one embodiment of the present invention;

FIG. 33 illustrates an expandable memory device for attachment to the dynamic backplane according to one embodiment of the present invention;

FIG. 34 illustrates a perspective view of a representative embodiment of the non-peripherals computer encasement comprising a representative embodiment of the dynamic backplane having one or more input/output ports and a power port located thereon to couple various components to the non-peripheral computer encasement;

FIGS. 35-38 illustrate plan views of several representative embodiments of the dynamic backplane;

FIG. 39 illustrates a diagram showing non-peripherals computer encasement controlling six visual displays according to one embodiment of the present invention;

FIG. 40 illustrates a perspective view of a representative embodiment of a tri-board circuit board configuration as coupled to or fit within the main support chassis of the non-peripherals computer encasement according to one embodiment of the present invention;

FIG. 41 illustrates a perspective view of a representative embodiment of the dynamic backplane interconnected to a printed circuit board;

FIG. 42 illustrates a plan view of a first electrical printed circuit board and a side-plan view and a top-plan view of a heat sink rail according to one embodiment of the present invention;

FIG. 43 illustrates a plan view of a computer on wheels (COW) with a process control unit in accordance with a representative embodiment of the present invention;

FIG. 44 illustrates a side view of a dynamic backplane with a pico-projector in accordance with a representative embodiment of the present invention;

FIG. 45 illustrates a block diagram of a processing control unit and two graphical processing units in accordance with a representative embodiment of the present invention;

FIG. 46 illustrates a cross-section view of a printed circuit board (“PCB”) and multiple heat-producing components in accordance with a representative embodiment of the present invention;

FIG. 47 illustrates a cross-section view of a unitary heat sink device coupled to a PCB and multiple heat-producing components in accordance with a representative embodiment of the present invention;

FIG. 48 illustrates an exploded, cross-section view of a modular heat sink device coupled to a PCB and multiple heat-producing components in accordance with a representative embodiment of the present invention;

FIG. 49 illustrates an exploded, cross-section view of a modular heat sink device having interchangeable diffusing duct plates in accordance with a representative embodiment of the present invention;

FIG. 50 illustrates an exploded, cross-section view of a modular heat sink device coupled to a multi-board PCB in accordance with a representative embodiment of the present invention;

FIG. 51 illustrates an exploded, cross-section view of a modular heat sink device having alignment features coupled to a PCB and multiple heat-producing components in accordance with a representative embodiment of the present invention;

FIGS. 52-58 illustrate various views of systems and methods for increasing airflow through a computer device in accordance with representative embodiments of the present invention;

FIG. 59 illustrates a perspective view of a representative mounting bracket on a computer display device in accordance with a representative embodiment of the present invention;

FIG. 60 illustrates a perspective view of a processing control unit mounted on the mounting bracket of FIG. 59 in accordance with a representative embodiment of the present invention;

FIG. 61 illustrates a perspective view of a representative mounting bracket component for the main support chassis in accordance with a representative embodiment of the present invention;

FIG. 62 illustrates another view of the representative mounting bracket of FIG. 61;

FIG. 63 illustrates a perspective view of a representative mounting bracket component for the main support chassis in accordance with a representative embodiment of the present invention;

FIG. 64 illustrates a perspective view of another representative mounting bracket component for the main support chassis in accordance with a representative embodiment of the present invention;

FIG. 65 illustrates a perspective view of another representative mounting bracket component for the main support chassis in accordance with a representative embodiment of the present invention;

FIG. 66 shows a representation of a computer system that can be used in conjunction with embodiments of the invention;

FIG. 67 shows a representative networked computer system that can be used in conjunction with embodiments of the invention;

FIG. 68 shows various representative configurations of a modular device according to embodiments of the invention;

FIGS. 69-73 show various views of portions of a housing of a modular device according to embodiments of the invention;

FIGS. 74-76 show various perspective views of a representative printed circuit board in a housing according to embodiments of a modular device;

FIGS. 77A-79 show views of a representative printed circuit board;

FIGS. 80A-80B show representative embodiments of mounting slots adapted to receive a T-shaped connector;

FIG. 81 shows a side view of a T-shaped connector disposed within a slot of a printed circuit board;

FIG. 82 illustrates a representative mobile system in accordance with embodiments of the invention;

FIG. 83 is a block diagram of a computer network in accordance with embodiments of the invention;

FIG. 84 is a representative application search appliance in accordance with an embodiment of the present invention;

FIG. 85 is an exploded view of a representative modular device;

FIG. 86 is a representative embodiment of a dynamic computer device; and

FIG. 87 is a representative circuit in accordance with an embodiment of the present invention.

### DETAILED DESCRIPTION

The present invention relates to systems and methods for providing a dynamically modular processing unit. In particular, embodiments of the present invention take place in association with a modular processing unit that is lightweight, compact, and is configured to be selectively used alone or oriented with one or more additional processing units in an enterprise.

In some embodiments, a modular processing unit includes a non-peripheral based encasement, a cooling process (e.g., thermodynamic convection cooling, forced air, and/or liquid cooling), an optimized layered printed circuit board configuration, optimized processing and memory ratios, and a dynamic back plane that provides increased flexibility and support to peripherals and applications.

The following disclosure of the present invention is grouped into eight subheadings, namely “A Modular Motherboard,” “A Modular Motherboard Connector,” “Customizable Computer Processing Unit,” “Customizable Chassis Design,” “Load Balancing Modular Cooling System,” “Systems and Methods for Mounting,” “Providing Computing Resources Using Modular Devices,” and “Software Installed on a Portable Hardware Device.” The utilization of the subheadings is for convenience of the reader only and is not to be construed as limiting in any sense.

### A Modular Motherboard

Modern computers and computing systems play an indispensable role in driving invention, enabling lightning speed technological advancement, simplifying tasks, recording and storing data, connecting the world, and enhancing innumerable applications in virtually every industry and every country around the world. Indeed, the computer has become an indispensable tool for individuals, businesses, and governments alike. Computing systems have been incorporated into innumerable machines, applications, and systems and have enhanced their functionality, efficiency, and speed, while reducing costs.

At the heart of modern computers and computing systems is the computer motherboard. A motherboard is the main circuit board in electronic, processing systems. The motherboard provides electronic connections by which components of a computing system operate. Historically, motherboards have been made of a single electronic circuit board, to which is attached the core components of the computer system. These core components generally include a processor or a socket into which a processor is installed, a clock, electronic memory or slots into which the system's main memory is installed, memory (typically non-volatile memory) containing the system's firmware or basic input/output system (“BIOS”), power connectors, and power circuits. In addition, some motherboards include slots for expansion cards, peripheral controllers, and connectors for peripheral devices.

Current motherboards only support minor upgrades and modifications to their components and configuration. For example, most motherboards only support a narrow range of processor types. If computer user wants to replace the current, supported processor with different type of processor he may need to replace the entire motherboard. Likewise, most motherboards don't allow a user to add an additional processor or add a processor that requires a different processor socket than that included on the motherboard. In these cases a user will need to replace the motherboard entirely.

By its very nature, the two-dimensional motherboard configuration limits the size of corresponding computer encasements. Two-dimensional motherboards require overly large encasements to keep out dust and house the motherboard, its components, a cooling system, and internal peripherals. Such encasements take up large amounts of office and desk space and are not easily portable.

In summary, current motherboard configurations are limited in their ability to adapt, to be upgraded, and to support various system components. Further current motherboard configurations impose size constraints on encasements and computing systems. Thus, it would be desirable to provide a motherboard that overcame the deficiencies of current motherboards.

In response to problems and needs in the art that have not yet been fully resolved by currently available motherboards, a modular motherboard and a method for providing a modular motherboard is presented herein. In particular, implementation of the present invention takes place in association with a modular motherboard that is made of two or more electronic circuit boards, each performing at least one designated function. The electronic circuit boards are operably coupled together as an integrated logic board that can be used in a computer or computing system. Exemplary functions include, processing, providing system memory, providing system storage, and providing system BIOS.

In one implementation, a processing unit includes a modular motherboard having a tri-board configuration. A first circuit board includes a processor and a memory device, a second circuit board includes system BIOS, and a third circuit board includes an electronic storage device. This processing unit can further include a non-peripheral based encasement and a dynamic backplane.

In another implementation, a processing unit includes a modular motherboard having a four-board configuration. A first circuit board includes a processor, a second circuit board includes a memory device, a third circuit board includes system BIOS, and a fourth circuit board includes an electronic storage device. This processing unit can also include a non-peripheral based encasement and a dynamic backplane.

In another implementation, a modular motherboard is connected together with motherboard connectors. These connectors have corresponding geometries which prevent noncompliant connectors from connecting to the motherboard. The connector geometry includes two sub-geometries: a connection sub-geometry and a security sub-geometry. The connection sub-geometry includes the necessary shapes, forms, and structure to mechanically and electrically connect with another motherboard connector. The security sub-geometry includes one or more security key structures that prevent the connector from mating with another motherboard connector that does not have a corresponding security key structure(s).

Implementation of the present invention provides a platform that may be employed in association with all types of computer enterprises. The platform allows for a plethora of modifications that may be made with minimal impact to the processing unit, thereby enhancing the usefulness of the platform across all type of applications.

While the methods and processes of the present invention have proven to be particularly useful in the area of personal computing enterprises, those skilled in the art will appreciate that the methods and processes of the present invention can be used in a variety of different applications and in a variety of different areas of manufacture to yield customizable enterprises, including enterprises for any industry utilizing control systems or smart-interface systems and/or enterprises that benefit from the implementation of such devices. Examples of such industries include, but are not limited to, automotive industries, avionic industries, hydraulic control industries, auto/video control industries, telecommunications industries, medical industries, special application industries, and electronic consumer device industries. Accordingly, the systems and methods of the present invention provide massive computing power to markets, including markets that have traditionally been untapped by current computer techniques.

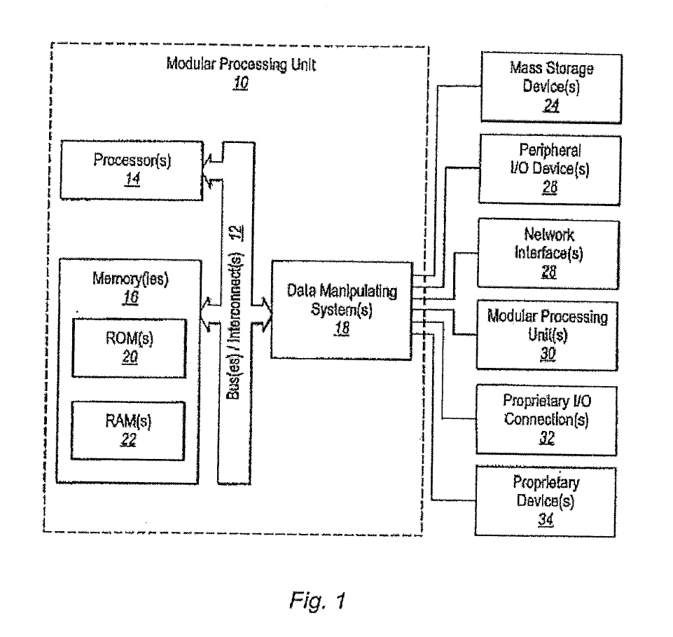

FIG. 1 and the corresponding discussion are intended to provide a general description of a suitable operating environment in accordance with embodiments of the present invention. As will be further discussed below, some embodiments embrace the use of one or more modular processing units in a variety of customizable enterprise configurations, including in a networked or combination configuration, as will be discussed below.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose modular processing unit capable of performing various different functions or one associated with a special-purpose modular processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid state storage device (e.g., flash memory, smart media, etc.), or any other device or component that is capable of providing data or executable instructions that may be accessed by a processing unit.

With reference to FIG. 1, a representative enterprise includes modular processing unit 10, which may be used as a general-purpose or special-purpose processing unit. For example, modular processing unit 10 may be employed alone or with one or more similar modular processing units as a personal computer, a notebook computer, a personal digital assistant (“PDA”) or other hand-held device, a workstation, a minicomputer, a mainframe, a supercomputer, a multi-processor system, a network computer, a processor-based consumer device, a smart appliance or device, a control system, or the like. Using multiple processing units in the same enterprise provides increased processing capabilities. For example, each processing unit of an enterprise can be dedicated to a particular task or can jointly participate in distributed processing.

In FIG. 1, modular processing unit 10 includes one or more buses and/or interconnect(s) 12, which may be configured to connect various components thereof and enables data to be exchanged between two or more components. Bus(es)/interconnect(s) 12 may include one of a variety of bus structures including a memory bus, a peripheral bus, or a local bus that uses any of a variety of bus architectures. Typical components connected by bus(es)/interconnect(s) 12 include one or more processors 14 and one or more memories 16. Other components may be selectively connected to bus(es)/interconnect(s) 12 through the use of logic, one or more systems, one or more subsystems and/or one or more I/O interfaces, hereafter referred to as “data manipulating system(s) 18.” Moreover, other components may be externally connected to bus(es)/interconnect(s) 12 through the use of logic, one or more systems, one or more subsystems and/or one or more I/O interfaces, and/or may function as logic, one or more systems, one or more subsystems and/or one or more I/O interfaces, such as modular processing unit(s) 30 and/or proprietary device(s) 34. Examples of I/O interfaces include one or more mass storage device interfaces, one or more input interfaces, one or more output interfaces, and the like. Accordingly, embodiments of the present invention embrace the ability to use one or more I/O interfaces and/or the ability to change the usability of a product based on the logic or other data manipulating system employed.

The logic may be tied to an interface, part of a system, subsystem and/or used to perform a specific task. Accordingly, the logic or other data manipulating system may allow, for example, for IEEE1394 (firewire), wherein the logic or other data manipulating system is an I/O interface. Alternatively or additionally, logic or another data manipulating system may be used that allows a modular processing unit to be tied into another external system or subsystem. For example, an external system or subsystem that may or may not include a special I/O connection. Alternatively or additionally, logic or other data manipulating system may be used wherein no external I/O is associated with the logic. Embodiments of the present invention also embrace the use of specialty logic, such as for ECUs for vehicles, hydraulic control systems, etc. and/or logic that informs a processor how to control a specific piece of hardware. Moreover, those skilled in the art will appreciate that embodiments of the present invention embrace a plethora of different systems and/or configurations that utilize logic, systems, subsystems and/or I/O interfaces.

As provided above, embodiments of the present invention embrace the ability to use one or more I/O interfaces and/or the ability to change the usability of a product based on the logic or other data manipulating system employed. For example, where a modular processing unit is part of a personal computing system that includes one or more I/O interfaces and logic designed for use as a desktop computer, the logic or other data manipulating system may be changed to include flash memory or logic to perform audio encoding for a music station that wants to take analog audio via two standard RCAs and broadcast them to an IP address. Accordingly, the modular processing unit may be part of a system that is used as an appliance rather than a computer system due to a modification made to the data manipulating system(s) (e.g., logic, system, subsystem, I/O interface(s), etc.) on the back plane of the modular processing unit. Thus, a modification of the data manipulating system(s) on the back plane can change the application of the modular processing unit. Accordingly, embodiments of the present invention embrace very adaptable modular processing units.

As provided above, processing unit 10 includes one or more processors 14, such as a central processor and optionally one or more other processors designed to perform a particular function or task. It is typically processor 14 that executes the instructions provided on computer readable media, such as on memory(ies) 16, a magnetic hard disk, a removable magnetic disk, a magnetic cassette, an optical disk, or from a communication connection, which may also be viewed as a computer readable medium.

Memory(ies) 16 includes one or more computer readable media that may be configured to include or includes thereon data or instructions for manipulating data, and may be accessed by processor(s) 14 through bus(es)/interconnect(s) 12. Memory(ies) 16 may include, for example, ROM(s) 20, used to permanently store information, and/or RAM(s) 22, used to temporarily store information. ROM(s) 20 may include a basic input/output system (“BIOS”) having one or more routines that are used to establish communication, such as during start-up of modular processing unit 10. During operation, RAM(s) 22 may include one or more program modules, such as one or more operating systems, application programs, and/or program data.

As illustrated, at least some embodiments of the present invention embrace a non-peripheral encasement, which provides a more robust processing unit that enables use of the unit in a variety of different applications. In FIG. 1, one or more mass storage device interfaces (illustrated as data manipulating system(s) 18) may be used to connect one or more mass storage devices 24 to bus(es)/interconnect(s) 12. The mass storage devices 24 are peripheral to modular processing unit 10 and allow modular processing unit 10 to retain large amounts of data. Examples of mass storage devices include hard disk drives, magnetic disk drives, tape drives and optical disk drives.

A mass storage device 24 may read from and/or write to a magnetic hard disk, a removable magnetic disk, a magnetic cassette, an optical disk, a solid state storage device (such as a flash memory storage device) or another computer readable medium. Mass storage devices 24 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

Data manipulating system(s) 18 may be employed to enable data and/or instructions to be exchanged with modular processing unit 10 through one or more corresponding peripheral I/O devices 26. Examples of peripheral I/O devices 26 include input devices such as a keyboard and/or alternate input devices, such as a mouse, trackball, light pen, stylus, or other pointing device, a microphone, a joystick, a game pad, a satellite dish, a scanner, a camcorder, a digital camera, a sensor, and the like, and/or output devices such as a monitor or display screen, a speaker, a printer, a control system, and the like. Similarly, examples of data manipulating system(s) 18 coupled with specialized logic that may be used to connect the peripheral I/O devices 26 to bus(es)/interconnect(s) 12 include a serial port, a parallel port, a game port, a universal serial bus (“USB”), a firewire (IEEE 1394), a wireless receiver, a video adapter, an audio adapter, a parallel port, a wireless transmitter, any parallel or serialized I/O peripherals or another interface.

Data manipulating system(s) 18 enable an exchange of information across one or more network interfaces 28. Examples of network interfaces 28 include a connection that enables information to be exchanged between processing units, a network adapter for connection to a local area network (“LAN”) or a modem, a wireless link, or another adapter for connection to a wide area network (“WAN”), such as the Internet. Network interface 28 may be incorporated with or peripheral to modular processing unit 10, and may be associated with a LAN, a wireless network, a WAN and/or any connection between processing units.

Data manipulating system(s) 18 enable modular processing unit 10 to exchange information with one or more other local or remote modular processing units 30 or computer devices. A connection between modular processing unit 10 and modular processing unit 30 may include hardwired and/or wireless links. Accordingly, embodiments of the present invention embrace direct bus-to-bus connections. This enables the creation of a large bus system. It also eliminates hacking as currently known due to direct bus-to-bus connections of an enterprise. Furthermore, data manipulating system(s) 18 enable modular processing unit 10 to exchange information with one or more proprietary I/O connections 32 and/or one or more proprietary devices 34.

Program modules or portions thereof that are accessible to the processing unit may be stored in a remote memory storage device. Furthermore, in a networked system or combined configuration, modular processing unit 10 may participate in a distributed computing environment where functions or tasks are performed by a plurality of processing units. Alternatively, each processing unit of a combined configuration/enterprise may be dedicated to a particular task. Thus, for example, one processing unit of an enterprise may be dedicated to video data, thereby replacing a traditional video card, and provides increased processing capabilities for performing such tasks over traditional techniques.

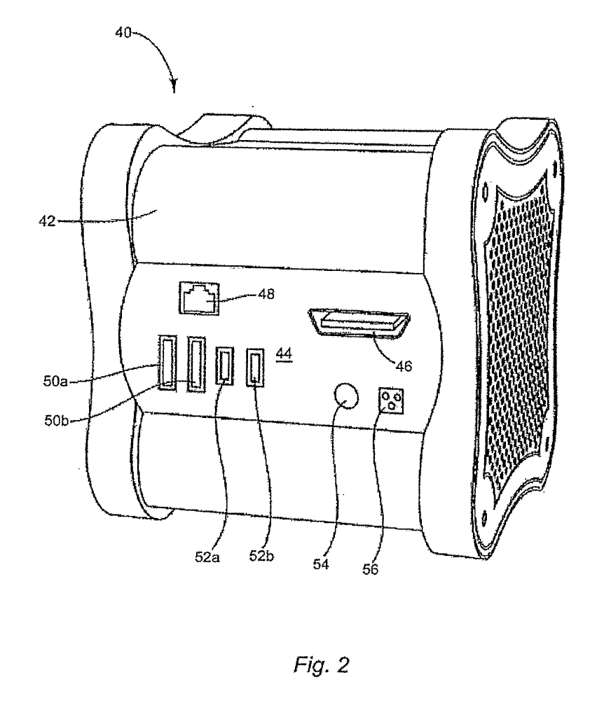

While those skilled in the art will appreciate that embodiments of the present invention may comprise a variety of configurations, reference is made to FIG. 2, which illustrates a representative embodiment of a durable and dynamically modular processing unit. In the illustrated embodiment of FIG. 2, processing unit 40 is durable and dynamically modular. In the illustrated embodiment, unit 40 is a 3½-inch (8.9 cm) cube platform that utilizes an advanced thermodynamic cooling model, eliminating any need for a cooling fan.

However, as provided herein, embodiments of the present invention embrace the use of other cooling processes in addition to or in place of a thermodynamic cooling process, such as a forced air cooling process and/or a liquid cooling process. Moreover, while the illustrated embodiment includes a 3½-inch cube platform, those skilled in the art will appreciate that embodiments of the present invention embrace the use of a modular processing unit that is greater than or less than a 3½-inch cube platform. Similarly, other embodiments embrace the use of shapes other than a cube.

Processing unit 40 also includes a layered motherboard configuration, that optimizes processing and memory ratios, and a bus architecture that enhances performance and increases both hardware and software stability, each of which will be further discussed below. Those skilled in the art will appreciate that other embodiments of the present invention also embrace non-layered motherboards. Moreover, other embodiments of the present invention embrace embedded motherboard configurations, wherein components of the motherboard are embedded into one or more materials that provide an insulation between components and embed the components into the one or more materials, and wherein one or more of the motherboard components are mechanical, optical, electrical or electro-mechanical. Furthermore, at least some of the embodiments of embedded motherboard configurations include mechanical, optical, electrical and/or electro-mechanical components that are fixed into a three-dimensional, sterile environment. Examples of such materials include polymers, rubbers, epoxies, and/or any non-conducting embedding compound(s).

Embodiments of the present invention embrace providing processing versatility. For example, in accordance with at least some embodiments of the present invention, processing burdens are identified and then solved by selectively dedicating and/or allocating processing power. For example, a particular system is defined according to specific needs, such that dedication or allocation of processing power is controlled. Thus, one or more modular processing units may be dedicated to provide processing power to such specific needs (e.g., video, audio, one or more systems, one or more subsystems, etc.). In some embodiments, being able to provide processing power decreases the load on a central unit. Accordingly, processing power is driven to the areas needed.

While the illustrated embodiment, processing unit 40 includes a 3 GHz processor and 2 GB of RAM, those skilled in the art will appreciate that other embodiments of the present invention embrace the use of a faster or slower processor and/or more or less RAM. In at least some embodiments of the present invention, the speed of the processor and the amount of RAM of a processing unit depends on the nature for which the processing unit is to be used.

A highly dynamic, customizable, and interchangeable back plane 44 provides support to peripherals and vertical applications. In the illustrated embodiment, back plane 44 is selectively coupled to encasement 42 and may include one or more features, interfaces, capabilities, logic and/or components that allow unit 40 to be dynamically customizable. In the illustrated embodiment, back plane 44 includes DVI Video port 46, Ethernet port 48, USB ports 50 (50a and 50b), SATA bus ports 52 (52a and 52b), power button 54, and power port 56. Back plane 44 may also include a mechanism that electrically couples two or more modular processing units together to increase the processing capabilities of the entire system as indicated above, and to provide scaled processing as will be further disclosed below.

Those skilled in the art will appreciate that back plane 44 with its corresponding features, interfaces, capabilities, logic and/or components are representative only and that embodiments of the present invention embrace back planes having a variety of different features, interfaces, capabilities and/or components. Accordingly, a processing unit is dynamically customizable by allowing one back plane to be replaced by another back plane in order to allow a user to selectively modify the logic, features and/or capabilities of the processing unit.

Moreover, embodiments of the present invention embrace any number and/or type of logic and/or connectors to allow use of one or more modular processing units 40 in a variety of different environments. For example, the environments include vehicles (e.g., cars, trucks, motorcycles, etc.), hydraulic control systems, and other environments. The changing of data manipulating system(s) on the back plane allows for scaling vertically and/or horizontally for a variety of environments, as will be further discussed below.

Furthermore, embodiments of the present invention embrace a variety of shapes and sizes of modular processing units. For example, in FIG. 2 modular processing unit 40 is a cube that is smaller than traditional processing units for a variety of reasons.

As will be appreciated by those skilled in the art, embodiments of the present invention are easier to support than traditional techniques because of, for example, materials used, the size and/or shape, the type of logic and/or an elimination of a peripherals-based encasement.

In the illustrated embodiment, power button 54 includes three states, namely on, off and standby for power boot. When the power is turned on and received, unit 40 is instructed to load and boot an operating system supported in memory. When the power is turned off, processing control unit 40 will interrupt any ongoing processing and begin a shut down sequence that is followed by a standby state, wherein the system waits for the power on state to be activated.

USB ports 50 are configured to connect peripheral input/output devices to processing unit 40. Examples of such input or output devices include a keyboard, a mouse or trackball, a monitor, printer, another processing unit or computer device, a modem, and a camera.

SATA bus ports 52 are configured to electronically couple and support mass storage devices that are peripheral to processing unit 40. Examples of such mass storage devices include floppy disk drives, CD-ROM drives, hard drives, tape drives, and the like.

As provided above, other embodiments of the present invention embrace the use of additional ports and means for connecting peripheral devices, as will be appreciated by one of ordinary skill in the art. Therefore, the particular ports and means for connecting specifically identified and described herein are intended to be illustrative only and not limiting in any way.

As provided herein, a variety of advantages exist through the use of a non-peripheral processing unit over larger, peripheral packed computer units. By way of example, the user is able to selectively reduce the space required to accommodate the enterprise, and may still provide increased processing power by adding processing units to the system while still requiring less overall space. Moreover, since each of the processing units includes solid-state components rather than systems that are prone to breaking down, the individual units may be hidden (e.g., in a wall, in furniture, in a closet, in a decorative device such as a clock).

The durability of the individual processing units/cubes allows processing to take place in locations that were otherwise unthinkable with traditional techniques. For example, the processing units can be buried in the earth, located in water, buried in the sea, placed on the heads of drill bits that drive hundreds of feet into the earth, on unstable surfaces in furniture, etc. The potential processing locations are endless. Other advantages include a reduction in noise and heat, an ability to provide customizable “smart” technology into various devices available to consumers, such as furniture, fixtures, vehicles, structures, supports, appliances, equipment, personal items, etc.

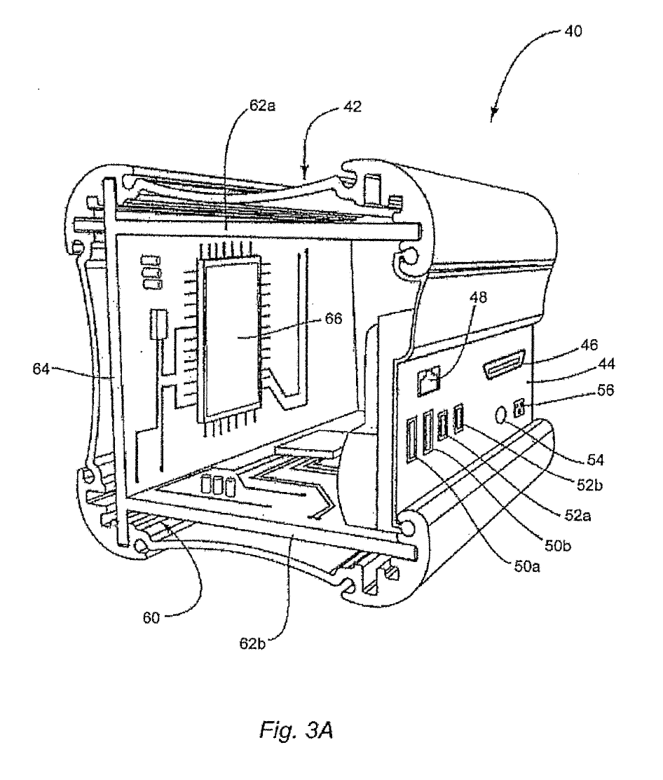

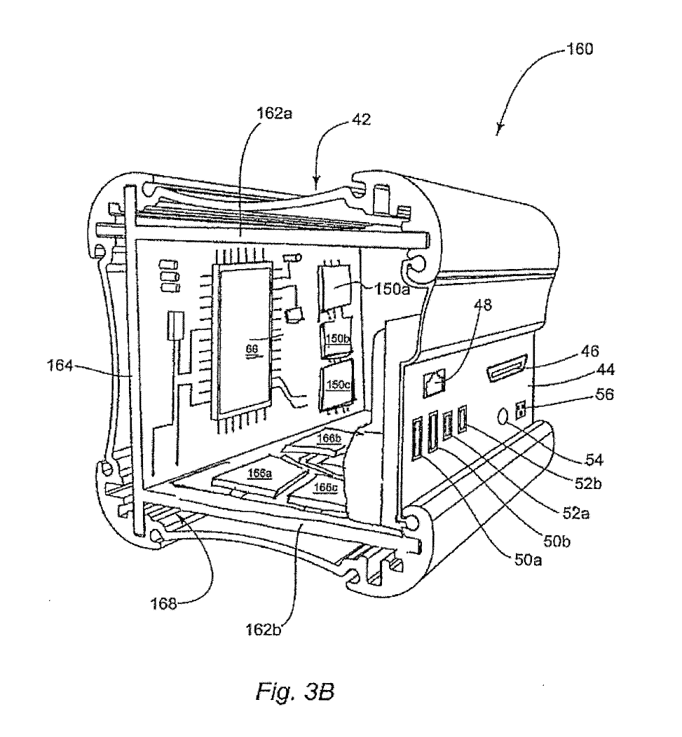

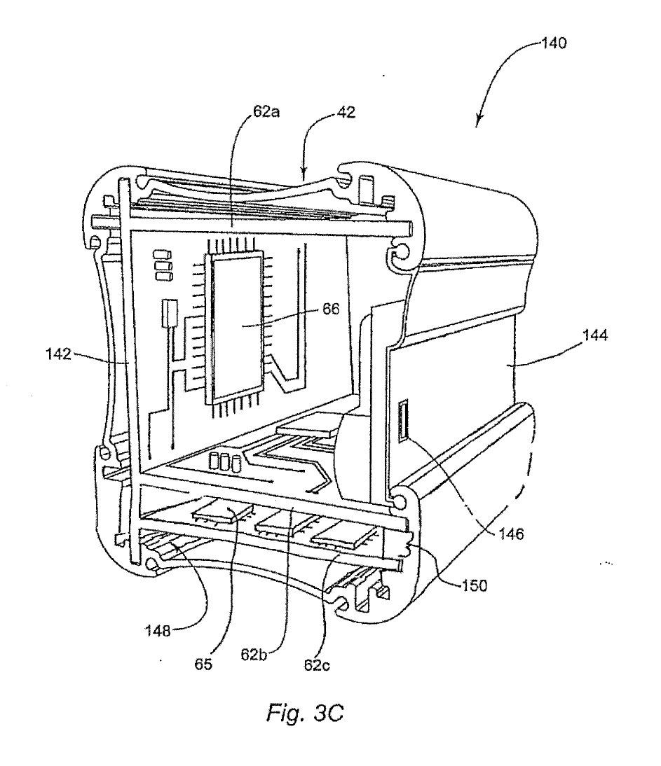

With reference now to FIG. 3A, another view of the embodiment of FIG. 2 is provided, wherein the view illustrates processing unit 40 with the side walls of the cube removed to more fully illustrate the non-peripheral based encasement, cooling process (e.g., thermodynamic convection cooling, forced air, and/or liquid cooling), optimized layered circuit board configuration, and dynamic back plane. In the illustrated embodiment, the various boards are coupled together by using a force fit technique, which prevents accidental decoupling of the boards and enables interchangeability. The boards provide for an enhanced EMI distribution and/or chip/logic placement. Those skilled in the art will appreciate that embodiments of the present invention embrace any number of boards and/or configurations. Furthermore, board structures may be modified for a particular benefit and/or need based on one or more applications and/or features. In FIG. 3A, processing unit 40 includes a layered circuit board/motherboard configuration 60 that includes two parallel sideboards 62 (62a and 62b) and a central board 64 transverse to and electronically coupling sideboards 62. While the illustrated embodiment provides a tri-board configuration, those skilled in the art will appreciate that embodiments of the present invention embrace board configurations having less than three boards, and layered board configurations having more than three boards. Moreover, embodiments of the present invention embrace other configurations of circuit boards, other than boards being at right angles to each other.

In the illustrated embodiment, the layered motherboard 60 is supported within encasement 42 using means for coupling motherboard 60 to encasement 42. In the illustrated embodiment, the means for coupling motherboard 60 to encasement 42 include a variety of channeled slots that are configured to selectively receive at least a portion of motherboard 60 and to hold motherboard 60 in position. As upgrades are necessary with the advancing technology, such as when processor 66 is to be replaced with an improved processor, the corresponding board (e.g., central board 64) is removed from the encasement 42 and a new board with a new processor is inserted to enable the upgrade. Accordingly, embodiments of the present invention have proven to facilitate upgrades as necessary and to provide a customizable and dynamic processing unit.

Processing unit 40 also includes one or more processors that at are configured to perform one or more tasks. In FIG. 3A, the one or more processors are illustrated as processor 66, which is coupled to central board 64. As technology advances, there may be a time when the user of processing unit 40 will want to replace processor 66 with an upgraded processor. Accordingly, central board 64 may be removed from encasement 42 and a new central board having an upgraded processor may be installed and used in association with unit 40. Accordingly, embodiments of the present invention embrace dynamically customizable processing units that are easily upgraded and thus provide a platform having longevity in contrast to traditional techniques.

According to some embodiments a processor cooling system may be attached to the processor 66. A number of devices can be used to cool the processor including a heat sink, fan, combinations thereof, and various other devices known in the art.

Similarly, processing unit 40 can include one or more memory devices (not shown). Memory may be coupled to an electronic circuit board in various ways, including a memory card removably coupled to a slot on a circuit board or a memory card directly couple to the circuit board. In some embodiments of the present invention, an entire circuit board of a modular motherboard may be substantially dedicated to providing one or more memory devices. As technology advances, there may be a time when the user of processing unit 40 will want to replace a memory device with an upgraded memory device. Accordingly, the circuit board containing the memory device may be removed from encasement 42 and a new circuit board having an upgraded processor may be installed and used in association with unit 40.

The motherboard 60 of the present invention is modular and easily upgradeable. The modular motherboard 60 is comprised of a plurality of electronic circuit boards that makes an integrated logic board equal in ability and performance to that of a non-modular motherboard having the same components. The modular motherboard 60 is composed of several electronic circuit boards 64, 62a, and 62b, which interconnect to form a complete logic board, or motherboard. Thus, each electronic circuit board can be easily removed and replaced without substantially affecting the remaining circuit boards. For example, a user may replace a circuit board 64 having a processor 66 and replace it with another circuit board having a different processor to provide increasing processing power to the processing unit 40.

Each board includes a bus system which connects to the bus system of another circuit board. The bus system provides electronic communication between the interconnected circuit boards forming the modular motherboard 60. The modular motherboard can be comprised of any number of circuit boards. For example, in one embodiment, a motherboard includes four circuit boards, each having a particular function, such as processing, providing memory, providing storage, and providing BIOS. In another embodiment, a circuit board has more than one function, such as processing and memory capabilities. In another embodiment, a single function is performed by more than one circuit board. Additional functions performed by individual circuit boards include, but are not limited to, providing a clock generator, providing a cooling system, and other motherboard functions as understood by those of skill in the art.

The modular motherboard 60 provides a number of advantages over single-circuit-board motherboards. For example, when the modular motherboard 60 doesn't support a specific component, a user need only replace a single circuit board with a compatible circuit board rather than replacing the entire motherboard. Additionally, a modular motherboard is not constrained to a two-dimensional area like single-circuit-board motherboards. As such, the modular mother board 60 may be configured to fit within smaller, three-dimensional encasements. For example, where the modular motherboard includes four circuit boards, the boards can be configured to utilize one fourth the footprint area used by an equivalent single-circuit-board motherboard. Finally, a modular motherboard 60 is easily scalable. For example, a user may easily attach an additional circuit board (not shown) to the preexisting motherboard configuration to scale the processing power of the whole structure. One of skill in the art will appreciate that the modular motherboard 60 provides an unlimited number of advantages when used in conjunction with specific applications and computer systems.

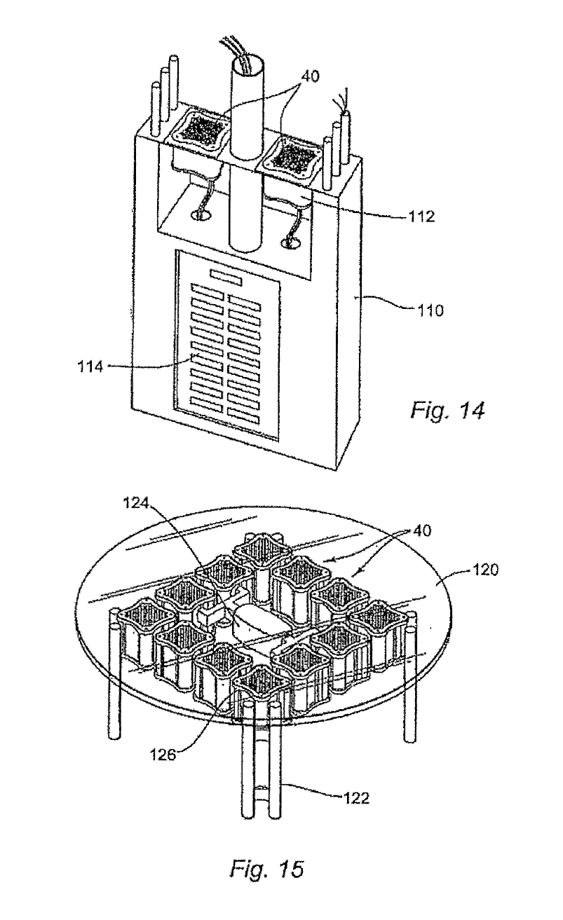

According to some embodiments of the processing unit of the present invention one or more electronic storage devices are included with the modular motherboard. The addition of electronic storage, such as a mass storage device, has the ability to enhance the processing and computing abilities of the processing unit. For example, a processing unit with electronic storage capacity can be used as a personal computer by merely attaching the essential peripheral devices, such as a monitor, mouse, and keyboard. Also a processing unit with electronic storage capacity can be effective and useful as an engine that drives and controls the operation of a component, structure, assembly, equipment module, as shown in FIGS. 14-16. For example a processing unit may store a digital log of the functions or performance of equipment in electronic storage. In another example, a processing unit may control both a stereo system and store a user's digital music library.

Referring now to FIG. 3B, another embodiment of the present invention is provided, wherein the view illustrates processing unit 160 with the side walls of the cube removed to more fully illustrate the non-peripheral based encasement, a plurality of layered circuit boards, and dynamic backplane 44. The layered circuit boards include two parallel sideboards 162 (162a and 162b) and a central board 164 transverse to and electronically coupling sideboards 162a and 162b.

In the embodiment of FIG. 3B, the central board 164 includes a processor 66 and memory devices 150a, 150b, and 150c, and sideboard 162b includes a plurality of electronic storage devices 166a, 166b, and 166c. As described above, the motherboard 168 is easily upgraded by removing a sideboard 162 or the central board 164 and replacing them with another circuit board. In another embodiment, boards are replaced with upgraded boards with improved abilities. A user interchanges one or more circuit boards 162a, 162b, or 164 to decrease the processing power, available memory, storage capacity, or other properties of the processing unit 160. Such upgrades or downgrades are possible and easily accomplished with the modular motherboard.

Various types of electronic storage devices can be utilized with the present processing unit 160. For example, solid state memory, such as flash memory, provides a number of benefits to modular processing units. Solid state memory uses low levels of power, which result in low levels of heat dissipations. As such, it is possible for one or more such solid state storage devices to be included in a relatively small processing unit 160 without substantially increasing the heat dissipated by the unit. For example, in one particular embodiment a sideboard 162b includes a plurality of flash memory storage devices 166a, 166b, and 166c that together provide 128 Gb of data storage. As configured, these storage devices uses less than five watts of energy, which will create minimal heat that is easily dissipate into the environment through natural convection, or another cooling method.

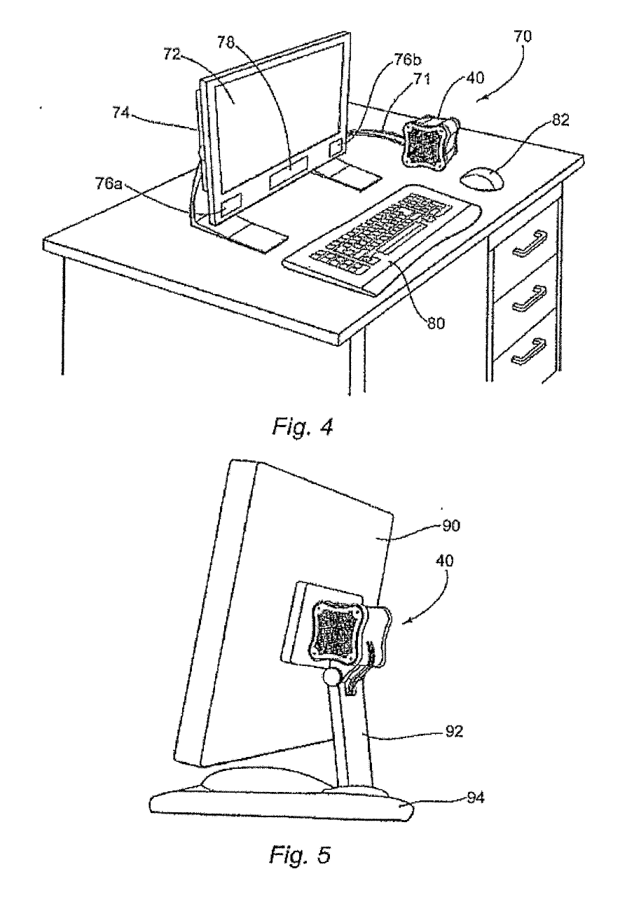

With reference now to FIG. 3C, another embodiment of the present invention is provided, wherein the view illustrates processing unit 140. Processing unit 140 includes an encasement, a modular motherboard 148, and a dynamic backplane 144. In this embodiment the modular motherboard 148 includes three parallel sideboards 62a, 62b, and 62c and a central board 142 transverse to and electronically coupling sideboards 62. Unlike the three-board configuration of FIGS. 3 and 4, the four-board configuration includes a third parallel sideboard 62c. The third parallel sideboard is configured beneath and parallel to sideboard 62b. One of skill in the art will appreciate that the four circuit boards may be configured in a variety of orientations. In some embodiment, a four-board configuration may be configured to positioning hot components strategically for maximum heat dissipation.

According to one embodiment encasement 42 is elongated to accommodate fourth sideboard 62c. In another embodiment, central board 142 is elongated to accommodate fourth sideboard 62c. In yet another embodiment, sideboard 62b is repositioned along central board 142 and sideboard 62c is positioned below it (as shown in FIG. 5) to accommodate fourth sideboard 62c. In yet another embodiment, the encasement can be elongated to accommodate fourth sideboard 62c.

The increased number of circuit boards in the four-board configuration provides additional surface area on the modular motherboard 148 for computer components. In one embodiment, the additional surface area provided by the four-board configuration is used for additional components, such as additional memory devices or an additional processor. As previously explained, storage devices utilize relatively low levels of energy and thus dissipate relatively low levels of heat. Thus, in some embodiments, a storage device is stored in relative proximity to other computer components without producing damaging heat or requiring a designated cooling device.

In one embodiment, one or more of the circuit boards in the four-board configuration includes a storage device 65 that provide electronic storage capabilities to the processing unit 140. In another embodiment, the storage device 65 is a solid state storage device, such as a flash memory device or another similar storage device. In another embodiment, an entire sideboard 62c is substantially dedicated to electronic storage, such as one or more flash memory device(s). Due to the relatively low levels of heat dissipated from the solid state storage devices the gap 150 between sideboard 62c and sideboard 62b is narrow and compact. Thus, the relative size of a processing unit 140 is relatively similar or equal to the size of a processing unit that doesn't include an electronic storage device.

The storage device 65 or plurality of storage devices may provide the processing unit 140 with sufficient electronic storage for it to perform one or more designated functions. According to one embodiment, the one or more storage device(s) may provide sufficient electronic storage to use the processing unit 140 as a personal computer. For example, a plurality of storage devices 65 are includes on sideboard 62c which may provide the processing unit between 16 Gb and 256 Gb of electronic storage. In another embodiment, the storage device 65 provides only 256 Mb of electronic storage, and the processing unit 140 is utilized to control the functions of home appliance.

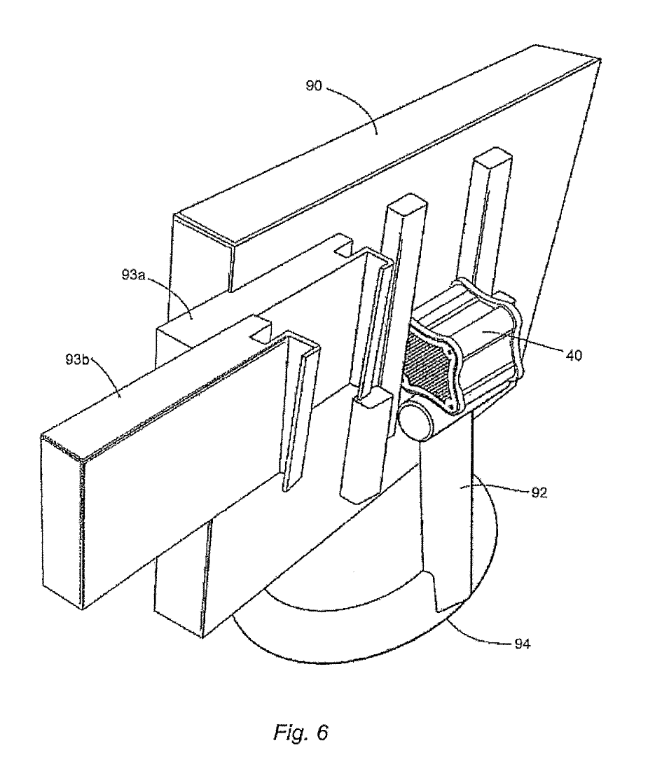

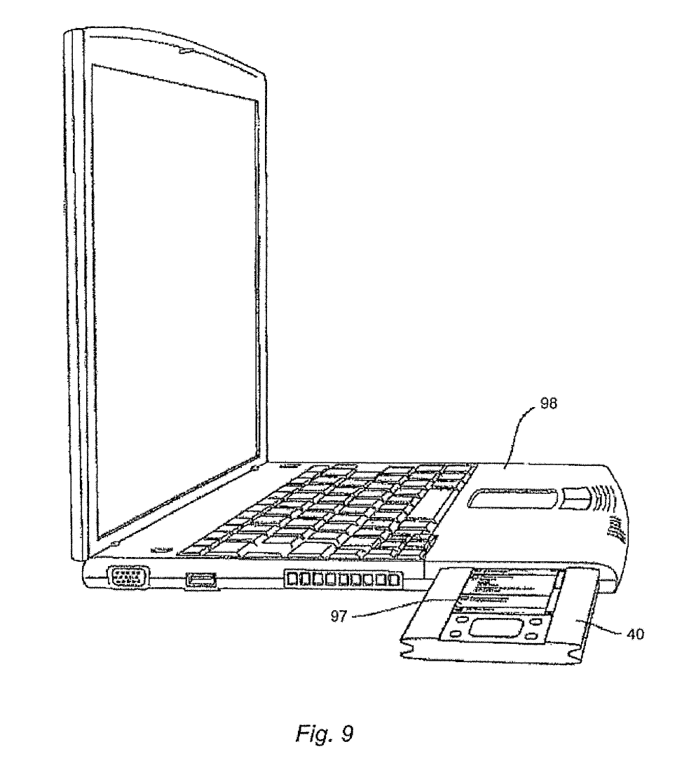

In the illustrated embodiment, the dynamic backplane 144 includes a single port 146. It will be understood that any number of ports, buttons, switches, or other like components may be included in the dynamic backplane 144. For example, in one embodiment the dynamic backplane can have wireless communication capabilities. In another embodiment, the dynamic backplane 144 includes only a single port which may be configured to connect to a number of external devices. In one embodiment, the single port 146 is configured to connect to a power supply, a personal computer, a computer server, a docking station, or other external device as will be understood by one of skill in the art. Finally, in one embodiment, single port 146 is a proprietary port that connects to a proprietary docking station. Representative devices that can function as docking stations are shown in FIGS. 6 and 9.

With reference now to FIG. 4, a representative enterprise 70 is illustrated, wherein a dynamically modular processing unit 40 having a non-peripheral based encasement, is employed alone in a personal computing enterprise. In the illustrated embodiment, processing unit 40 includes power connection 71 and employs wireless technology with the peripheral devices of enterprise 70. The peripheral devices include monitor 72 having hard disk drive 74, speakers 76, and CD ROM drive 78, keyboard 80 and mouse 82. Those skilled in the art will appreciate that embodiments of the present invention also embrace personal computing enterprises that employ technologies other than wireless technologies.

Processing unit 40 is the driving force of enterprise 70 since it provides the processing power to manipulate data in order to perform tasks. The dynamic and customizable nature of the present invention allows a user to easily augment processing power. In the present embodiment, processing unit 40 is a 3½-inch (8.9 cm) cube that utilizes thermodynamic cooling and optimizes processing and memory ratios. However, as provided herein, embodiments of the present invention embrace the use of other cooling processes in addition to or in place of a thermodynamic cooling process, such as a forced air cooling process and/or a liquid cooling process. Furthermore, while the illustrated embodiment includes a 3½-inch cube platform, those skilled in the art will appreciate that embodiments of the present invention embrace the use of a modular processing unit that is greater than or less than a 3½-inch cube platform. Similarly, other embodiments embrace the use of shapes other than a cube.

In particular, processing unit 40 of the illustrated embodiment includes a 3 GHz processor, 2G RAM, a 512 L2 cache, and wireless networking interfaces. So, for example, should the user of enterprise 70 determine that increased processing power is desired for enterprise 70, rather than having to purchase a new system as is required by some traditional technologies, the user may simply add one or more modular processing units to enterprise 70. The processing units/cubes may be selectively allocated by the user as desired for performing processing. For example, the processing units may be employed to perform distributive processing, each unit may be allocated for performing a particular task (e.g., one unit may be dedicated for processing video data, or another task), or the modular units may function together as one processing unit.

While the present example includes a processing unit that includes a 2 GHz processor, 1.5G RAM, and a 512 L2 cache, those skilled in the art will appreciate that other embodiments of the present invention embrace the use of a faster or slower processor, more or less RAM, and/or a different cache. In at least some embodiments of the present invention, the capabilities of the processing unit depends on the nature for which the processing unit will be used.

While FIG. 4 illustrates processing unit 40 on top of the illustrated desk, the robust nature of the processing unit/cube allows for unit 40 to alternatively be placed in a non-conspicuous place, such as in a wall, mounted underneath the desk, in an ornamental device or object, etc. Accordingly, the illustrated embodiment eliminates traditional towers that tend to be kicked and that tend to produce sound from the cooling system inside of the tower. No sound is emitted from unit 40 as all internal components are solid states when convection cooling or liquid cooling is employed.

With reference now to FIG. 5, another example is provided for utilizing a modular processing unit in a computing enterprise. In FIG. 5, an ability of modular processing unit 40 to function as a load-bearing member is illustrated. For example, a modular processing unit may be used to bridge two or more structures together and to contribute to the overall structural support and stability of the structure or enterprise. In addition, a modular processing unit may bear a load attached directly to a primary support body. For example, a computer screen or monitor may be physically supported and the processing controlled by a modular processing unit. In the illustrated embodiment, monitor 90 is mounted to modular processing unit 40, which is in turn mounted to a stand 92 having a base 94.

With reference now to FIG. 6, another representative enterprise is illustrated, wherein a dynamically modular processing unit 40 having a non-peripheral based encasement, is employed computing enterprise. In FIG. 6, the representative enterprise is similar to the embodiment illustrated in FIG. 5, however one or more modular peripherals are selectively coupled to the enterprise. In particular, FIG. 6 illustrates mass storage devices 93 that are selectively coupled to the enterprise as peripherals. Those skilled in the art will appreciate that any number (e.g., less than two or more than two) and/or type of peripherals may be employed. Examples of such peripherals include mass storage devices, I/O devices, network interfaces, other modular processing units, proprietary I/O connections; proprietary devices, and the like.

With reference now to FIG. 7, another representative embodiment is illustrated, wherein a dynamically modular processing unit 40 having a non-peripheral based encasement, is employed in an enterprise. In accordance with at least some embodiments of the present invention, a modular processing unit having a non-peripheral based encasement may be employed in a central processing unit or in other electronic devices, including a television, a stereo system, a recording unit, a set top box, or any other electronic device. Accordingly, the modular processing unit may be selectively used to in the enterprise to monitor, warn, inform, control, supervise, record, recognize, etc. In FIG. 7, modular processing unit is coupled to a power source 94, one or more other peripherals 95, and connections 96 for use in the enterprise.

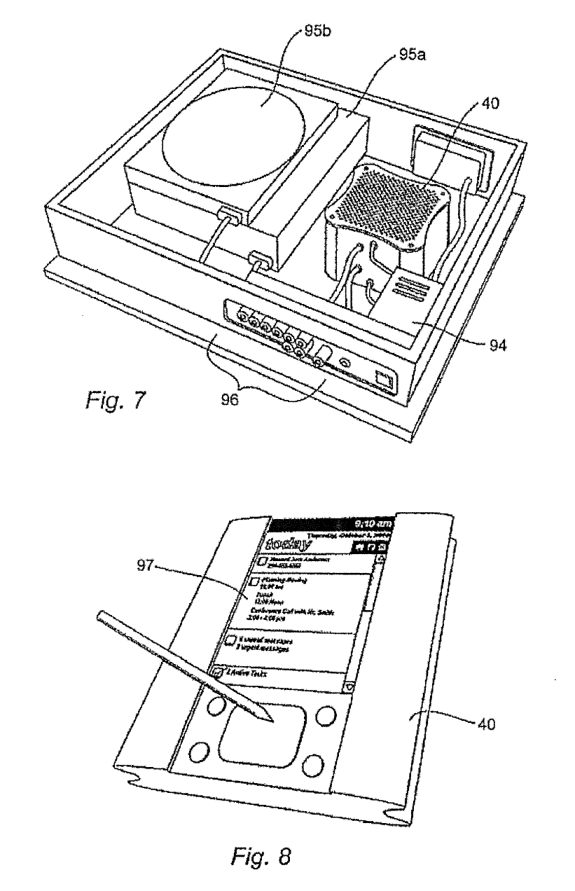

As provided herein, embodiments of the present invention embrace a variety of shapes and sizes for a modular processing unit. With reference now to FIG. 8, a modular processing unit 40 is illustrated that is employed as a hand-held computing enterprise, such as a personal digital assistant (“PDA”). An I/O peripheral 97 is coupled to the modular processing unit 40. In the illustrated embodiment, the I/O peripheral 97 includes a monitor and a stylus to enable input and output. Those skilled in the art will appreciate that additional peripherals may be included, such as speakers, a microphone, a cellular telephone, keyboard, or any other type of peripheral, representative examples of such will be provided below.

In the embodiment of FIG. 8, the hand-held computing enterprise has the dimensions of 3.5″×4.75″×0.75″, however those skilled in the art will appreciate that the present invention also embraces embodiments that are larger or smaller than the illustrated embodiment. In FIG. 8, the I/O peripheral 97 is a slide on pieces that is selectively coupled to modular processing unit 40, which includes a non-layered board design to allow unit 40 to be more slender. Additional peripherals include a power source and mass storage device. In one embodiment, the mass storage device is a 40G hard drive that enables the user to always have all of his/her files. Accordingly, the embodiment of FIG. 8 enables a user to employ a complete computer in the palm of his/her hand. Moreover, because of the solid state components, the embodiment of FIG. 8 is more durable than traditional techniques. Furthermore, in at least some embodiments, the casing includes metal to increase the durability. Accordingly, if unit 40 is dropped, the core will not be broken.

With reference now to FIG. 9, another representative enterprise is illustrated that includes a dynamically modular processing unit 40 having a non-peripheral based encasement. In FIG. 9, processing unit 40, having an I/O peripheral 97, is selectively coupled to peripheral 98 to allow the representative enterprise to function as a high-end laptop computer. Utilizing a liquid cooling technique, for example, processing unit 40 can be a very powerful handheld machine. And, as illustrated in FIG. 9, unit 40 may be selectively inserted like a cartridge into a large I/O peripheral 98, which includes a keyboard, monitor, speakers, and optionally logic depending on end user application. Once unit 40 is decoupled/ejected from peripheral 98, unit 40 can retain the files to allow the user to always have his/her files therewith. Accordingly, there is no need to synchronize unit 40 with peripheral 98 since unit 40 includes all of the files. While the embodiment illustrated in FIG. 9 includes one modular processing unit, other embodiments of the present invention embrace the utilization of multiple processing units.

Similarly, modular processing unit 40 may be inserted or otherwise coupled to a variety of other types of peripherals, including an enterprise in a vehicle, at home, at the office, or the like. Unit 40 may be used to preserve and provide music, movies, pictures or any other audio and/or video.

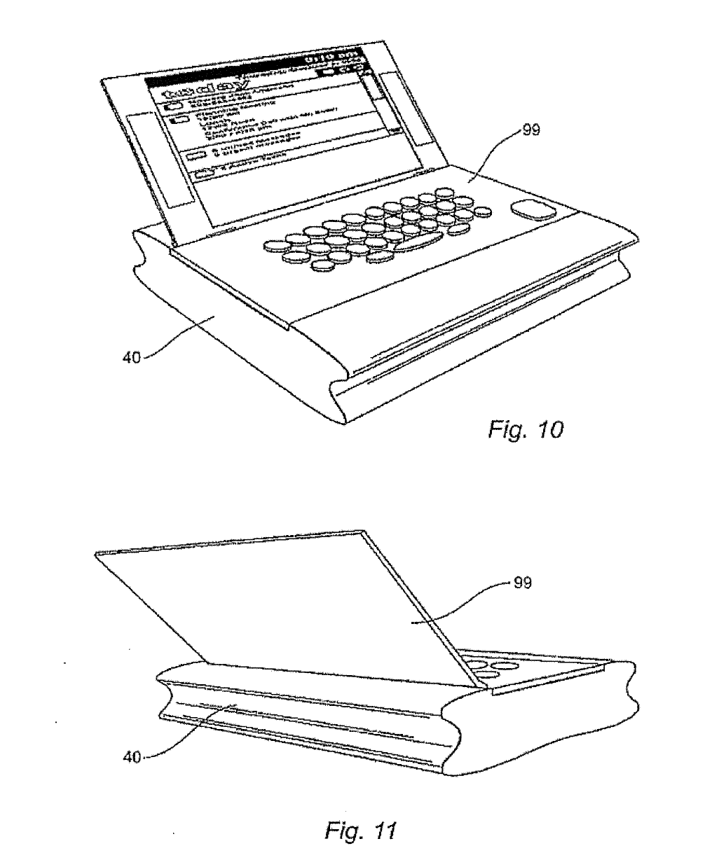

With reference now to FIGS. 10-11, another representative enterprise is illustrated, wherein a dynamically modular processing unit 40 having a non-peripheral based encasement, is employed in a personal computing enterprise. In FIGS. 10-11, modular processing unit 40 is coupled to a flip top peripheral 99, which includes a monitor, thumb keyboard and mouse device. The flip top peripheral 99 runs at full speeds with a hand top computer to do spreadsheets, surf the internet, and other functions and/or tasks. The embodiment illustrated in FIGS. 10-11 boots a full version of an operating system when the flip top is open. In another embodiment, flip top peripheral 99 and I/O peripheral 97 are simultaneously coupled to the same modular processing device such that the enterprise boots a full version of an operating system when the flip top is open and runs a modified version when closed that operates on minimal power and processing power.

In further embodiments, modular processing units are employed as MP3 players and/or video players. In other embodiments, a camera is employed as a peripheral and the images/video are preserved on the modular processing unit.

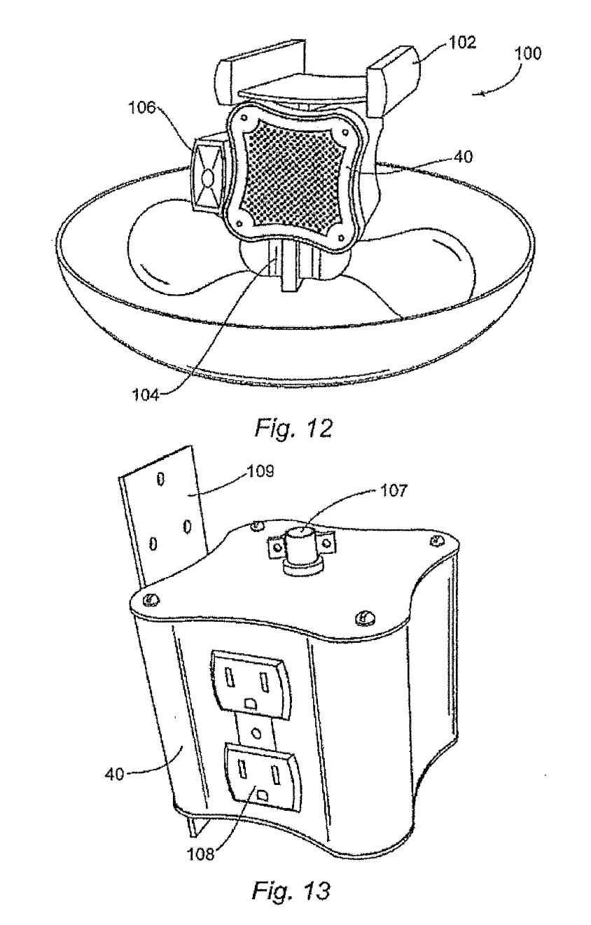

As provided above, embodiments of the present invention are extremely versatile. As further examples, processing control unit 40 may be used to physically support and/or provide processing to various fixtures or devices, such a lighting fixture (FIG. 12), an electrical outlet (FIG. 13), or a breaker box (FIG. 14). As provided herein, at least some embodiments of the present invention embrace a modular processing unit that functions as an engine that drives and controls the operation of a variety of components, structures, assemblies, equipment modules, etc.

With reference now to FIG. 12, a representative enterprise is illustrated wherein a dynamically modular processing unit is employed in a representative consumer electrical device. In FIG. 12, modular processing unit 40 is incorporated a lighting fixture 100. For example, modular processing unit 40 may be used to control the on/off, dimming, and other attributes of lighting fixture 100, such as monitoring the wattage used by the bulb and alerting a control center of any maintenance required for lighting fixture 100 or any other desirable information. In the illustrated embodiment, modular processing unit 40 is mounted to a ceiling structure via slide-on mounting bracket 102 and to lighting fixture 100 using a mounting bracket slide-on lighting module 104 that is slid into slide receivers (not shown) located in the primary support body of modular processing unit 40. Lighting module 104 may support one or more light bulbs and a cover as shown. In the illustrated embodiment, modular processing unit 40 is also mounted to a slide on dimmer 194.

With reference to FIG. 13, a representative enterprise is illustrated, wherein a dynamically modular processing unit 40 having a non-peripheral based encasement is employed in another representative electrical device, wherein the representative device is an electrical outlet or plug that is used for 802.11x distribution. In FIG. 13, modular processing unit 40 is coupled to an AC interface 107, AC plug peripheral 108, and mounting bracket 109. AC plug peripheral 108 and mounting bracket 109 are slide-on peripherals. Modular processing unit 40 is powered by the ac distribution into unit 40 and is used as a smart plug to monitor, control, oversee, and/or allocate power distribution.

In one embodiment, unit 40 is utilized as a router. In another embodiment, unit 40 is employed as a security system. In another embodiment, unit 40 monitors electrical distribution and disconnects power as needed to ensure safety. For example, unit 40 is able to detect is an individual has come in contact with the electrical distribution and automatically shuts off the power. In some embodiments, technologies, such as X10 based technologies or other technologies, are used to connect multiple enterprises, such as the one illustrated in FIG. 13, over copper wire lines. In further embodiments, the multiple enterprises exchange data over, for example, a TCP/IP or other protocol.

Accordingly, embodiments of the present invention embrace the utilization of a modular processing unit in association with a mundane product to form a smart product. Although not exhaustive, other examples of products, systems and devices with a modular processing unit may be used to provide a smart product, system and/or device include a heating system, a cooling system, a water distribution system, a power distribution system, furniture, fixtures, equipment, gears, drills, tools, buildings, artificial intelligence, vehicles, sensors, video and/or audio systems, security systems, and many more products, systems and/or devices.

For example, a modular processing unit in association with a furnace may be used to control the efficiency of the furnace system. If the efficiency decreases, the modular processing unit may be programmed to provide the owner of the building, for example in an email communication, to change filters, service the system, identify a failure, or the like. Similarly, a modular processing unit may be used in association with a water supply to monitor the purity of the water and provide a warning in the event of contamination. Similarly, appliances (e.g., washers, dryers, dishwashers, refrigerators, and the like) may be made smart when used in association with a modular processing unit. Furthermore, the modular processing units may be used in association with a system that provides security, including detecting carbon monoxide, anthrax or other biological agents, radiological agents, or another agent or harmful substance. Moreover, due to the stability and versatility of the processing units, the modular processing units may be placed in locations previously unavailable. In at least some embodiments, the use of a modular processing unit with a super structure allows the modular processing unit to take on qualities of the super structure.

With reference now to FIG. 14, a representative enterprise is illustrated wherein one or more dynamically modular processing units are employed in another representative device, namely a voltage monitoring breaker box. In the illustrated embodiment, modular processing units 40 are used to transform a standard breaker box 114 into a voltage monitoring breaker box 110. Dual redundant modular processing units 40 function to process control breaker box 110 and monitor the voltage, in real-time, existing within breaker box 110 and throughout the house. Attached to each modular processing unit 40 is a voltage monitoring back plate 112, which attach using slide receivers. While the illustrated embodiment provides two modular processing units, those skilled in the art will appreciate that other embodiments embrace the use of one modular processing units or more than two processing units.

With reference now to FIG. 15, another representative enterprise is illustrated wherein one or more dynamically modular processing units are employed in a representative device. In FIG. 15, modular processing units 40 are used in a load-bearing configuration of a table assembly 120, which employs slide-on leg mounts 122 that couple to respective slide receivers on corresponding modular processing units 40 to comprise the legs of table assembly 120. In the illustrated configuration, a plurality of modular processing units 40 is physically and electronically coupled together, and comprises the primary physical structure of table assembly 120. Also shown is a slide-on DVD and hard drive module 124 that allow table assembly 120 to perform certain functions. Also illustrated is a plurality of modular processing unit bearing connectors 126.

These illustrations are merely exemplary of the capabilities of one or more modular processing units in accordance with embodiments of the present invention. Indeed, one of ordinary skill in the art will appreciate that embodiments of the present invention embrace many other configurations, environments, and set-ups, all of which are intended to be within the scope of embodiments of the present invention.

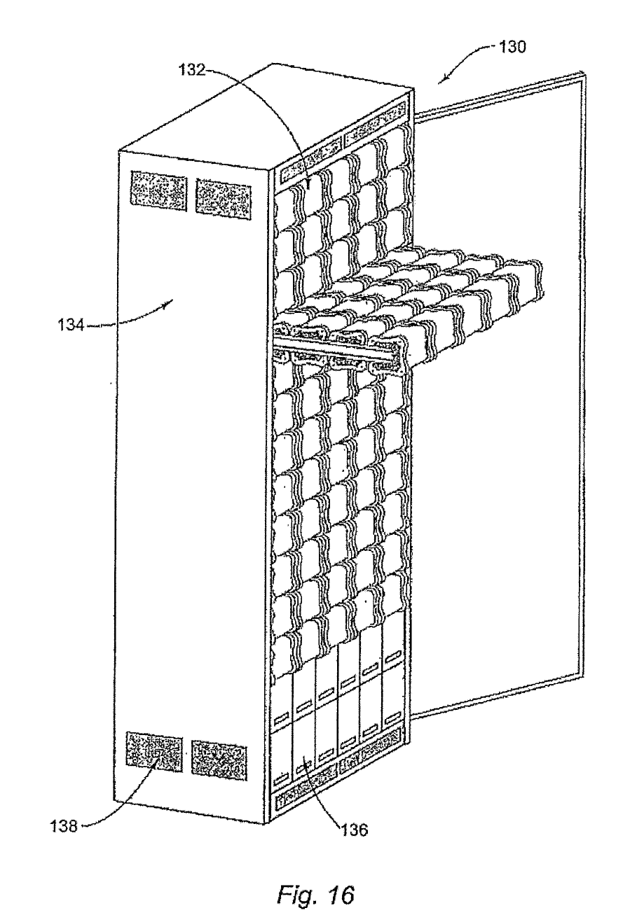

As provided herein, the dynamic and modular nature of the processing units allow for one or more processing units that may be used with all types of enterprises. With reference now to FIG. 16, enterprise 130 is a server array that is configured for server clustering and includes multiple dynamically modular processing units 132, each having a non-peripheral based encasement, which are housed in cabinet 134 and are available for use in processing data. In the illustrated embodiment, cabinet 134 includes drawers that receive modular processing units 132. Enterprise 130 further includes mass storage devices 136 for preserving data.

While FIG. 16 illustrates a cabinet that includes drawers configured to receive the individual processing units/cube, other embodiments of the present invention include the use of a mounting bracket that may be used in association with a processing unit/cube to mount the unit/cube onto a bar. The illustrated embodiment further includes a cooling system (not show) that allows for temperature control inside of cabinet 134, and utilizes vents 138.

The modular nature of the processing units/cubes is illustrated by the use of the processing units in the various representative enterprises illustrated. Embodiments of the present invention embrace chaining the units/cubes in a copper and/or fiber channel design, coupling the cubes in either series or parallel, designating individual cubes to perform particular processing tasks, and other processing configurations and/or allocations.

Each unit/cube includes a completely re-configurable motherboard. In one embodiment, the one or more processors are located on the back plane of the motherboard and the RAM modules are located on planes that are transverse to the back plane of the motherboard. In a further embodiment, the modules are coupled right to the board rather than using traditional sockets. The clock cycle of the units are optimized to the RAM modules.

While one method for improving processing powering an enterprise includes adding one or more additional processing units/cubes to the enterprise, another method includes replacing planes of the motherboard of a particular unit/cube with planes having upgraded modules. Similarly, the interfaces available at each unit/cube may be updated by selectively replacing a panel of the unit/cube. Moreover, a 32-bit bus can be upgraded to a 64-bit bus, new functionality can be provided, new ports can be provided, a power pack sub system can be provided/upgraded, and other such modifications, upgrades and enhancements may be made to individual processing units/cubes by replacing one or more panels.

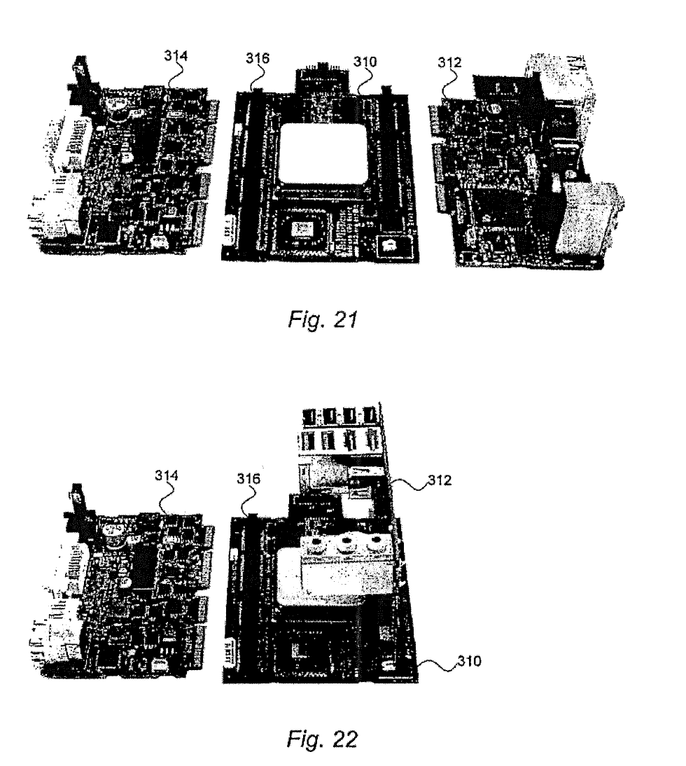

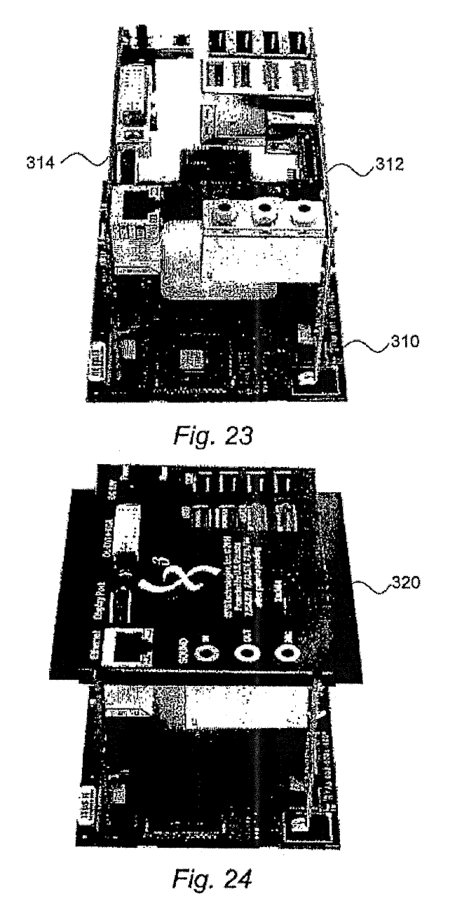

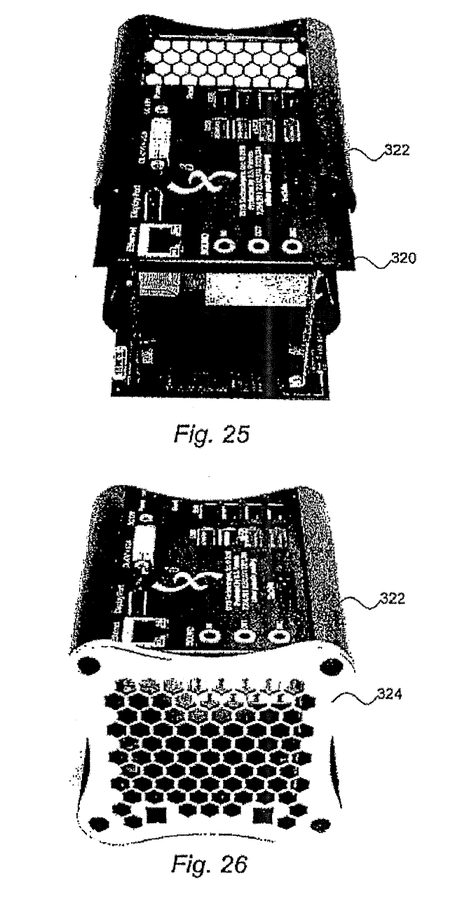

FIGS. 21 to 26 illustrate the assembly of a modular motherboard having three electronic circuit boards 310, 312, 314. These electronic circuit boards 310, 312, 314 are operably connected together with connectors 316. These figures also illustrate the assembly of a computer system wherein the modular motherboard is inserted into an enclosure 322, 320 with two end caps/plates 324.

Thus, in one aspect, a modular motherboard comprises: a first electronic circuit board performing a first function; and a second electronic circuit board performing a second function, wherein the first and second boards are operably connected to provide an integrated logic board for a computer system.

Implementations of the modular motherboard include one or more of the following features. A third electronic circuit board may performing a third function. The third electronic circuit board may operably connect to the first electronic circuit board. The first, second, and third electronic circuit boards can form a tri-board configuration. The first and second functions may include at least one of: (i) electronic storage; (ii) electronic memory; (iii) processing capability; and (iv) basic input output system. The first electronic circuit board may include a first bus operably connected to the second bus of the second electronic circuit board.

In another aspect, a modular processing unit comprises: an encasement; and a plurality of interconnected circuit boards coupled to the encasement, wherein a first circuit board of the plurality of interconnected circuit boards performs a first function and a second circuit board of the plurality of interconnected circuit board performs a second function.

Implementations of the modular motherboard include one or more of the following features. The first function may include electronic storage and the second function may include a processor. The encasement is a non-peripheral based encasement. The modular motherboard may further comprise an interchangeable backplane coupled to the encasement. A third circuit board of the plurality of circuit boards may include a basic input output system. A first circuit board of the plurality of circuit boards may further include electronic memory. A fourth circuit board of the plurality of circuit boards may include electronic memory. The plurality of interconnected circuit boards may have a tri-board configuration. The plurality of interconnected circuit boards may have a four-board configuration. The first and second of the plurality of interconnected circuit boards may be independently and interchangeably coupled to the encasement. The second of the plurality of interconnected circuit boards may be removed from the encasement and replaced with a new circuit board. The plurality of interconnected circuit boards may include three interconnected circuit boards.

In another aspect, a method of providing a modular motherboard comprises: providing a first electronic circuit board in a first plane, the first electronic circuit board having a first bus system; providing a second electronic circuit board in a second plane, the second electronic circuit board having a second bus system; mechanically coupling the first electronic circuit board to the second electronic circuit board; and electrically interconnecting the first bus system with the second bus system, wherein the motherboard performs logic functions for a computer system.

Implementations of the modular motherboard include one or more of the following features. The first electronic circuit board may have a first function and the second electronic circuit board has a second function. The first and second functions may include at least one of: (i) electronic storage; (ii) electronic memory; (iii) processing functions; and (iv) a basic input output system. The method may further comprise providing a third circuit board in a third plane, wherein the third circuit board has a third function. The method may further comprise providing a dynamic backplane.

### A Modular Motherboard Connector

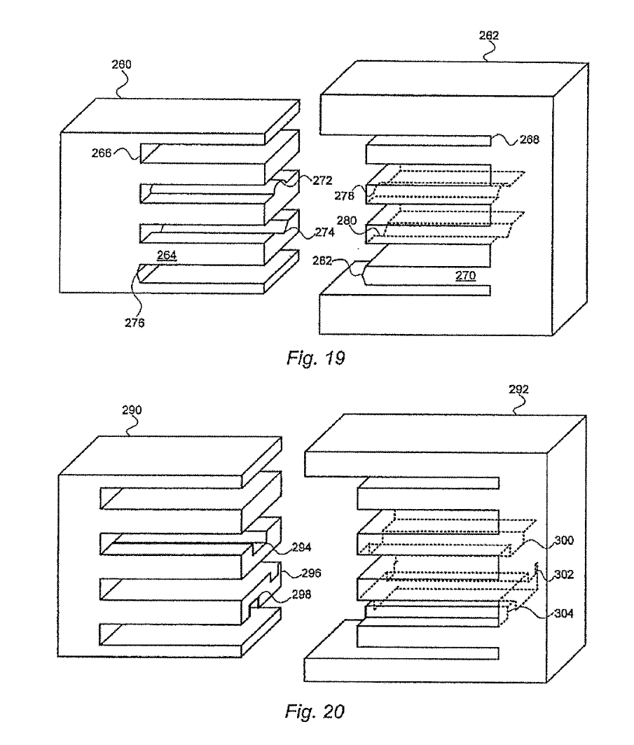

In some embodiments, the modular processing unit includes a modular motherboard comprised of two or more electronic circuit board connected with one or more motherboard connectors (“connectors”). The connectors provide an electronical connection and mechanical support to the interconnected circuit boards. In some embodiments, the connectors provide high-speed electronic communication capabilities between two interconnected circuit boards. Using a high-speed connector a modular motherboard performs like a nonmodular motherboard. Examples of motherboard connectors are illustrated in FIGS. 19-22.

Referring now to FIG. 19, a modular motherboard 200 is illustrated that includes a first 202 and second 204 electronic circuit boards. A number of motherboard components 206, 208, 210, 212, and 214 are included on the electronic circuit boards 202 and 204. The first circuit board 202 includes a first connector 216 and the second circuit board 204 includes a second connector 218. As shown, the connectors are not mated, but, by moving the first circuit board 202 in the direction of the arrow 219 the connectors mate with one another and a connection is made. The union of the two circuit boards forms a single, modular motherboard.

In other embodiments, the modular motherboard 200 includes three or more circuit boards (not shown), each connected to another circuit board by one or more motherboard connector(s). In yet other embodiments, the modular motherboard includes three or more circuit boards (not shown), and only two of the three of more boards are connected by motherboard connectors.

As shown in FIG. 19, the connectors 216 and 218 have corresponding geometries. This correspondence allows the connectors 216 and 218 to mate completely. In some embodiments, the geometry of each connector includes more than one functional association of forms, or “sub-geometry”. One such sub-geometry will be referred to herein as the “connection sub-geometry.” The connection sub-geometry includes the necessary forms and structures used to electrically and mechanically connect with a connector having a corresponding connection sub-geometry. For example, the “connection sub-geometry” of FIG. 19, includes slots 213a, 213b, 213c, 213d, and 213e and elongated protrusions 215a, 215b, and 215c. The slots 213 are configured to securely receive the elongated protrusions 215 to provide a mechanical and electrical connection.

As will be understood by one of skill in the art, the connection sub-geometry of a motherboard connector can have a variety of forms or shapes to provide means for mechanically connecting with a corresponding connector. While FIGS. 19-22 illustrate connectors having protrusions and slots, any other type of other mechanical and/or electrical connector may be utilized which can mechanically and electrically connects two electrical circuit boards. In some embodiments, the connection sub-geometry can include one or more of the following: fingers and cavities, peaks and valleys, plugs and receptacles, latches, fittings, locking devices, or any other known set of mating structures.

In some embodiments, an electrical connection is made by bringing into contact electrical contacts disposed on the connectors 216 and 218. As used herein the term “electrical contacts” refers to any structure disposed on a connector that is known by one of skill in the art to establish an electrical connection between two connectors. For example, a contact can be a metal contact pad, such as a copper contact pad. In some embodiments, the motherboard connector includes a ground connector and a plurality of electrical contacts (not shown). In other embodiments, the slots 213 and elongated protrusions 215 include a plurality of electrical contacts. In some embodiment, electrical contacts are located on the distal end of the protrusions 215 and on the inner recess of the slots 213. In other embodiments, electrical contacts are located throughout the length of the protrusions 215 and slots 213. In some embodiments, the electrical connectors only operably connect when the motherboard connectors are completely mated. If the motherboard connectors are restricted from completely mating the electrical connectors do not provide adequate electrical communication between the motherboard connectors.

Additional examples of connection sub-geometries are illustrated in FIGS. 20-22 and described below.

In some embodiments, the connector geometry includes a second sub-geometry, a “security sub-geometry.” The security sub-geometry comprises one or more security key structure(s) included on the connector geometry. A security key structure limits the ability of the connector to connect with any connector that does not have a corresponding security key structure. In some embodiments, part or all of a “security sub-geometry” is formed into or onto the form or structure of a connection sub-geometry. In other embodiments, the security sub-geometry is disposed on a separate portion of a connector than the connection sub-geometry. By analogy, the security sub-geometries of two motherboard connectors act like notches and grooves in a key and keyhole. Like notches and grooves, the security sub-geometries discriminate against mating with a motherboard connector that does not have a corresponding security sub-geometry, or a corresponding “keyed configuration.”

FIG. 20 illustrates a side view of one embodiment of a pair of motherboard connectors 222 and 224. The geometries of the connectors 222 and 224 are corresponding such that the first connector 222 can mate with the second connector 224 to provide a mechanical and electrical connection. Each connector geometry includes a connection sub-geometry and a security sub-geometry. The connection sub-geometry of the first connector includes a plurality of protrusions 246a-e and a plurality of slots 246a-d. The connection sub-geometries of the second connector 224 include a plurality of protrusions 248a-d and a plurality of slots 244a-e.

Each connector geometry also includes a security sub-geometries. The security sub-geometry of the first connector 222 includes a plurality of security key structures 226, 230, 234, and 238. The security sub-geometry of the second connector 224 includes a plurality of security key structures 228, 232, 236, and 240. The security sub-geometries of the first 222 and second 224 connectors correspond so that the geometries of the first 222 and second 224 connectors can mate and provide an electrical and mechanical connection between two circuit boards.

It will be noted that if either the first 222 or second 224 connector did not include its security key structures the two connectors could not completely mate. Thus, the security key structures discriminate against mating with connectors that do not have corresponding security key structures. For instance, if the protrusion 246c of the first connector 222 did not have the security key structure 238 the security feature 240 in slot 244c would discriminate against the first connector completely mating with the second connector 224. Likewise, if the protrusion 248d did not have the security key structure 232 then the second connector 224 could not completely mate with the first connector 222. The same is true with the other security key structures 226, 228, 234, and 236 of the two connectors 222 and 224.

FIG. 21 illustrates a three-dimensional view of another embodiment of two corresponding motherboard connectors 260 and 262. The first connector 260 includes a number of elongated protrusions 264 and slots 266. Likewise, the second connector 262 includes a number of elongated protrusions 270 and slots 268. The protrusions and slots comprise connection sub-geometries of each connector, which correspond to the connection sub-geometry of the other connector. Each connector includes a number of security key structures that comprises its security sub-geometry. For instance, the first connector 260 includes three security key structures 272, 274, and 276. Likewise, the second connector 262 includes three security key structures 278, 280, and 282 that correspond to those of the first connector 260. Like the security key structures of FIG. 20, the security key structures of FIG. 21 these security key structures discriminate against completely mating with another connector that does not have corresponding security key structure. It will be noted that security key structures 272 and 280 will prevent any degree of mating with a connector that does not have corresponding key structures.

FIG. 22 illustrates another three-dimensional embodiment of two corresponding motherboard connectors 290 and 292. The motherboard connectors 290 and 292 include corresponding geometries, which include corresponding connection and security sub-geometries. The connectors have connection sub-geometries comprising a number of corresponding elongated protrusions and slots, similar to those of FIGS. 20-21. The connectors also have corresponding security sub-geometries comprised of a number of security key structure 294, 296, 298, 300, 302, and 304. The security key structures are one type of notches and grooves, which have been uniquely positioned on the protrusions of the connectors to prevent mating with any connector that has a non-corresponding geometry.

As will be understood by one of skill in the art, the security sub-geometry of a motherboard connector can take a variety of forms or shapes. In some embodiments a security sub-geometry includes a number of different types of security key structures, as in FIG. 20. In other embodiments, security sub-geometry includes a single type of security key structures, as in FIG. 22, which includes only notches and grooves.

A variety of security key structures can be incorporated with any security sub-geometry. For example, FIG. 20 illustrates a number of security key structure types, such as: an indented protrusion 228, an elongated protrusion 236, the first keyed protrusion 232, a second keyed protrusion 238. Each of these security key structures has a corresponding key structure on the opposite connector. FIG. 21 illustrates other types of security key structures, namely: a rounded notch 272, a triangular notch 274, and a triangular elongate protrusion 282. Each of these security key structures has a corresponding security key structure on the opposite connector. FIG. 22 illustrates various notches 300, 302, and 304 with their corresponding groves 294, 296, and 298. It will be recognized by one of skill in the art that this list of security key structure types is not exhaustive, but that a wide variety of security key structures and structure types can be incorporated in the present invention.

The unique positioning, size, and shape of the security key structures provides the motherboard connectors with a unique keyed configuration. By modifying any one of these features an alternate keyed configuration can be created. As explained above, in some embodiments, the motherboard connectors must be completely mated to establish an adequate electrical connection. So, if a security key structure prevent two non-corresponding motherboard connectors from completely mating those connectors can not establish an electrical connection and no electrical communication is established. In some embodiments, the motherboard connectors must be completely mated for a secure mechanical connection to be established as well. For example, a connection sub-geometry may include latches, hooks, indentions, or the like which secure the connectors when completely mated. In this way the security key structures limit connectivity of the connectors to mate with corresponding security sub-geometries.

In some embodiments, a motherboard connector includes a housing to house the internal workings of the connector. In some embodiments, the housing includes a plurality of interior, parallel circuit boards. Each interior circuit board includes at least one signal and ground line. The signal and ground lines are incorporated onto the circuit board. These lines connect with the housing at a circuit board interface and at a mating interface. The mating interface provides an electrical connection to the electrical portion of the connection sub-geometry of the connector. The circuit board interface connects and communicates electrical signals from the circuit board through the connectors. Thus, when two motherboard connectors are interconnected, electrical signals are sent through the circuit board interface of a first connector, then through the signal lines to the mating interface. At the mating interface the electrical signal is sent via the electrical contacts on the connection sub-geometries of the mated connectors. This signal is then sent via the mating interface of the second motherboard connector through the signal lines, to the board connector, where it is routed to the appropriate electrical component of the second circuit board. Thus, communication signals are transferred between interconnected circuit boards in a modular motherboard system.

Thus, as discussed herein, embodiments of the present invention embrace systems and methods for providing a dynamically modular processing unit. In particular, embodiments of the present invention relate to providing a modular processing unit that is configured to be selectively oriented with one or more additional units in an enterprise. In at least some embodiments, a modular processing unit includes a non-peripheral based encasement, a cooling process (e.g., a thermodynamic convection cooling process, a forced air cooling process, and/or a liquid cooling process), an optimized layered printed circuit board configuration, optimized processing and memory ratios, and a dynamic back plane that provides increased flexibility and support to peripherals and applications.

The present invention may be embodied in other specific forms without departing from its spirit or essential characteristics. The described embodiments are to be considered in all respects only as illustrative and not restrictive. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

In one aspect, a modular processing unit comprises: a modular motherboard having a first electronic circuit board and a second electronic circuit board, the first electronic circuit board includes a first motherboard connector and the second electronic circuit board includes a second motherboard connector being operably connected to the first motherboard connector; and a dynamic backplane coupled to the modular motherboard, wherein the dynamic backplane supports communication between the modular motherboard and an external device.

Implementations of the modular processing unit may include one or more of the following features. The first motherboard connector may include a first geometry comprising a first sub-geometry shaped to securely mate with the second motherboard connector and a second sub-geometry having a security key structure that discriminates against mating with a second motherboard connector not having a corresponding security key structure. The second motherboard connector may include a second geometry comprising a third sub-geometry shaped to be securely mate with the first motherboard connector and a fourth sub-geometry shaped having a security key structure corresponding with the security key structure of the first motherboard connector. The first electronic circuit board may be in a first plane and the second electronic circuit board is in a second plane. The modular processing unit may further comprise a non-peripheral based encasement coupled to the modular motherboard.

### Customizable Computer Processing Unit

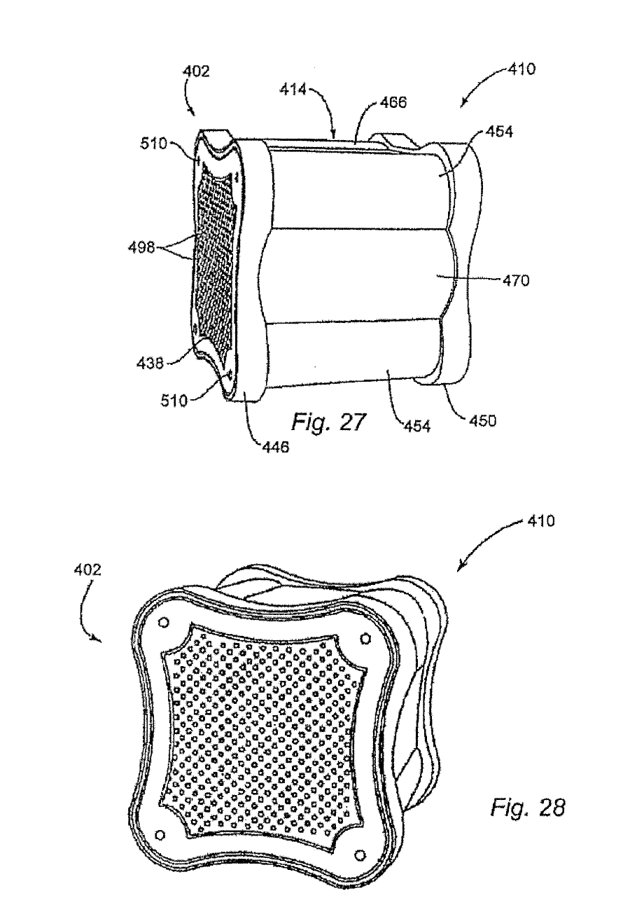

With specific reference to FIGS. 27 and 28, the present invention features in one exemplary embodiment, and the figures illustrate, a proprietary non-peripherals or non-peripherals-based processing control unit 402, shown in perspective view. In its simplest form, processing control unit 402 comprises a proprietary encasement module 410, as well as a proprietary printed circuit board design (shown in FIG. 34). Processing control unit 402, through the specific and calculated design of encasement module 436, provides unparalleled computer processing advantages and features not found in prior art processing units or computers. Indeed, the present invention processing control unit, as described and claimed herein, presents a complete conceptual shift, or paradigm shift, from conventional computers or processing control units. This paradigm shift will become evident from the subject matter of the disclosure below, which subject matter is embodied in the appended claims.

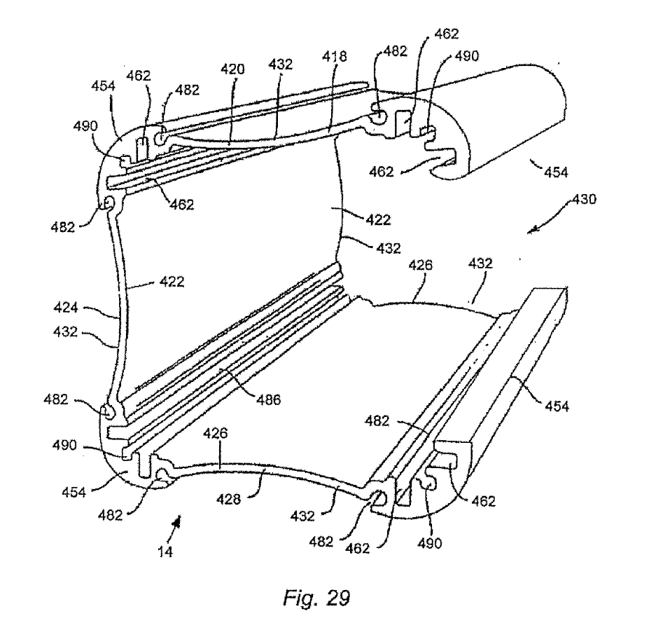

FIGS. 27 and 28 show processing control unit 402 in its fully assembled state with many of the primary components of processing control unit 402 generally illustrated. As stated, processing control unit 402 comprises encasement module 410, which itself has a very specific and unique support structure and geometric configuration or design that is more fully described with respect to FIG. 29. In one representative and presently preferred embodiment, encasement module 410 comprises a main support chassis 414; first insert 466; second insert 470; third insert 474 (not shown); dynamic backplane 434 (not shown); first end plate 438; second end plate 442 (not shown); first end cap 446; and second end cap 450 to provide an enclosed housing or encasement for one or more processing and other computer components, such as printed circuit boards, processing chips, and circuitry.

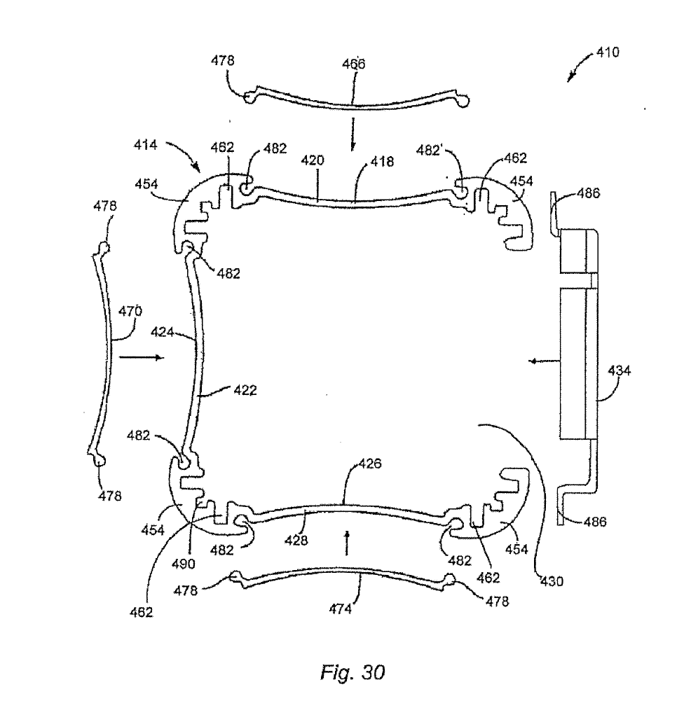

FIGS. 29 and 30 illustrate an exemplary embodiment of main support chassis 414 and some of the component parts of encasement module 410 as designed to attach or couple to main support chassis 414. Preferably, these component parts are removably coupled to primary chassis 414, as shown, in order to enable some of the unique features and functions of processing control unit 402 as described and set forth herein. Main support chassis 414 serves as the primary support structure for encasement module 410 and processing control unit 402. Its small size and proprietary design provide advantages and benefits not found in prior art designs. Essentially, main support chassis 414 provides structural support for the component parts of processing control unit 402, including any additional physical attachments, processing and other circuit board components, as well as enabling processing control unit 402 to be adaptable to any type of environment, such as incorporation into any known structure or system, or to be used in clustered and multi-plex environments.

Specifically, as shown in FIGS. 29 and 30, processing control unit 402, and particularly encasement module 410, is essentially comprised of a cube-shaped design, wherein first, second, and third wall supports 418, 422, and 426 of main support chassis 414, along with dynamic backplane 434, when attached, comprise the four sides of encasement module 410, with a union module, or junction center 54 positioned at each corner of encasement module 410.

In some embodiments, junction center 454 functions to integrally join first, second, and third wall supports 418, 422, and 426, as well as to provide a base to which the end plates discussed below may be attached. End plates are coupled to main support chassis 414 using attachment means as inserted into attachment receiver 490, which is shown in FIG. 29 as an aperture, and which may be threaded or not depending upon the particular type of attachment means used.

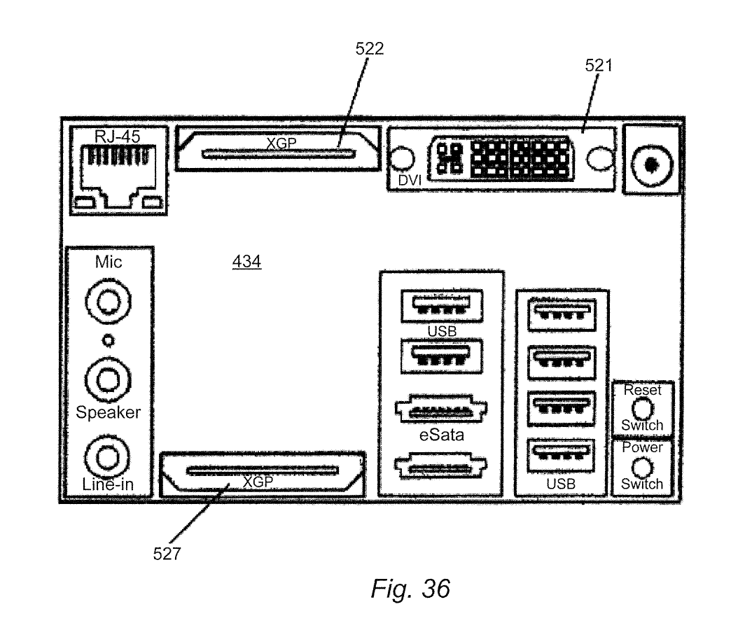

In some embodiments, junction center 54 further provides the primary support and the junction center for at least a portion of the proprietary printed circuit board design existing within processing control unit 402 as discussed below. As shown in FIG. 29 (and as discussed in greater detail below with respect to FIG. 36), a printed circuit board or a board supporting a printed circuit board (neither of which are shown in FIG. 29) is capable of being inserted into and secured within one or more channeled board receivers 462. The particular design shown in the figures and described herein is merely an example of one embodiment or means for securing or engaging printed circuit boards within processing control unit 402. Other designs, assemblies, or devices are contemplated and may be used as recognized by one ordinarily skilled in the art. For instance, means for securing processing components may include screws, rivets, interference fits, and others commonly known.

Main support chassis 414 further comprises a plurality of slide receivers 482 designed to receive a corresponding insert located on one or more insert members, a dynamic backplane, or a mounting bracket of some sort used to couple two or more processing control units together, or to allow the processing control unit to be implemented into another structure, such as a Tempest superstructure. Slide receivers 482 may also be used to accept or receive suitable elements of a structure or a structure or device itself, wherein the processing control unit, and specifically the encasement module, serves as a load bearing member. The ability of processing control unit 402 to function as a load bearing member is derived from its unique chassis design. For example, processing control unit 402 may be used to bridge two structures together and to contribute to the overall structural support and stability of the structure. In addition, processing control unit 402 may bear a load attached directly to main support chassis 414. For example, a computer screen or monitor may be physically supported and process controlled by processing control unit 402. As further examples, processing control unit 402 may be used to physically support and process control various home fixtures, such a lighting fixture, a breaker box, etc. Moreover, if needed, an additional heat sink assembly may be coupled exterior to processing control unit 402 in a similar manner. Many other possible load bearing situations or environments are possible and contemplated herein. Thus, those specifically recited herein are only meant to be illustrative and not limiting in any way. Slide receivers 482 are shown as substantially cylindrical channels running the length of the junction center 454 of main support chassis 414. Slide receivers 482 comprise merely one means of coupling external components to main support chassis 414. Other designs or assemblies are contemplated and may be used to carry out the intended function of providing means for attaching various component parts, such as those described above as recognized by one ordinarily skilled in the art.

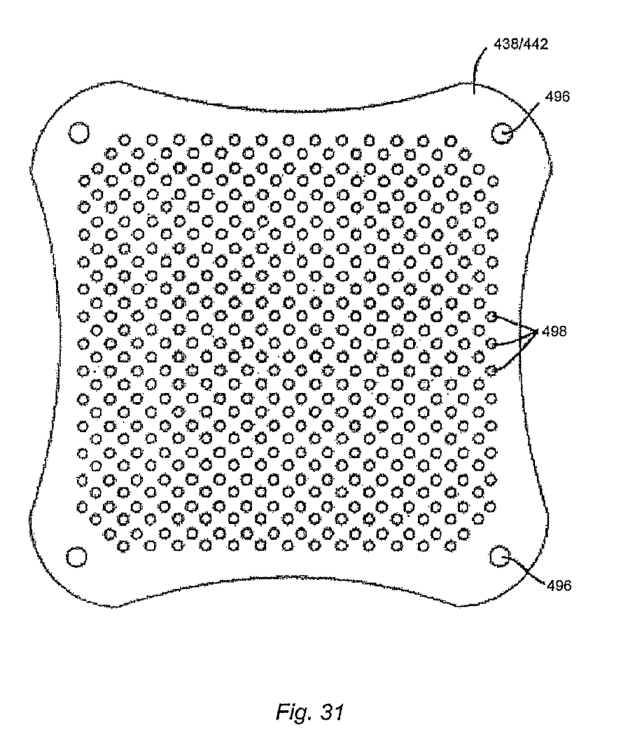

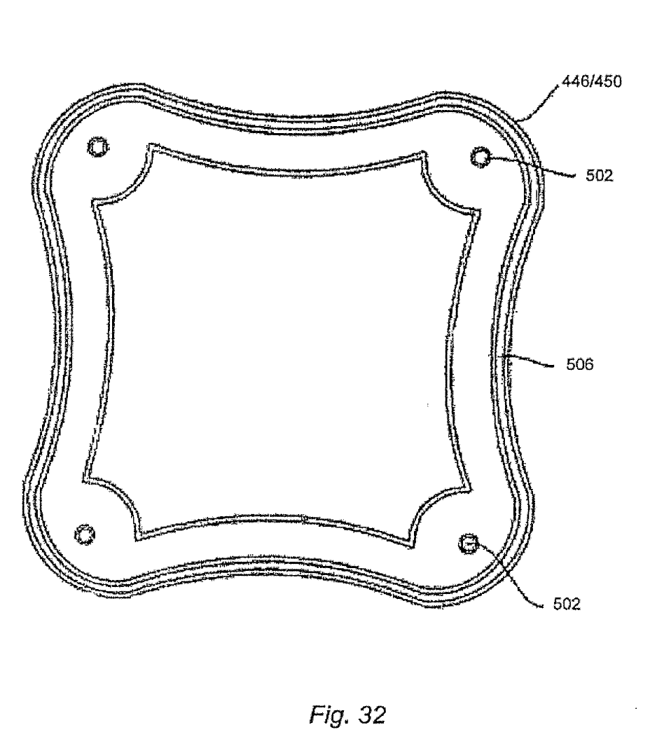

FIGS. 29 and 30 further illustrate the concave nature of main support chassis 414, and particularly first, second, and third wall supports 418, 422, and 426. First, second, and third insert members 466, 470, and 474 comprise corresponding concave designs. Each of these component parts further comprises a specifically calculated radius of curvature, such that first wall support 418 comprises a radius of curvature 420 to correspond to a mating radius of curvature designed into first insert 466. Likewise, second wall support 422 comprises a radius of curvature 424 to correspond to a mating radius of curvature designed into second insert 470, and third wall support 426 comprises a radius of curvature 428 to correspond to a mating radius of curvature designed into third insert 474. End plates 438 and 442, as well as end caps 446 and 450, as illustrated in FIGS. 31 and 32, each comprise similar design profiles to match the concave design profile of main support chassis 414. In the embodiment shown in FIGS. 29 and 30, the wall supports comprise a radius of curvature of approximately 2.8 inches, and insert members comprise a radius of curvature of approximately 2.7 inches. The concaved design and the calculated radius of curvature each contribute to the overall structural rigidity and strength of main support chassis 414, as well as contributing to the thermodynamic heat dissipating properties of processing control unit 402. For example, in a natural convection cooling system, described in greater detail below, the concaved design facilitates the distribution of heated air to the outer, and primarily upper, corners of encasement module 410, thus allowing heat or heated air to be dispersed away from the top and center of the interior portion of processing control unit 402 and towards the upper right and left corners, where it may then escape thru ventilation ports 498 (FIG. 31) or where it may be further conducted through the top of encasement module 410. Other embodiments are contemplated where the radius of curvature of these elements may differ from one another to provide the most optimal design of encasement module 410 as needed.

In a preferred embodiment, main support chassis 414 comprises a full metal chassis that is structured and designed to provide an extremely strong support structure for processing control unit 402 and the components contained therein. Under normal circumstances, and even extreme circumstances, main support chassis 414 is capable of withstanding very large applied and impact forces originating from various external sources, such as those that would normally cause disfiguration or denting to prior related computer encasements, or limit their ability to be used in other or extreme environments.

Essentially, main support chassis 414 is the main contributor to providing a virtually indestructible computer encasement for processing control unit 402. This unique feature in a computer encasement is in direct relation to the particular design of the components used to construct encasement module 410, including their geometric design, the way they are fit together, their material composition, and other factors, such as material thickness. Specifically, encasement module 410 is preferably built entirely out of radiuses, wherein almost every feature and element present comprises a radius. This principle of radiuses is utilized to function so that any load applied to processing control unit 402 is transferred to the outer edges of processing control unit 402. Therefore, if a load or pressure is applied to the top of encasement module 410, that load would be transferred along the sides, into the top and base, and eventually into the corners of encasement module 410. Essentially, any load applied is transferred to the corners of processing control unit 402, where the greatest strength is concentrated.

Processing control unit 402 and its components, namely encasement module 410; main support chassis 414; inserts 466, 470, and 474; dynamic backplane 434; and end plates 438 and 442, are each preferably manufactured of metal using an extrusion process. In one exemplary embodiment, main support chassis 14, first, second, and third inserts 466, 470, and 474, dynamic backplane 34, and first and second end plates 38 and 42 are made of high-grade aluminum to provide strong, yet light-weight characteristics to encasement module 410. In addition, using a metal casing provides good heat conducting properties. Although preferably constructed of aluminum or various grades of aluminum and/or aluminum composites, it is contemplated that various other materials, such as titanium, copper, magnesium, the newly achieved hybrid metal alloys, steel, and other metals and metal alloys, as well as plastics, graphite, composites, nylon, or a combination of these depending upon the particular needs and/or desires of the user, may be used to construct the main components of encasement module 410.

In essence, the intended environment for use of the processing control unit will largely dictate the particular material composition of its constructed components. As stated, an important feature of the present invention is the ability of the processing control unit to adapt and be used for several uses and within several different and/or extreme environments. As such, the specific design of the processing control unit relies upon a concerted effort to utilize the proper material. Stated differently, the processing control unit of the present invention contemplates using and comprises a pre-determined and specifically identified material composition that would best serve its needs in light of its intended use. For example, in a liquid cooled model or design, a more dense metal, such as titanium, may be used to provide greater insulative properties to the processing control unit.

Given its preferred aluminum composition, encasement module 410 is very strong, light-weight, and easy to move around, thus providing significant benefits extending to both the end user and the manufacturer. For example, from an end user standpoint, processing control unit 402 may be adapted for use within various environments in which prior related computers could not be found. In addition, an end user may essentially hide, mask, or camouflage processing control unit 402 to provide a cleaner looking, less-cluttered room, or to provide a more aesthetically appealing workstation.

From a manufacturing standpoint, encasement module 410 and processing control unit 402 are capable of being manufactured using one or more automated assembly processes, such as an automated aluminum extrusion process-coupled with an automated robotics process for installing or assembling each of the component parts as identified above. Equally advantageous is the ability for encasement module 410 to be quickly mass-produced as a result of its applicability to an extrusion and robotics assembly process. Of course, processing control unit 402 may also be manufactured using other known methods, such as die casting, injection molding, and hand assembly—depending upon the particular characteristics desired and the particular intended use of the processing control unit.

In addition, since encasement module 410 is small in size and relatively light-weight, shipping costs, as well as manufacturing costs, are also greatly reduced.

With continued reference to FIG. 30, shown are the main components of encasement module 10, namely main support chassis 414 and the several inserts that are designed to removably attach or couple to the sides of main support chassis 414. FIG. 26 also illustrates a representative embodiment of dynamic backplane 434 as it is designed to removably attach or couple to the rear portion of main support chassis 414.

Specifically, first insert 466 attaches to first wall support 418. Second insert 470 attaches to second wall support 422. Third insert 474 attaches to third wall support 426. Moreover, each of first, second, and third inserts 466, 470, and 474, and first, second, and third wall supports 418, 422, and 426 comprise substantially the same radius of curvature so that they may mate or fit together in a nesting or matching relationship.

Each of first, second, and third inserts 466, 470, and 474 comprise means for coupling with main support chassis 414. In one exemplary embodiment, as shown in FIG. 30, each insert comprises two insert engagement members 478 located at opposing ends of the insert. Engagement members 478 are designed to fit within a means for engaging or coupling with various external devices, systems, objects, etc. (hereinafter an external object), wherein the means for engaging is formed within main support chassis 414. In the exemplary embodiment shown, means for engaging an external object comprises a plurality of slide receivers 82 positioned along main support chassis 414, as shown and identified above in FIG. 29. Other means are also contemplated, such as utilizing various attachments ranging from snaps, screws, rivets, interlocking systems, and any others commonly known in the art.

Dynamic backplane 434 is also designed for or is capable of releasably coupling with main support chassis 414. Dynamic backplane 434 comprises means for engaging main support chassis 414. In the exemplary embodiment shown, means for engaging is comprised of two engagement members 486 positioned at opposing ends of dynamic backplane 434. Engagement members 486 fit within channeled board receivers 462 at their respective locations along the rear portion of main support chassis 414 (shown as space 430) to removably attach dynamic backplane 434 to main support chassis 414. Thus, in at least some embodiments, dynamic backplane 434 can be slidably received in and released from main support chassis 414. These particular features are intended as one of several possible configurations, designs, or assemblies. Therefore, it is intended that one skilled in the art will recognize other means available for attaching dynamic backplane 434 to main support chassis 414 other than those specifically shown in the figures and described herein.

Means for engaging an external object, and particularly slide receiver 482, is capable of releasably coupling various types of external objects, such as inserts 466, 470, and 474, mounting brackets, another processing control unit, or any other needed device, structure, or assembly. As illustrated in FIG. 30, slide receivers 482 engage corresponding engagement members 478 in a releasable manner so as to allow each insert to slide in and out as needed. As stated, other means for coupling main support chassis 414 and means for engaging an external object are contemplated herein, and will be apparent to one skilled in the art.

By allowing each insert and dynamic backplane 434 to be removably or releasably coupled to main support chassis 414, several significant advantages to processing control unit 402, over prior related computer encasements, are achieved. For example, and not intended to be limiting in any way, first, second, and third inserts 466, 470, and 474 may be removed, replaced, or interchanged for aesthetic purposes. These insert members may possess different colors and/or textures, thus allowing processing control unit 402 to be customized to fit a particular taste or to be more adaptable to a given environment or setting. Moreover, greater versatility is achieved by allowing each end user to specify the look and overall feel of their particular unit. Removable or interchangeable insert members also provide the ability to brand (e.g., with logos and trademarks) processing control unit 402 for any company entity or individual using the unit. Since they are external to main support chassis 414, the insert members will be able to take on any form or branding as needed.

Aside from aesthetics, other advantages are also recognized. For example, because dynamic backplane 434 can be removed, replaced, and interchanged with another dynamic backplane (as discussed hereinafter), processing control unit 402 can be easily customized to be process coupled with a variety of external devices.

On another level of versatility, means for engaging an external object provides processing control unit 402 with the ability to be robust and customizable to create a smart object. For instance, processing control unit may be docked in a mobile setting or in a proprietary docking station where it may serve as the control unit for any conceivable object, such as boats, cars, planes, and other items or devices that were heretofore unable to comprise a processing control unit, or where it was difficult or impractical to do so.

With reference to FIG. 31, shown is an illustration of one of first end plate 438 or second end plate 442 that couples to first and second end portions 440 and 444 of primary chassis 414, respectively, and functions to provide means for allowing air to flow or pass in and out of the interior of processing control unit 402. First and second end plates 438 and 442 function with first and second end caps 446 and 450 (shown in FIG. 32), respectively, to provide a protective and functional covering to encasement module 410. First and second end plates 438 and 442 attach to main support chassis 414, using attachment means 510 (as shown in FIG. 27). Attachment means 510 typically comprises various types of screws, rivets, and other fasteners as commonly known in the art, but may also comprise other systems or devices for attaching first and second end plates 438 and 442, along with first and second end caps 446 and 450, to main support chassis 414, as commonly known in the art. In an exemplary embodiment, attachment means 510 comprises a screw capable of fitting within the respective attachment receivers 490 located in junction center 454 at the four corners of main support chassis 414 (attachment receivers 490 and junction centers 454 are illustrated in FIG. 29).

Structurally, first and second end plates 438 and 442 comprise a geometric shape and design to match that of end portions 440 and 444 of main support chassis 414. Specifically, as shown in FIG. 31, the perimeter profile of first and second end plates 438 and 442 comprises a series of concave edges, each having a radius of curvature to match those of the respective wall supports and dynamic backplane. Essentially, end plates 438 and 442 serve to close off the ends of encasement module 410 by conforming to the shape of encasement module 410, whatever that may be.

One of the primary functions of first and second end plates 438 and 442 is to provide means for facilitating or allowing the influx of air into and efflux of air out of encasement module 410. In the representative embodiment shown in FIG. 31, such means comprises a plurality of apertures or ventilation ports 498 intermittently spaced along the surface or face of and extending through end plates 438 and 442.

In one embodiment, processing control unit 402 utilizes natural convection to cool the processing components contained therein. By equipping end plates 438 and 442 with ventilation ports 498, ambient air is allowed to enter into the interior of processing control unit 402, while the heated air, as generated from the processors and other components located within the interior of processing control unit 402, is allowed to escape or flow from the interior to the outside environment. By natural physics, heated air rises and is forced out of encasement module 410 as cooler air is drawn into encasement module 410. This influx and efflux of ambient and heated air, respectively, allows processing control unit 402 to utilize a natural convection cooling system to cool the processors, internal heat sinks (as discussed hereinafter), and other internal components functioning or operating within processing control unit 402. Ventilation ports 498 are preferably numerous, and span a majority of the surface area of end plates 438 and 442, and particularly the outer perimeter regions, thus enabling increased and efficient cooling of all internal components in an air-cooled model.

In some embodiments, ventilation ports 498 are machined to exact specifications to optimize airflow and to constrict partial flow into encasement module 410. By constricting some flow, dust and other sediments or particles are prohibited from entering the interior of encasement module 410 where they can cause damage to and decreased performance of processing control unit 402. Indeed, ventilation ports 498 are preferably sized to only allow air particles to flow therethrough.

Because encasement module 410 is preferably made of metal, the entire structure, or a portion of the structure, can be positively or negatively charged to prohibit dust and other particles or debris from being attracted to the encasement. Such an electrostatic charge also prevents the possibility of a static charge jumping across dust and other elements and damaging the main board. Providing an electrostatic charge is similar to ion filtering, only opposite. By negatively charging encasement module 410, all positively charged ions (i.e. dust, dirt, etc.) are repelled.

FIG. 6 illustrates first end cap 446 and second end cap 450, which are designed to fit over first and second end plates 438 and 442, respectively, as well as over a portion of each end portion 440 and 444 of main support chassis 414. These end caps are preferably made of some type of impact absorbing plastic or rubber, thus serving to provide a barrier of protection to processing control unit 402, as well as to add to its overall look and feel.

In one presently preferred embodiment, processing control unit 402 comprises a rather small footprint or size relative to or as compared with conventional computer encasements. For example, in a presently preferred embodiment, its geometric dimensions are approximately 3.6 inches in length, 3.6 inches in width, and 3.6 inches in height, which are much smaller than prior related conventional processing control units, such as desktop computers or even most portable computers or laptops. In addition to its reduced dimensional characteristics, processing control unit 402 comprises rather unique geometrical characteristics as well. FIGS. 27 and 28 illustrate this unique shape or geometry, most of which has been discussed above. These dimensional and geometrical characteristics are proprietary in form and contribute to the specific, unique functional aspects and performance of processing control unit 402. They also provide or lend themselves to significant features and advantages not found in prior related processing control units. Stated differently, the proprietary design of processing control unit 402, as described and shown herein, allows it to perform in ways and to operate in environments that are otherwise impossible for prior related conventional computer encasements and processing units.

It is important to state that processing control unit 402 can take on any size and/or geometric shape. Although in the preferred embodiment processing control unit 2 is substantially cube-shaped having approximately a 3.6 inch×3.6 inch×3.6 inch size, other sizes and shapes are intended to be within the scope of the present invention. For example, processing control unit can be substantially rectangular, cylindrical, triangular, polygonal, irregular in shape, etc. Specifically, as recited herein, the processing control unit may be adapted for use in various structures or super structures, such as any conceivable by one ordinarily skilled in the art. In this sense, processing control unit 402 must be able to comprise a suitable size and structure to be able to take on the physical attributes of its intended environment. For example, if processing control unit is to be used within a thin hand-held device, it will be constructed having a thin profile physical design, thus deviating away from the cube-like shape of the preferred embodiment. As such, the various computer and processing components used within processing control unit 402 are also capable of associated sizes and shapes and designs.

As is apparent from its size, in some embodiments, processing control unit 402 comprises none of the peripheral components that are typically found within certain prior art computer encasements, such as a desktop, a personal computer, or a laptop. Hence, in some embodiments, processing control unit 402 is referred to as being “non-peripherally-based.” Indeed, processing control unit 402 comprises a proprietary non-peripheral design, with the term “peripheral” referring to any one of or all of the several types of existing components commonly known in the art and commonly housed within prior art computer encasements. In some preferred embodiments, any peripheral devices are process coupled to processing control unit 402, but are not physically included in the makeup of the unit. Peripheral devices may be attached or coupled using the methods described herein, such as through a slide-on, or snap-on system. Obviously, however, if desired, processing control unit 402 may be designed to include any conventional peripheral devices as found in the prior art, such as a hard drive, a CD-ROM drive, memory storage devices, etc. The present invention, therefore, is not limited to a non-peripheral design.

Some of the most common types of peripheral devices or components are mass or media storage devices (e.g., hard disk drives, magnetic disk drives, magnetic cassette drives, solid-state memory drives, floppy disc drives, CD-ROM drives, DVD drives, Zip drives, etc.), video cards, sound cards, and internal modems. All these types of peripheral devices or components, although not typically physically supported by or actually physically present within encasement module 410 and processing control unit 402, are nonetheless still intended to be compatible, functional, and/or operational with processing control unit 402 as designed. It should be noted that these described devices are typically considered to be peripherals. However, these items may also be integrated or embedded into the printed circuit board design of processing control unit 402, wherein they do not comprise or are not considered to be peripherals, but are instead part of the logic associated with the printed circuit board design of processing control unit 402. For example, a video card and sound card may be part of the logic of one or more of the printed circuit boards (discussed below) that is disposed within processing control unit 402.

Although preferably containing no internal peripheral devices as identified above, processing control unit 402 still preferably comprises a system bus as part of its internal architecture. The system bus is designed to function as commonly known in the art, and is configured to connect and make operable the various external components and peripheral devices that would otherwise be internal. The system bus also enables data to be exchanged between these components and the processing components of processing control unit 402.

The system bus may include one of a variety of bus structures including a memory bus or memory controller, a peripheral bus, or a local bus that uses any one of a variety of bus architectures. Typical components connected by the system bus include a processing system and memory. Other components may include one or more mass storage device interfaces, one or more input interfaces, one or more output interfaces, and/or one or more network interfaces.

Processing control unit 402, although designed or intended to outperform prior related computer systems, is designed to be at least as functional as these computer systems. Therefore, everything a user is capable of doing on a typical or commonly known computer system (e.g. a desktop computing system) can be done on the computer system of the present invention. From a practical standpoint, this means that no functions or operations are sacrificed, but many are gained. As such, to be able to accomplish this using the proprietary design described herein, processing control unit 402 must be able execute similar tasks as prior related computers or computer processors, as well as to be able to access or utilize those components required to perform such tasks.

To function as a computing unit, processing control unit 402 comprises the necessary means for connecting these various identified peripherals and other hardware components, even though they are preferably located without or are remotely located from encasement module 410. Therefore, the present invention processing control unit 402 comprises various connection means for providing the necessary link between each peripheral device and the processing components contained within processing control unit 402.

For example, one or more mass storage device interfaces may be used to connect one or more mass storage devices to the system bus of processing control unit 402. Mass storage devices and their corresponding computer readable media provide nonvolatile storage of data and/or executable instructions that may include one or more program modules, such as an operating system, one or more application programs, other program modules, or program data. Such mass storage devices are preferably peripheral to processing control unit 402, but allow it to retain large amounts of data.

As stated above, examples of a mass storage device include hard disk drives, magnetic disk drives, tape drives, solid-state memory drives, and optical disk drives. A mass storage device may read from and/or write to a solid-state memory unit, a magnetic hard disk, a removable magnetic disk, a magnetic cassette, an optical disk, or another computer readable medium.

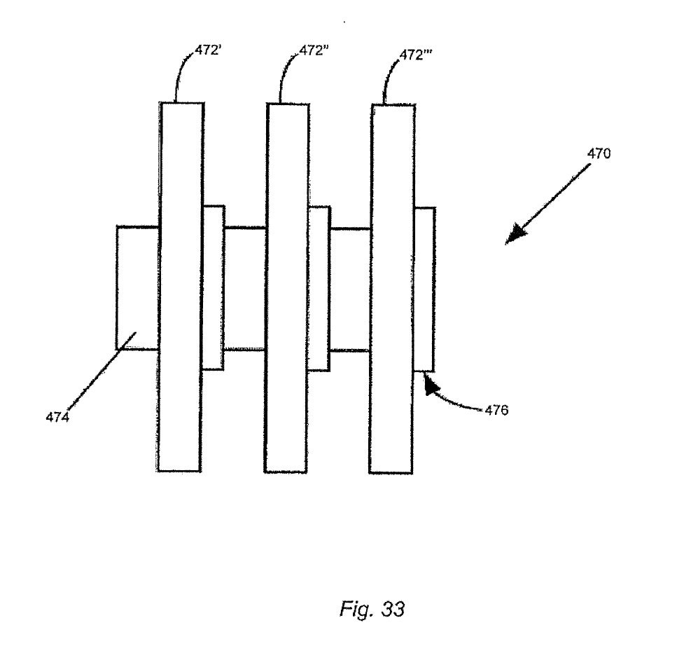

In one presently preferred example of a suitable mass storage device, FIG. 33 shows a mass storage device comprising an expandable memory device 470. Said differently, FIG. 33 shows a representative embodiment of peripheral memory device comprising one or more peripheral memory components 472′, 472″, and 472′″ (collectively and individually referred to as memory components 472) that comprise at least two electrical connectors. As shown in FIG. 33, the electrical connectors allow a first peripheral memory component 72′ to be physically and electrically attached to processing control unit 402 as well as to another peripheral memory component 472″. While each peripheral memory component 472 can comprise any suitable number or type of electrical connectors, FIG. 33 shows an embodiment in which each memory component 472 comprises a conventional male connector 474 (e.g., a male USB connector) disposed at a first surface and female connector 476 (e.g., a female USB port) disposed at a second surface that opposes the first surface. In still another embodiment (not shown), each memory component 472 comprises two male and two female electrical connectors. In such an embodiment, the plurality of male and female electrical connectors helps to speed the rate at which information is conveyed to and from the various memory components.

Where the processing control unit comprises an expandable memory, individual memory components 472 can have any suitable characteristic. In one example, individual memory components 472 comprise a solid-state memory drive; a small, magnetic hard disk drive; or another computer readable medium. In some preferred embodiments, however, each memory component comprises solid-state memory drive, such as a flash, SRAM-based, or DRAM-based memory drive.

In another example, individual memory components 472 can be stacked to any suitable height. For instance, peripheral memory components 472 can be stacked on each other so that 2, 3, 4, 5, or more memory components are stacked on and processed coupled to each other. In still another example, each memory component can comprise any suitable amount of memory (e.g., 32 gigabytes, 64 gigabytes, 100 gigabytes, etc.).

In yet another example, the memory of expandable memory 470 can be repartitioned manually or automatically. In some preferred embodiments, however, the memory of the expandable memory device is repartitioned automatically, or on the fly, each time that an individual memory component 472 is connected to or disconnected from another memory component 472 that is connected to processing control unit 402.

The expandable memory device can offer several beneficial characteristics. In one example, the amount of memory available to processing control unit 402 can easily be increased by connecting another individual memory component 472 to the expandable memory 470. In contrast, the amount of memory in expandable memory 470 can be easily decreased by unplugging or otherwise disconnecting one or more memory components 472 from expandable memory 470. In another example, because expandable memory 470 attaches outside processing control unit 402 (e.g., via dynamic backplane 434), expandable memory 470 does not act to significantly heat the interior of processing control unit 402. In still another example, FIG. 33 shows that electrical connectors 474 and 476 act to physically separate individual memory components 472. In this manner, air is able to flow between and cool individual memory components 472 through natural convection.

It should be noted that while expandable memory device 470 has been described above for peripheral use with processing control unit 402, the skilled artisan will recognize that expandable memory 470 may be used externally or internally with any suitable computer, computer system, or other electronic device.

Referring back to processing control unit 402, some embodiments of processing control unit 402 comprise one or more input interfaces to enable a user to enter data and/or instructions into processing control unit 402 through one or more corresponding input devices. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces that may be used to connect the input devices to the system bus include a serial port, a parallel port, a game port, a universal serial bus (“USB”), a firewire (IEEE 1394), an Ethernet connector (RJ-45), or any other suitable interface.

One or more output interfaces may also be employed to connect one or more corresponding output devices to the system bus. Examples of output devices include a monitor or visual display (e.g., a viewer), a speaker system, a printer, and the like. These particular output devices are also peripheral to (outside of) processing control unit 402. Examples of output interfaces include a video adapter (e.g., a DVI connector, a DVI-I connector, an HDMI connector, etc.), an audio adapter (e.g., a speaker adapter, a microphone adapter, etc.), a parallel port, and the like.

In another embodiment, any peripheral devices used are connected directly to the system bus without requiring an interface. This embodiment is fully described in U.S. Pat. No. 7,075,784, filed Oct. 22, 2003, and entitled, “Systems and Methods for Providing a Dynamically Modular Processing Unit,” which is incorporated by reference in its entirety herein.

Providing a non-peripherals computer system gives users many advantages over larger, peripheral packed computer units. Some of the advantages may be that the user is able to reduce the space required to accommodate the computer unit and system. Indeed, the present invention processing control unit may be set directly atop a desk, or may be hidden from view completely. The potential storage locations are endless. Processing control unit 402 may even be camouflaged within some type of desk-top piece, such as a clock, to hide it from view. Other features may include a relative reduction in noise and generated heat, or universal application to introduce intelligence or “smart” technology into various items, assemblies, or systems (external objects) so that the external objects are capable of performing one or more smart functions. These and other examples are apparent from the disclosure herein.

As described above, the present invention processing control unit 402 was designed to have certain mainstream components exterior to encasement module 410 for multiple reasons. First, because of its small size, yet powerful processing capabilities, processing control unit 402 may be implemented into various devices, systems, vehicles, or assemblies to enhance these as needed. Common peripheral devices, such as special displays, keyboards, etc., can be used in the traditional computer workstation, but processing control unit 402 can also be without peripherals and customized to be the control unit for many items, systems, etc. In other words, processing control unit 402 may be used to introduce “smart” technology into any type of conceivable item of manufacture (external object), such that the external object may perform one or more smart functions. A “smart function” may be defined herein as any type of computer executed function capable of being carried out by the external object as a result of the external object being operably connected and/or physically coupled to a computing system, namely processing control unit 402.

Second, regarding cooling issues, most of the heat generated within the interior of a conventional computer comes from two places—the computer processor and the hard drive. By removing the hard drive from the encasement module 410 and putting it exterior to processing control unit 402, better and more efficient cooling is achieved. By improving the cooling properties of the system, the lifespan or longevity of the CPU itself is increased, thus increasing the lifespan and longevity of the entire computer processing system.

Third, processing control unit 402 preferably comprises an isolated power supply. By isolating the power supply from other peripherals, more of the supplied voltage can be used just for processing, versus using the same voltage to power the CPU in addition to one or more peripheral components, such as a hard drive and/or a CD-ROM, existing within the system. In a workstation model, the peripheral components will exist without processing control unit 402 and will be preferably powered by a monitor power supply.

Fourth, in some presently preferred embodiments, no lights or other indicators are employed to signify that processing control unit 402 is on or off or if there is any disk activity. Activity and power lights still may be used, but they are preferably located on the monitor or another peripheral housing device. This type of design is preferred as it is intended that the system be used in many applications where lights would not be seen or where they would be useless, or in applications where they would be destructive, such as dark rooms and other photosensitive environments. Obviously however, exterior lighting, such as that found on conventional computer systems to show power on or disk use, etc., may be implemented or incorporated into the actual processing control unit 402, if so desired.

Fifth, passive cooling systems, such as a natural convection system, may be used to dissipate heat from the processing control unit rather than requiring some type of mechanical or forced air system, such as a blower or fan. Of course, such forced air systems are also contemplated for use in some particular embodiments. It should be noted that these advantages are not all inclusive. Other features and advantages will be recognized by one skilled in the art.

With reference to FIG. 34, shown is processing control unit 402, and particularly encasement module 410, in an assembled state having first end plate 438 and second end plate 442 (not shown), first and second end caps 446 and 450, inserts 466, 470 (not shown), and 874 (not shown), as well as dynamic backplane 434 attached thereto. Dynamic backplane 434 is designed to comprise the necessary ports and associated means for connecting that are used for coupling various input/output devices and power cords to processing control unit 402 to enable it to function, especially in a workstation environment. While all the available types of ports are not specifically shown and described herein, it is intended that any existing ports, along with any other types of ports that come into existence in the future, or even ports that are proprietary in nature, are to be compatible with and capable of being designed into and functional with processing control unit 402.

While dynamic backplane 434 may only comprise a single type of input/output port (e.g., a USB port) that requires a single type of logic to interface with processing control unit's 402 CPU, in preferred embodiments, dynamic backplane 434 comprises a plurality of input/output ports that require a plurality of different logics to interface with the CPU. Accordingly, it is contemplated that processing control unit 402 can comprise any suitable number of ports requiring any suitable type of logic. In one presently preferred embodiment, dynamic backplane 434 comprises as many as fourteen USB ports, six SATA ports, and two XGP ports. However, it is anticipated that any desired combination of ports may be provided for a desired application. As one example only, in one embodiment, the dynamic backplane 434 comprises exclusively USB ports, and may have as many USB ports as will fit within the real estate of the dynamic backplane 434.

As previously mentioned, in order to customize processing control unit 402 for particular applications, dynamic backplane 434 can be designed in a variety of manners and may be interchanged as needed. Some embodiments of interchangeable backplanes 434 are illustrated in FIGS. 34 through 38.

Specifically, FIG. 33 shows an embodiment in which dynamic backplane 434 comprises DVI video port 520, 10/100 Ethernet port 524, USB ports 528 and 532, SATA bus ports 536 and 540, power button 544, and power port 548.

Similarly, FIG. 34 shows a representative embodiment in which dynamic backplane 434 comprises HD audio input/output ports 500, 502, and 504; USB ports 528, 529, 530, 531, 532, and 533; eSATA ports 536 and 540; DVI-I port 521; XGP (ATI XGP) port 522; RJ-45 Ethernet port 523; ePCle port 525, power button 544, reset button 546, and power port 548.

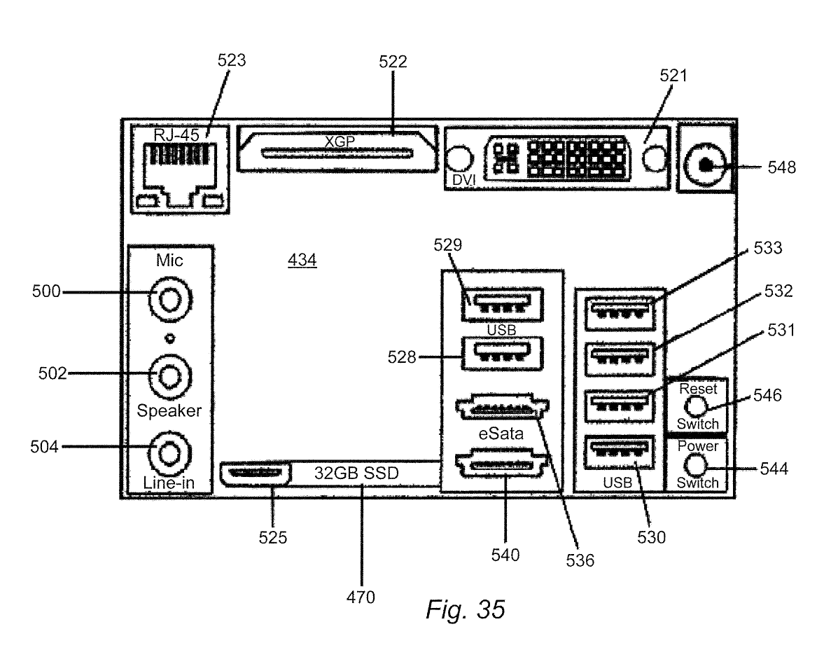

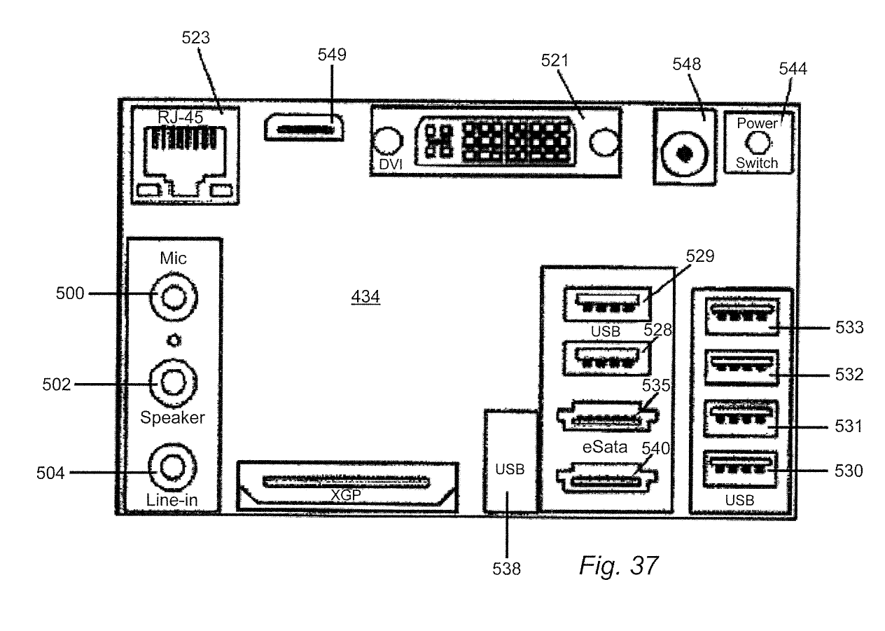

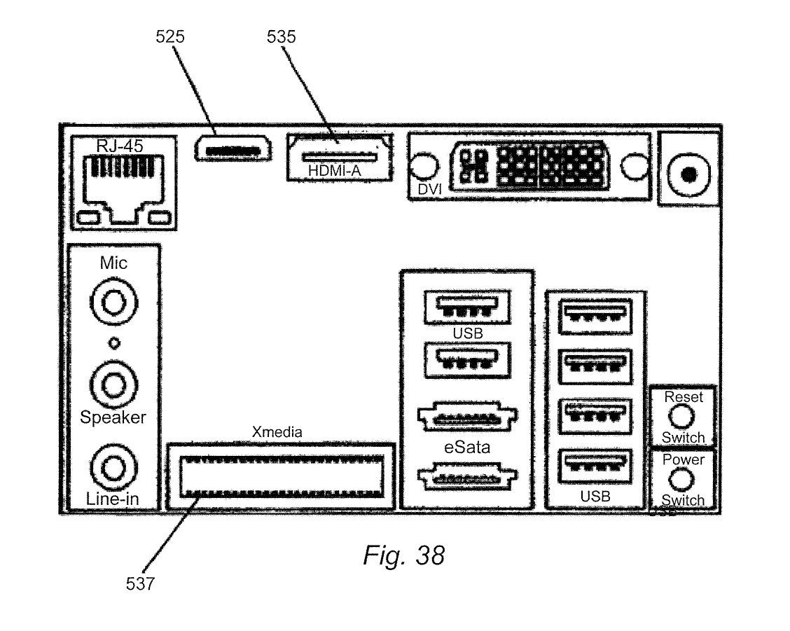

While the embodiments of dynamic backplane 434 that are illustrated in FIGS. 36 through 38 are similar to the embodiment illustrated in FIG. 35, the embodiments illustrated in FIGS. 36 through 38 differ from the embodiment illustrated in FIG. 35 in several ways. In one example, in place of ePCLe port 525, the embodiment shown in FIG. 36 comprises second XGP port 527. In a second example, the embodiment illustrated in FIG. 37 lacks reset button 546 and ePCLe port 525, but further comprises an additional USB port 538, and includes HDM-C port 149. In a final example, in the embodiment illustrated in FIG. 38, dynamic backplane 434 lacks XGP port 527 and further comprises HDMI-A port 535, as well as a proprietary universal port 537 that allows multiple processing units to be electrically coupled to increase processing capabilities of the entire system.

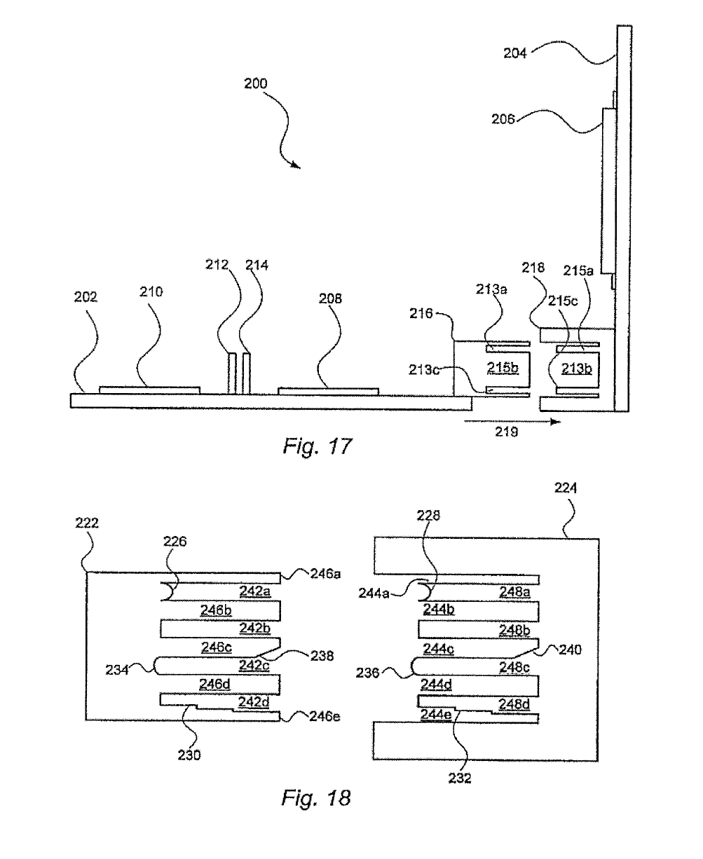

The various embodiments of dynamic backplane 434 (e.g., those shown in FIGS. 8A through 38) allow processing control unit 402 to customized for a variety of applications. In one example, FIG. 35 shows that in at least one embodiment, ePCLe port 525 allows expandable memory device 470 (e.g., a 32 GB SDD hard drive) to be electrically attached to dynamic backplane 434.

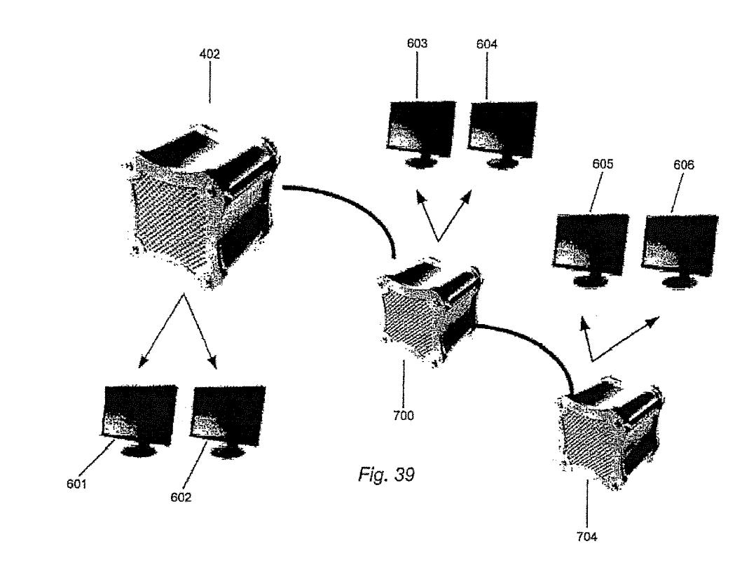

In another example, the various backplanes 434 shown in FIGS. 34 through 38 are configured to allow processing control unit 402 to control varying numbers of visual displays (e.g., monitors). For instance, FIG. 39 illustrates an embodiment in which processing control unit 402 comprises the dynamic backplane 434 shown in FIG. 36. Specifically, FIG. 39 shows that such a dynamic backplane allows processing control unit 2 to simultaneously control up to six monitors 601, 602, 603, 604, 605, and 606. Specifically, FIG. 39 illustrates that through its DVI-I port 521 (shown in FIG. 36), processing control unit 402 can control two visual displays 601 and 602. Moreover, FIG. 39 shows that through first 522 and second 527 XGP ports (shown in FIG. 36), processing control unit 402 can communicate with two other encasements, which each comprise a graphical control unit 700 and 704. In turn, through a DVI-out port, or any other suitable type of port, disposed on each graphical control unit 700 and 704, each graphical control unit 700 and 704 allows processing control unit 402 to control two visual displays (namely displays 603, 604, 605, and 606).

It should also be noted that the location of the various input/output ports in dynamic backplane 434 may be beneficial for several reasons. By way of example, the placement of the input/output ports in the embodiments of dynamic backplane 434 illustrated in FIGS. 34 through 38 represent some preferred embodiments in which the ports' placement provides optimal routing efficiencies on electrical printed circuit boards (described below) within unit 402. For instance, the placement of the various input and output ports on dynamic backplane 434 allows some of the ports to directly and electrically connect with one or more printed circuit boards within module 410.

While the various components of dynamic backplane 434 may perform any suitable function, in some embodiments, SATA bus ports 536 and 540 are designed to electronically couple and support storage medium peripheral components, such as CD-ROM drives, and hard drives. In another example, USB ports 528, 529, 530, 531, 532, 533, and 534 are designed to connect processing control unit 402 with peripheral components, like keyboards, mice, and any other peripheral components, such as 56k modems, tablets, digital cameras, network cards, monitors, and others.

Where dynamic backplane 434 comprises a power button, the power button (e.g., button 544) can have any suitable characteristic. For instance, in some embodiments, power button 544 has three states—system on, system off, and system standby for power boot. The first two states, system on and system off, dictate whether processing control unit 402 is powered on or powered off, respectively. The system standby state is an intermediary state. When power is turned on and received, the system is instructed to load and boot the operating system supported on processing control unit 402. When power is turned off, processing control unit 402 will then interrupt any ongoing processing and begin a quick shut down sequence followed by a standby state where the system sits inactive waiting for the power on state to be activated.

In this preferred embodiment, processing control unit 402 also comprises a unique system or assembly for powering up the system. The system is designed to become active when a power cord and corresponding clip is snapped into the appropriate port located on dynamic backplane 434. Once the power cord and corresponding clip are snapped into power port 548, the system will fire and begin to boot. The clip is important because once the power source is connected and even if the power cord is connected to the leads within power port 548, processing control unit 402 will not power on until the clip is snapped in place. Indicators may be provided, such as on the monitor, that warn or notify the user that the power cord is not fully snapped in or properly in place.

The highly dynamic, customizable, and interchangeable backplane 434 provides support to peripherals and vertical applications. In the embodiments illustrated in FIGS. 34 through 38, backplane 434 includes one or more features, interfaces, capabilities, logics, and/or components that allow processing control unit 402 to be dynamically customizable. Dynamic backplane 434 may also include any suitable mechanism (e.g., universal port 537) that electrically couples two or more modular processing units together to increase the processing capabilities of the entire system, and to provide scaled processing and symmetrical multiprocessing. As used herein the term symmetrical multiprocessing may refer to embodiments in which two or more processing control units comprising substantially identical CPUs are connected to a shared memory device.

Those skilled in the art will appreciate that the illustrated embodiments of backplane 434, with its corresponding features, interfaces, capabilities, logic, and/or components, are representative only and that other embodiments of the present invention embrace backplanes having a variety of different features, interfaces, capabilities, and/or components. Accordingly, processing control unit 402 is dynamically customizable by allowing one backplane to be replaced by another backplane in order to allow a user to selectively modify the logic, features, and/or capabilities of processing control unit 402.

Moreover, embodiments of the present invention embrace any number and/or type of logic and/or connectors to allow use of one or more modular processing control units in a variety of different environments. For example, some environments may include vehicles (e.g., cars, trucks, motorcycles, etc.), hydraulic control systems, structural, and other environments. The changing of data manipulating system(s) on the dynamic backplane allows for scaling vertically and/or horizontally for a variety of environments.

It should be noted that in an exemplary embodiment, the design and geometric shape of encasement module 410 provides a natural indentation for the interface of these ports. This indentation is shown in FIG. 34. Thus, inadvertent dropping or any other impacts to processing control unit 402, and encasement module 410, will not damage the system as these ports are protected via the indentation formed within dynamic backplane 434. First and second end caps 446 and 450 also help to protect the system from damage.

The present invention also contemplates snap-on peripherals that snap onto dynamic backplane 434 and couple to the system bus of processing control unit 402 through a snap on connection system. Indeed, in at least some embodiments, expandable memory 470 attaches to processing control unit 402 as a snap-on peripheral.

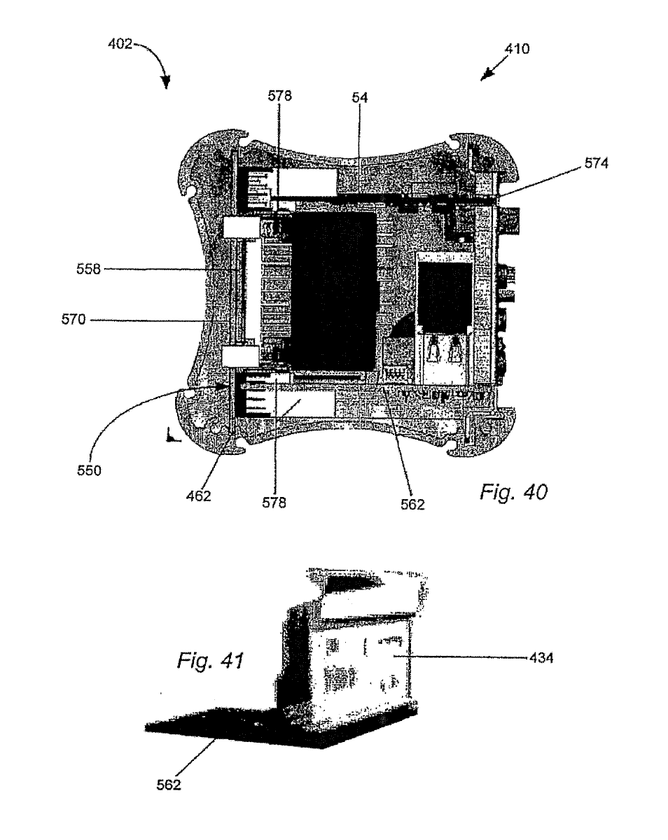

With reference to FIG. 40, the present invention processing control unit 402 comprises a proprietary computer processing system 550, with encasement module 410 comprising a unique design and structural configuration for housing processing system 550 and the electrical printed circuit boards designed to operate and be functional within processing control unit 402.

Essentially, processing system 550 includes one or more electrical printed circuit boards. Indeed, processing system 550 may comprise one, two, three, four, five, or more printed circuit boards. However, unlike many conventional computers that comprise a single printed circuit board (e.g., a motherboard) that is necessary for the functioning of the computer, in some preferred embodiments, processing control unit 402 comprises at least two discrete printed circuit boards that need to be electrically connected for processing control unit 402 to turn on or to otherwise function. In addition to these boards, processing control unit, like many conventional computers, may comprise one or more optional boards (e.g., daughter boards).

By comprising a plurality of necessary printed circuit boards, as opposed to a single motherboard, processing system 550 may provide several significant advantages over certain prior art board configurations. As one advantage, processing system 550 can be configured as two, three, four, or more multi-layer main boards instead of one main board as is found in some conventional computer systems. In addition, less real estate is taken up as the boards are able to be configured within different planes. Moreover, while the entire motherboard of a conventional computer may need to be replaced in order to upgrade the computer, where processing control system 550 comprises a plurality of necessary boards, one board may be replaced (e.g., with an updated board) while the other necessary boards of the system are not. Accordingly, processing control unit 402 may be upgraded at a lower cost than certain conventional computers, and may be upgraded in ways not possible with certain conventional computers.

While, in some embodiments, processing control unit 402 comprises two printed circuit boards that are necessary for the functioning of the unit, FIG. 40 illustrates an embodiment in which processing system 550 comprises three necessary printed circuit boards, namely a first 554, a second 558, and a third 562 electrical printed circuit board.

In embodiments in which processing system 550 requires three boards for functioning, the various boards may perform any suitable function. In one example, one of the boards (e.g., first board 554) functions as or includes a northbridge to handle communication between the CPU, RAM, AGP, and other electrical components of processing system 550. In other example, one of the boards (e.g., first board 554) functions as a power supply board and further comprises logic for one or more input/output ports (e.g., one or more DVI connectors, Ethernet connectors, ePCle connectors, etc.).

In another example, one or more of the boards (e.g., second board 558) comprises at least one central processor and optionally one or more other processors designed to perform one or more particular functions or tasks. As a result, processing system 550 functions to execute the operations of processing control unit 402, and specifically, to execute any instructions provided on a computer readable media, such as on a memory device, a magnetic hard disk, a removable magnetic disk, a magnetic cassette, an expandable memory device, a disk (e.g. CD-ROM's, DVD's, floppy disks, etc.), or from a remote communications connection, which may also be viewed as a computer readable medium. Although these computer readable media are preferably located exterior to or without processing control unit 402, processing system 450 functions to control and execute instructions on such devices as commonly known, the only difference being that such execution is done remotely via one or more means for electrically connecting such peripheral components or input/output devices to processing control unit 2.

In still another example of suitable functions of the circuit boards in processing system 550, one or more of the boards (e.g., third board 562) functions as or includes a southbridge or an input/output controller hub. In this example, the discrete southbridge circuit board (e.g., third board 562) comprises logic for some or all of the input/output ports on dynamic backplane 434. For instance, the southbridge can comprise logic for one or more XGP connectors, eSATA connectors, USB connectors, audio connectors, etc.

The division of the functions onto multiple boards (e.g. first board 554, second board 558 and third board 562, for example), allows system upgrades and modifications in manners not previously available in the art. In a conventional motherboard, the motherboard typically contains a CPU socket (and CPU), a northbridge or equivalent functionality, and a southbridge or equivalent functionality, all on the same board. This configuration has led to difficulties in ensuring continued operability with upgrading components and has limited manufacturers in their efforts to provide system upgrades. This difficulty can be traced in part to the cost of developing new board and chip layouts and configurations to adequately handle new upgrades.

For example, in the past, if a new northbridge was under development by a manufacturer, the manufacturer would commonly be unwilling to invest the cost in ensuring that the new northbridge would prove compatible with older CPUs and older southbridges. Proving out compatibility for each new upgrade of one of a northbridge, a southbridge, and a CPU for each possible combination of those components has been prohibitively expensive, and has led to the common practice whereby development of new components is synchronized (e.g. development of certain components delayed) so that upgrades of all three components occurs together. This practice leads to development delays.

The division of functions onto multiple boards in embodiments of the invention allows ready upgrades of each component separately, and allows for easy testing of cross compatibility with old systems and components, simply by replacing only one of the three boards, the one having the desired component for testing. Consider, for example, an embodiment where the first circuit board 554 contains the southbridge and the second circuit board 558 contains the northbridge and a socket for the CPU. The third circuit board 562 contains input/output functionality for the system. The first and third boards (554, 562) are connected to the second circuit board 558 by riser connectors similar to those known in the art, but the riser connectors transfer more functionality between boards than standard daughter-board connectors as is known in the art.

For example, all capability of the northbridge may be brought through the riser connector between the first circuit board 554 and the second circuit board 558, whereby the capability of the northbridge is available to components on the first circuit board 558. Similarly, capability of the southbridge is brought down through the riser connector between the first circuit board 554 and the second circuit board 558, across the second circuit board 558 to the riser connector between the second circuit board 558 and the third circuit board 562, and up to the third circuit board 562, where it is available to components on the third circuit board 562. In this way, when compatibility testing between a new component such as a northbridge, southbridge, or CPU and old components is desired, the manufacturer only needs make one new board or component containing the item to be tested, which can then be readily and inexpensively tested with any number of old components on other boards by way of a few board exchanges.

Therefore, one unique feature of embodiments of the invention is the presence of riser connectors and circuit board edges having multiple unrelated input/output connections on them. In the given example, each board may have input/output connections for PCI, USB, AGP, and more. Of course, the exact distribution of components across the various boards may vary and still fall within the principles discussed herein, and the discussed divisions are merely intended to be illustrative and not limiting.

Where processing system 550 comprises a plurality of printed circuit boards, the printed circuit boards (e.g., 554, 558, and 562) can have any suitable configuration within encasement module 410. In one example, processing system 550 comprises a layered configuration in which the printed circuit boards are substantially parallel to each other in a multi-planar configuration. In another example, however, FIG. 40 shows an embodiment in which first, second, and third circuit boards 554, 558, and 562 are disposed in a tri-board configuration. Specifically, FIG. 40 shows that first circuit board 554 and third circuit board 562 run substantially perpendicular to second circuit board 558.

The various circuit boards of processing system 550 can be supported within main support chassis 414 by any suitable means for engaging or coupling or supporting electrical printed circuit boards. Referring to FIG. 40, that figure shows a representative embodiment in which means for engaging electrical printed circuit boards comprises a series of board receiving channels 462 that are located within the junction centers 454 disposed on each side of second wall support 422

In some embodiments, a printed circuit board (e.g., second board 558) from processing system is directly received within board receiving channels 462 that flank second wall support 422. Nevertheless, FIG. 40 shows that in presently preferred embodiments, a supporting card 570 is received within board receiving channels 462 on either side of second wall support 422, while a circuit board (e.g., second board 558) is attached to supporting card 570.

In another example of means for engaging electrical printed circuit boards, in some embodiments, dynamic backplane 434 is configured to support one or more printed circuit boards. Indeed, in some embodiments, dynamic backplane is integrally connected to one or more printed circuit boards (e.g., first board 554 and/or third board 562) to form a single unit. By way of example, FIG. 40 shows an embodiment in which dynamic backplane is integrally connected to third printed circuit board 562. Accordingly, where logic for the input/output ports on dynamic backplane 434 is disposed on dynamic backplane 434 and/or on third printed circuit board 562, without changing first board 554 or second board 558, dynamic backplane 434 and third board 562 can be interchanged with different dynamic backplane 434 and third board 562 having a different input/output permutation and logic requirements. Conversely, in this example, first board 554 and second board 558 can be interchanged with different boards while the original third board 562 and dynamic backplane 434 remain unchanged. Thus, processing control unit can be upgraded without replacing the entire processing system 550.

Referring back to FIG. 40, that figure shows another example of suitable means for engaging electrical printed circuit board. Specifically, FIG. 40 shows an embodiment in which dynamic backplane 434 comprises a circuit board attachment point 574. While circuit board attachment 574 may comprise any characteristic that allows it to support a circuit board, FIG. 40 illustrates an embodiment, in which board attachment 574 comprises a notch that receives an end portion of a printed circuit board (e.g., first board 554).

The printed circuit boards in processing system 550 can be electrically connected to each other in any suitable manner, including through the use of board-to-board physical connectors and/or ribbon connectors. However, because board-to-board physical connectors may require less space, offer a stronger connection, and allow for more efficient routing on the printed circuit boards, such connectors are preferred in some embodiments. By way of illustration, FIG. 40 shows an embodiment in which first board 554 and third board 562 are physically and electrically attached to second board 558 through board-to-board physical connectors 578.

Where the printed circuit boards in processing system 550 are connected to each other through one or more board-to-board physical connectors, the physical connectors can have any suitable characteristic. By way of example, the physical connectors are configured to mate with a printed circuit board (e.g., first board 554 or third board 562) using contact pads/finger (edge board contacts) along an edge that mate with pins within the confines of the connector (referred to a card edge connector). In another embodiment, the physical connection comprises two unique connectors, wherein one is a male and one is a female that are configured to mate together. In yet another embodiment, the physical connection comprises one or more connectors, wherein each connector is hermaphroditic so that each connector connects to itself.

By coupling each of the first, second, and third electrical printed circuit boards 554, 558, and 562 together in the manner illustrated in FIG. 40, the chance for detachment of each of these boards from their proper place within primary chassis 414 and encasement module 410 is significantly decreased. In virtually any circumstance and condition processing control unit 402 is exposed to, first, second, and third printed circuit boards 554, 558, and 562 will remain intact and in working order, thus maintaining or preserving the integrity of the system. This is true even in impact and applied loading situations.

In some embodiments, the printed circuit boards of processing system 550 are not supported by and preferably do not rest upon any of the wall supports of primary chassis 414. Indeed, in some embodiments, primary chassis 414 is designed to provide a gap or space between each of the electrical printed circuit boards and the opposing wall supports to allow for the proper airflow within processing control unit 402 according to the unique natural convection cooling properties provided herein. As such, each radius of curvature calculated for each wall support is designed with this limitation in mind.

While the processing system may be assembled in any suitable manner, first and second electrical printed circuit boards 554 and 558 are preferably attached to each other during manufacture and prior to being placed within encasement module 410. Once first 554 and second 558 boards are assembled, inserted into, and secured to main support chassis 414, dynamic backplane 434 and third board 562 are inserted, as shown in FIG. 40.

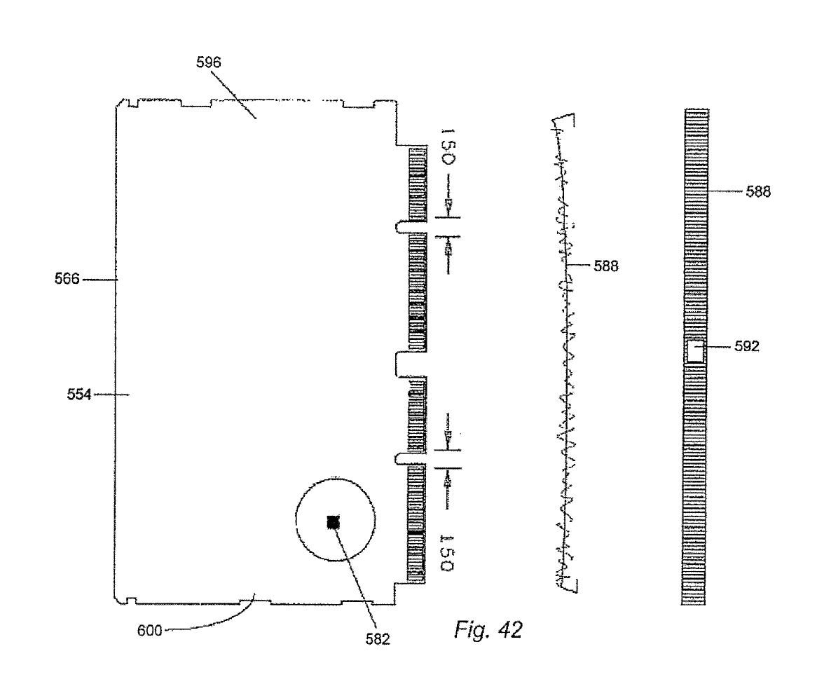

In addition to the aforementioned components, processing system 550 may comprise any component or characteristic that is suitable for use with processing control unit 402. In one example, one or more of the electrical circuit boards in processing system 550 comprises a security chip (e.g., an application-specific integrated circuit). For instance, FIG. 42 shows a representative embodiment in which first electrical circuit board 554 comprises security chip 582.

Security chip 582 can function in a variety of manners. In one example, security chip 582 prevents software that has not been approved for use on a particular process control unit 402 from being used in that unit. In this example, a software program that has been licensed or otherwise approved for a specific processing unit 402 can only be used on a processing unit having a security chip with the proper unique identifier. Accordingly, certain software is prevented from being used on unauthorized processing control units.

In another example, security chip 582 prevents unauthorized hardware from being used with processing control unit 402. While security chip can accomplish this feature in any suitable manner, in some embodiments, security chip 582 is configured to communicate with at least one other security chip associated with processing control unit to ensure that the other chip has an authorized unique identifier. For instance, where first 554, second 558, and third 562 electrical circuit boards each comprise their own security chip 582, the security chips communicate between each other, check each other's unique identifiers, and determine whether each of the electrical circuit boards is authorized to be used together. In such instances, one or more of the security chips can determine if any of the electrical circuit boards does not belong in processing control unit 402. Accordingly, security chip 582 can determine if a circuit board or another piece of hardware comprising security chip 582 has been interchanged with another circuit board or other hardware from another processing control unit. Similarly, security chip 582 can prevent hardware (e.g., a circuit board) produced from an unauthorized fabrication (e.g., an illegal copy) from being used with processing control unit 402.

In still another example, the security chip acts to prevent both unauthorized software and hardware from being used on a particular processing control unit.

In another example of a suitable component associated with processing system 550, one or more of the electrical circuit boards in processing system may comprise any heat sink that is suitable for use with processing control unit 2 and capable of absorbing heat from and dissipating heat away from one or more components on the electrical circuit boards. FIG. 42 shows a representative embodiment of a suitable heat sink comprising a rail 588. While heat sink rail 188 can have any suitable characteristic, FIG. 42 shows an embodiment in which rail 588 is bowed so as to be able to contact one or more hot surfaces on an electrical circuit board (e.g., first board 554). Additionally, FIG. 42 shows that rail 588 comprises one or more holes 592 to allow tall structures (e.g., a portion of security chip 582) on the electrical circuit board to pass therethrough. Further, while rail 588 can comprise any projection (e.g., fin, protrusion, etc.) that allows it to dissipate heat more quickly, FIG. 42 shows an embodiment in which rail 588 is corrugated so as to have a zig-zagged surface.

Heat sink 588 can be secured to an electrical circuit board in any suitable manner, including through the use of soldering, an adhesive, a mechanical fastener (e.g., a rivet, screw, etc.), or the like. In some presently preferred embodiments, however, heat sink rail 588 snaps or clips onto an electrical circuit board. While a heat sink can be clipped or snapped onto the an electrical circuit board in any suitable manner, FIG. 42 shows an embodiment in which rail 588 is configured to extend across a first surface 596 of first circuit board 554 and snap into a notch 600 disposed on two opposing edges of first board 554. Such an embodiment may be beneficial for several reasons, including that rail can be connected to circuit board 554 without drilling, riveting, etc.

In addition to the previously mentioned features, processing control unit 402 can comprise any other suitable feature. By way of example, in some embodiments, processing control unit is configured to require a proper password to be entered every time, and only when, the unit is connected to a power source, (e.g., a municipal power grid). In such embodiments, processing control unit 402 locks out certain data and applications in the unit until the proper password is entered into the unit. Accordingly, if processor control unit is stolen, the unit will not function and its data will be safely protected.

In addition to the many advantages discussed above, the present invention features other significant advantages, one of which is that due to encasement module 410 comprising a full metal chassis or a main support chassis 414, there is very little or no radiation emission in the form of electromagnetic interference (EMI). This is in large part due to the material properties, the small size, the thickness of the structure, and the close proximity of the processing components in relation to the structural components of encasement module 410. Whatever EMI is produced by the processing components is absorbed by encasement module 410, no matter the processing power of the processing components.

Another significant advantage is that encasement module 410 enables a much cleaner, more sterile interior than prior art computer encasement designs. Because of the design of encasement module 410, particularly the small size, ventilation ports, and the heat dissipating properties, it is very difficult for dust particles and other types of foreign objects to enter the encasement. This is especially true in a liquid cooled model, wherein the entire encasement may be sealed. A more sterile interior is important in that various types of foreign objects or debris can damage the components of and/or reduce the performance of processing control unit 402.

Although processing control unit 402 relies on natural convection in one exemplary embodiment, the natural influx and efflux of air during the natural convection process significantly reduces the influx of dust particles or other debris into processing control unit 402 because there is no forced influx of air. In the natural convection cooling system described herein, air particles enter the interior of encasement module 410 according to natural principles of physics, and are less apt to carry with them heavier foreign object as there is less force to do so. This is advantageous in environments that contain such heavier foreign objects as most environments do.

The unique cooling methodology of processing control unit 402 will allow it to be more adaptable to those environments prior related encasements were unable to be placed within.

Still another significant advantage of the present invention processing control unit 402 is its durability. Because of its compact design and radius-based structure, encasement module 410 is capable of withstanding large amounts of impact and applied forces, a feature which also contributes to the ability for processing control unit 402 to be adaptable to any type of conceivable environment. Encasement module 410 can withstand small and large impact forces with little effect to its structural integrity or electrical circuitry, an advantage that is important as the small size and portability of processing control unit 402 lends itself to many conceivable environments, some of which may be quite harsh.

In addition to the structural components of encasement module 410 being very durable, the electrical printed circuit design board and associated circuitry is also extremely durable. In some embodiments, once inserted, one or more of the printed circuit boards are very difficult to remove, especially as a result of inadvertent forces, such as dropping or impacting the encasement. Moreover, the boards are extremely light weight, thus not possessing enough mass to break during a fall. Obviously though, encasement 410 is not entirely indestructible. In most circumstances, encasement module 410 will be more durable than the board configurations; therefore the overall durability of processing control unit 402 is limited by the board configuration and the circuitry therein.

In short, encasement module 410 comprises a high level of durability not found in prior related encasement designs. Indeed, these would break, and often do, at very slight impact or applied forces. Such is not so with processing control unit 402 described herein.

The durability of encasement module 410 is derived from two primary features. First, encasement module 410 is preferably built with radiuses. Each structural component, and their designs, is comprised of one or more radiuses. This significantly adds to the strength of encasement module 410 as a radius-based structure provides one of the strongest designs available. Second, the preferred overall shape of encasement module 410 is cubical, thus providing significant rigidness. The radius-based structural components combined with the rigidness of the cubical design, provide a very durable, yet functional, encasement.

The durability of the individual processing units/cubes allows processing to take place in locations that were otherwise unthinkable with traditional techniques. For example, the processing units can be buried in the earth, located in water, buried in the sea, placed on the heads of drill bits that drive hundreds of feet into the earth, mounted on unstable surfaces, mounted to existing structures, placed in furniture, etc. The potential processing locations are endless.

The processing control unit of the present invention further features the ability to be mounted to, or to have mounted onto it, any structure, device, or assembly using means for mounting and means for engaging an external object (each preferably comprising slide receiver 482, as existing on each wall support of main support chassis 414). Any external object having the ability to engage processing control unit 402 in any manner so that the two are operably connected is contemplated for protection herein. In addition, one skilled in the art will recognize that encasement module 410 may comprise other designs or structures as means for engaging an external object other than slide receivers 482.

Essentially, the significance of providing mountability to processing control unit, no matter how this is achieved, is to be able to integrate processing control unit 402 into any type of environment as discussed herein, or to allow various items or objects (external objects) to be coupled or mounted to processing control unit 402. The unit is designed to be mounted to various inanimate items, such as multi-plex processing centers or transportation vehicles, as well as to receive various peripherals mounted directly to processing control unit 402, such as a monitor or LCD screen.

The mountability feature is designed to be a built-in feature, meaning that processing control unit 402 comprises means for engaging an external object built directly into its structural components. Both mounting using independent mounting brackets (e.g. those functioning as adaptors to complete a host-processing control unit connection), as well as mounting directly to a host (e.g. mounting the unit in a car in place of the car stereo) are also contemplated for protection herein.

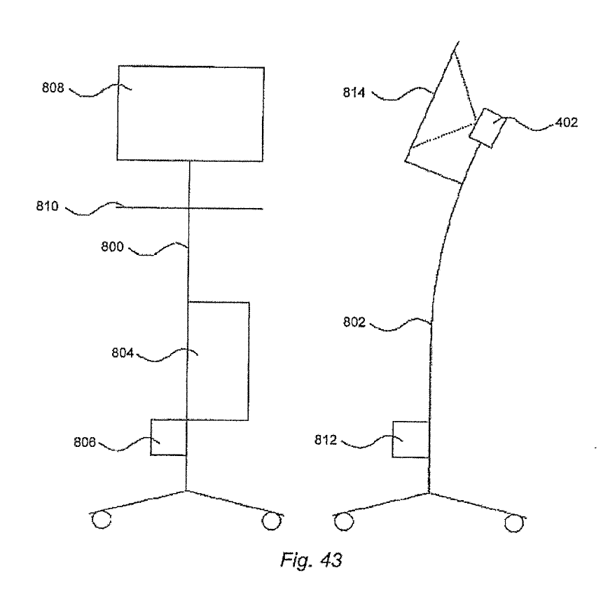

Advantages that may be obtained in conjunction with the mounting feature may be illustrated with respect to FIG. 43, which schematically shows a comparison between an existing computer on wheels (existing COW 800) and a new COW 802 using features described herein. The existing COW 800 includes a bulky standard processing unit 804 that is powered by a battery 806. The existing COW 800 also includes a standard monitor 808 and an input platform 810 that usually includes a keyboard and mouse or the like. While these devices are functional and have revolutionized record keeping in environments like hospitals, they are limited by their bulk and power use. For example, it is not uncommon for the standard processing unit 804 and the monitor 808 to each consume approximately sixty watts of energy, quickly depleting the batter 806.

In contrast, the new COW 802 provides many advantages over the existing COW 800. First, the processing control unit 402 of the illustrated embodiment may use, for example only twenty-two watts of energy. Thus, a battery 812 of the new COW 802 may be reduced in size or if kept an equivalent size to the battery 806 of the existing COW 800, may permit operation of the new COW 802 for significantly longer periods of time between charges. The dynamic backplane 434 of the processing control unit 402 of this embodiment may be provided with a pico projector of any type now known or later invented, that projects onto a touch-sensitive glass screen 814. This projection feature onto the touch-sensitive screen 814 provides combined input and output with very minimal power use. Alternatively, the pico projector may project onto a standard screen, and input may be provided using a standard keyboard and mouse. Regardless, the new COW 802 is easier to move around, functions longer on a single charge because of its lower wattage, and is cheaper to ship and support.

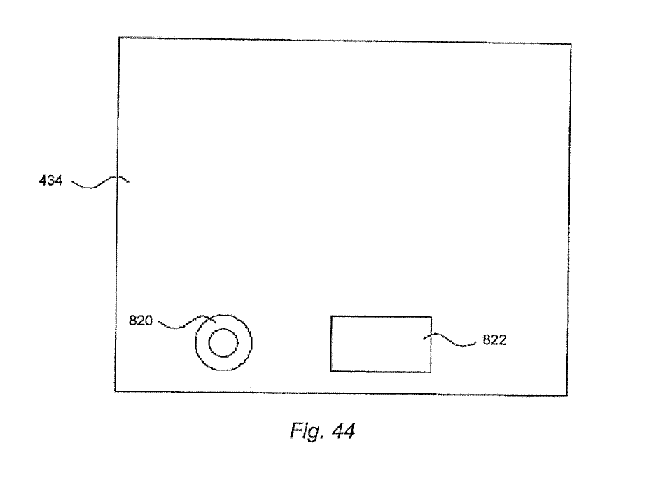

Certain embodiments of the invention may utilize similar pico-projection technology to allow the processing control unit 802 to be utilized for identification and 3-D gaming purposes. FIG. 44 schematically illustrates components that may be incorporated into the dynamic backplane 434 to provide such features. In FIG. 44, other ports and features of the dynamic backplane 434 have been omitted for clarity, but it should be understood that any ports and/or features discussed herein may be present in conjunction with the features discussed with respect to FIG. 44.

The dynamic backplane 434 of FIG. 44 includes a camera 820 and a pico projector 822. The pico projector in this embodiment projects a laser grid onto a user's face or any other object. The camera 820 captures image information, including the projected grid. The processing control unit 402 uses the image information and the grid information to obtain three-dimensional information from the camera image. This information may be used for identification purposes, 3-dimensional gaming purposes (e.g. to detect movement for a game), and for any other purposes where 3-dimensional information is desirable.

While embodiments of the invention have been discussed herein with respect to processing control units 402 having a variety of processors, including CPUs, it should be emphasized that processing control units 402 may include any variety of processors, including graphical processing units (GPUs). GPUs are commonly used to process polygons and are well-suited to perform certain types of tasks that are not always handled as well by standard CPUs. If a processing control unit contains a GPU, it may be deemed a graphical control unit, or GCU. Uses of such units was discussed briefly above with respect to FIGS. 8C and 9, where one processing control unit 402 communicates using XGP ports with two GCUs (700 and 704) to provide control over six monitors (601-606). As will be appreciated, in such configurations, the monitors may be tiled to provide very large display units.

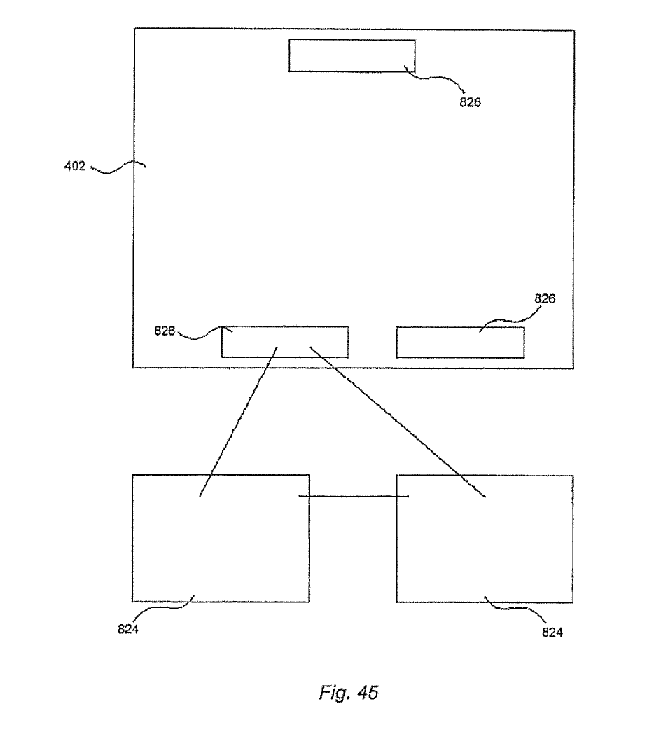

FIG. 45 shows a schematic illustration of a system configuration between a processing control unit 402 and two GPUs 824. The processing control unit 402 may have a standard CPU and may have multiple AGP ports or connectors 826, each of which may have, for example, eight lanes of PCI-E communications available. The two GPUs 824 (each containing a GPU) may be connected to one AGP port 826 of the processing control unit 402 in series, as shown, or in parallel (with each using four lanes, not shown) to effectively provide super-computing type processing capabilities to the extended processing control unit system. This kind of processing may be used in environments where super-computing capabilities have previously been unavailable, including personal supercomputing and educational supercomputing. Thus, a capability of the processing control unit is its ability to be expanded with other units to provide computing abilities not previously available.

Another capability of processing control unit 402 is its ability to be mounted and implemented within a super structure, such as a Tempest super structure, if additional hardening of the encasement module is effectuated. In such a configuration, processing control unit 402 is mounted within the structure as described herein, and functions to process control the components or peripheral components of the structure. Processing control unit 402 also functions as a load bearing member of the physical structure if necessary. All different types of super structures are contemplated herein, and can be made of any type of material, such as plastic, wood, metal alloy, and/or composites of such.

Other advantages include a reduction in noise and heat. Additionally, advantages include an ability to introduce customizable “smart” technology into various devices, such as furniture, fixtures, vehicles, structures, supports, appliances, equipment, personal items, etc. (external object). For a more detailed description of using processing control unit 402 to introduce smart technology into devices, see U.S. patent application Ser. No. 11/827,360, filed Jul. 9, 2007 and entitled SYSTEMS AND METHODS FOR PROVIDING A ROBUST COMPUTER PROCESSING UNIT; the entire disclosure of which is hereby incorporated by reference.

Accordingly, in one aspect, a customizable computer comprises: a first electrical printed circuit board; a second electrical printed circuit board having a central processing unit; and a dynamic backplane having a plurality of ports for electrically connecting a peripheral device to the computer, wherein the plurality of ports require a plurality of different logics to interface with the central processing unit, and wherein the computer will not turn on unless the first printed circuit board is electrically connected to the second printed circuit board.

In another aspect, a customizable computer comprises: a dynamic backplane comprising a plurality of ports for electrically connecting a peripheral device to the computer, a first printed circuit board; a second printed circuit board comprising a central processing unit, wherein the plurality of ports requires a plurality of different logics to interface with the central processing unit, wherein the plurality of different logics required by the plurality of ports is disposed on a component selected from the first printed circuit board, the dynamic backplane, and combinations thereof, and wherein the computer will not turn on unless the first printed circuit board is electrically connected to the second printed circuit board.

In another aspect, a computer comprises: a security chip having a unique identifier, wherein the security chip prevents a component selected from unauthorized software, unauthorized hardware, and a combination thereof from fully functioning with the computer. Some implementations of the computer may further comprise: a first electrical printed circuit board, and a second electrical printed circuit board, wherein the computer will only function where both the first circuit board and the second circuit board each comprises the security chip.

In another aspect, a computer comprising: a central processing unit; and a means for requiring a password only after the computer is disconnected from and reconnected to a power source.

In another aspect, an expandable memory device, comprises: a first peripheral memory component capable of storing digital information, the first peripheral memory component comprising: a first electrical connector to physically and electrically connect the first peripheral memory component to a computer system; and a second electrical connector to physically and electrically connect the first peripheral memory component to a second peripheral memory component, wherein the expandable memory device automatically reparations its memory when the second peripheral memory component is electrically connected to or disconnected from the first peripheral memory component.

### Customizable Chassis Design

In some embodiments, the encasement module 410, such as that shown in FIGS. 27 and 28 are customizable according to the various desires and preferences of a user. For instances, a user may be provided with options of modifying the color, shape, or other ornamental aspects of the encasement module 410. For example, in some instances, the end cap 438, 442, such as that shown in FIG. 31, can have various possible hole 498 shapes and configurations. These holes can include round, square, honeycomb, or other shaped holes. These holes can also have various patterns, orientations, or designs.

In some instances, the user is provided with the options of changing the exterior color of the encasement module 410 or a portion of the encasement module 410. Additionally or alternatively, a user may be provided with the option of addition a design, logo, image, text, or other such feature to the encasement module 410 or other part of the process control unit 402.

In some instance, the encasement module 410 is provided with an engraving, which can be a design, image, text, or other such engraving. In one non-limiting instance, a user is provided with the option of submitting an image, text, or other design that will be engraven, etched (e.g. laser etched) onto the encasement module 410. Likewise, other such ornamental design options for modifying the external features of the encasement module are anticipated by the present invention.

In some embodiments, the encasement module 410 is labeled, etched, engraved, or otherwise marked with a barcode, unit identification number, or a like identification (ID) marking. Such marking can be used in an inventory management system of a user organization. For example, an organization, such as a business, can have numerous computer device, such as the process control units 402, personal computers, printers, and the like. To manage at least the process control units 402, the organization can have a reader, management software, and a plurality of process control units 402 having ID markings thereon. These ID markings can be etched, such as laser etched, onto the process control units 402, each ID marking being unique to each process control unit 402. As process control units 402 are exchanged, moved, upgraded, purchased, etc., the organization can scan the ID marking and identify what is happening with each process control unit 402 using the management system. Furthermore, since each process control system is modular, an ID marking can be disposed on each of the modular components of the process control unit 402, including the encasement module 410, the back plate 434, each of the motherboard components 62a, 62b, 64. As these components are exchanged, interchanged, discarded, or purchased, the organization can scan these parts in and register the change, the location, or other such information. Thus, this ID marking system provides an organization with the ability to track and manage a plurality of process control unites 402.

### Load Balancing Modular Cooling System

Metallic heat sinks are available to dissipate the heat produced by electronic power components, such as transistors, as effectively as possible and thus avoid an overheating of the appertaining component. Such heat sinks have a heat sink contact surface in contact with the appertaining component via a thermally conductive connection. The heat sink, due to its good thermal conductivity, its mass and its surface area, absorbs the heat of the component and emits the heat to the environment.

A large variety of heat sinks are available, these being respectively adapted to the nature and shape of the electronic components to be cooled, as well as to the purpose, particularly the heat quantity to be eliminated, the available space and the mounting possibilities. When assembling a more complex circuit having many different power components, a corresponding number of different types of heat sinks having different dimensions and shapes therefore must be available. Each heat-producing electronic component is fitted with a heat sink thereby assisting dissipation of heat generated by the electronic component. Where space is limited, the dimensions, shape and/or size of the heat sink is adjusted to accommodate the space in which the component located. Such accommodations may result in limiting heat dissipation or efficiency of the heat sink. Further, the size requirements of the heat sink may only be required during peak operation of the electronic component, thereby resulting in periods of time where the space occupied by the heat sink is not actively removing heat from the electronic system.

Thus, while techniques currently exist that are used to remove heat energy from electronic systems, challenges still exist. Accordingly, it would be an improvement in the art to augment or even replace current techniques with other techniques. Accordingly, one aspect of the present invention relates to systems and methods for dissipating heat from multiple heat producing components of a computer device. In particular, the present invention relates to a heat sink device having a customized receiving surface for interfacing with multiple heat producing components, and a modular surface for receiving a heat diffusing layer for dissipating heat from the multiple components. The present invention further relates to system and methods for optimizing airflow through a computer device.

In some implementations, a unitary heat sink device is provide having a first surface for receiving a plurality of heat-producing components, and a second surface having a diffusing duct surface. In other implementations, a modular heat sink device is provided having a receiver and a diffusing duct plate. The receiver has a first surface for receiving a plurality of heat-producing components, and a second surface for receiving the diffusing duct plate. The diffusing duct plate has a first surface for forming an interface with the second surface of the receiver, and a second surface having heat diffusing features. Thus, the receiver provides a universal surface onto which any desired diffusing duct plate may be interchangeably coupled.

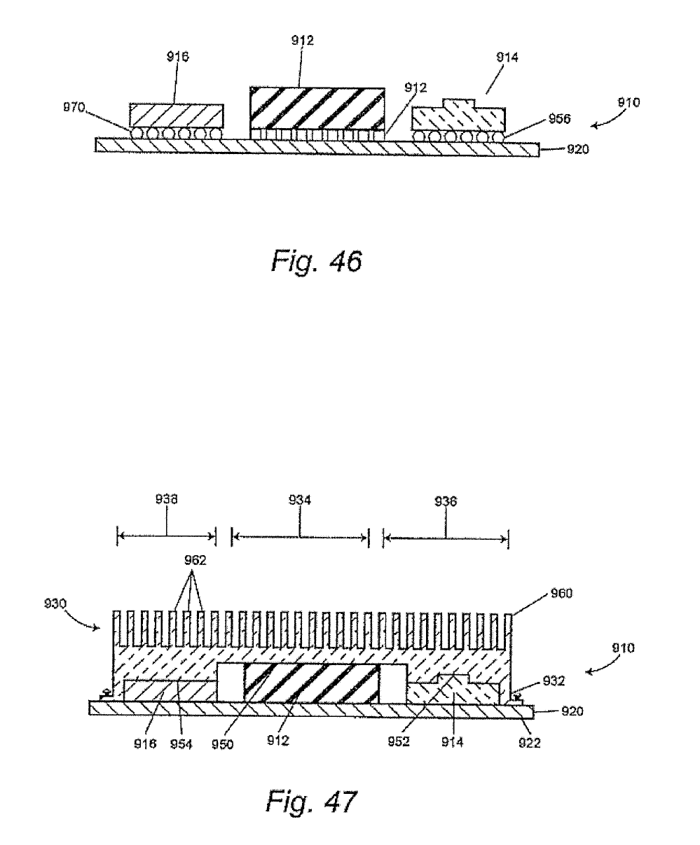

With reference to FIG. 46, a cross-section of a computing device 910 is shown. In some embodiments, computing device 910 comprises various heat-producing components such as a CPU or Northbridge 912, a video processor 914, and memory 916. Heat-producing components 912, 914 and 916 are operably connected to a printed circuit board 920 according to standard techniques known in the art. For example, in some embodiments a heat-producing component is operably connected to a PCB 920 via a pinned connection 956. In other embodiments, an interposer 958 is interposedly positioned between the heat-producing component 912 and the PCB, wherein the interposer 958 enables the binding of a PCA component 912 to the PCB via a BCA connection format.

Heat-producing components 912, 914 and 916 commonly have varying shapes, sizes, and dimensions to accommodate the various functions and capabilities of the individual components. Computing device 910 may further include non-heat producing components to provide a working computing device, such components to include an encasement, a bus architecture, a cooling fan, ROM, a mass storage device, an executable software program, an input device, an output device, RAM, and other components known in the art.

As discussed above, heat-producing components 912, 914 and 916 are generally fitted with individual heat sink devices having a size, shape and dimension selected to accommodate the heat-dissipating needs and size constraints of the computing device 910 environment and individual components. However, in some embodiments heat-producing components 912, 914 and 916 are fitted with a unitary, single heat sink device 930, as shown in FIG. 47.

Referring now to FIG. 47, unitary heat sink device 930 is shown coupled to PCB 920 and heat-producing components 912, 914 and 916. In some embodiments, unitary heat sink device 930 is provided having a plurality of receiving surfaces 950, 952 and 954 correspondingly positioned relative to the locations of heat-producing components 912, 914 and 916, respectively. In some embodiments, receiving surfaces 950, 952 and 954 each define an independent plane corresponding to a distance from PCB 920, the distance being approximately equal to the height of the respective component 912, 914 and 916. In other embodiments, receiving surface 952 comprises multiple parallel and perpendicular planes to accommodate the non-linear top surface of heat-producing component 914. Thus, in some embodiments heat sink 30 is designed and manufactured for a specific chip set configuration of computing device 910.

In some embodiments, receiving surfaces 950, 952 and 954 form interfaces with their respective heat-producing components 912, 914 and 916 thereby providing means for dissipating heat from the computing system 910. The interface between unitary heat sink 930 and the corresponding components 912, 914 and 916 is precisely fitted so as to eliminate voids created by surface roughness effects, defects and misalignment. In some embodiments, a thermal interface material (not shown) is further applied to the receiving surfaces 950, 952 and 954 to displace air present therebetween. Thermal interface materials may include a thermal grease, thermal paste, epoxy, phase change material, polyimide, graphite or aluminum tapes, silicone coated fabrics, and other gap fillers as known in the art.

Unitary heat sink 930 further comprises a heat diffusing duct surface 960. In some embodiments, duct surface 960 comprises a plurality of pins or fins 962. In other embodiments, duct surface 960 comprises at least one of a water cooling system, a heat pipe system, and a phase-change cooling system. In some embodiments, duct surface 960 further comprises a cooling fan (not shown). In other embodiments, computing system 910 further includes an external fan (not shown) used in combination with unitary heat sink 930.

In some embodiments, heat sink 930 is directly coupled to PCB 920 via pins 932. For example, in some embodiments PCB 920 comprises a plurality of holes 922 arranged in a predetermined pattern to accommodate the fastening of heat sink 930. In some embodiments, pins 932 comprise push pins having compression springs. In other embodiments, pins 932 comprise threaded standoffs having compression springs. Further, in some embodiments pins 932 comprise standard machine screws. Still further, in some embodiments heat sink 930 is secured to PCB 920 via a clip (not shown).

In some embodiments, heat sink 930 comprises a plurality of “heat zones” corresponding to a portion of the heat sink adjacent a heat-producing component. For example, heat sink 930 comprises a first heat zone 934 adjacent to CPU 912, a second heat zone 936 adjacent video processor 914, and a third heat zone 938 adjacent memory 916. Generally, as a heat-producing component begins to produce heat, the heat is removed from the component by the corresponding adjacent heat zone. However, in some embodiments where a first heat-producing component is actively producing heat, and a second, adjacent heat-producing component is not actively producing heat, the heat from the first heat-producing component is diffused and/or dissipated first by the heat zone adjacent the heat-producing component, and subsequently by the heat zone of the inactive heat-producing component. Thus, additional heat is removed from the active heat-producing component by the heat zones of both the first and second heat-producing components. Accordingly, the shared configuration of unitary heat sink 930 provides additional increased heat dissipating capabilities for any single heat-producing component 912, 914 or 916 which is actively producing heat.

For example, it is unlikely that all of the heat-producing components will heat up at the same time. When only the CPU 912 is actively heating up, the first, second and third heat zones 934, 936 and 938 provide increased diffusion and dissipation of heat thereby increasing the rate of cooling for CPU 912. In particular, as CPU 912 heats up a heat “bloom” is formed that initially fills heat zone 934 until the heat capacity of heat zone 934 is reached. Thereafter, the heat “bloom” is dissipated between adjacent heat zones 936 and 938. Similarly, when only video processor 914 is actively heating up, the first, second and third heat zones 934, 936 and 938 provide increased diffusion and dissipation of the video processor's heat “bloom” thereby increasing the rate of cooling for video processor 914. Thus, heat sink 930 provides increased heat dissipating properties for a single heat-producing component than could otherwise be provided by conventional heat sink configurations.

One of skill in the art will further appreciate that the thickness of the heat zone will directly affect the rate at which the heat bloom fills the respective heat zone of the active heat-producing component, prior to dissipating into adjacent heat zones. Accordingly, in some embodiments the thickness of a heat zone is modified in anticipation of the cooling needs and frequency/patterns of heating for a given heat-producing component.

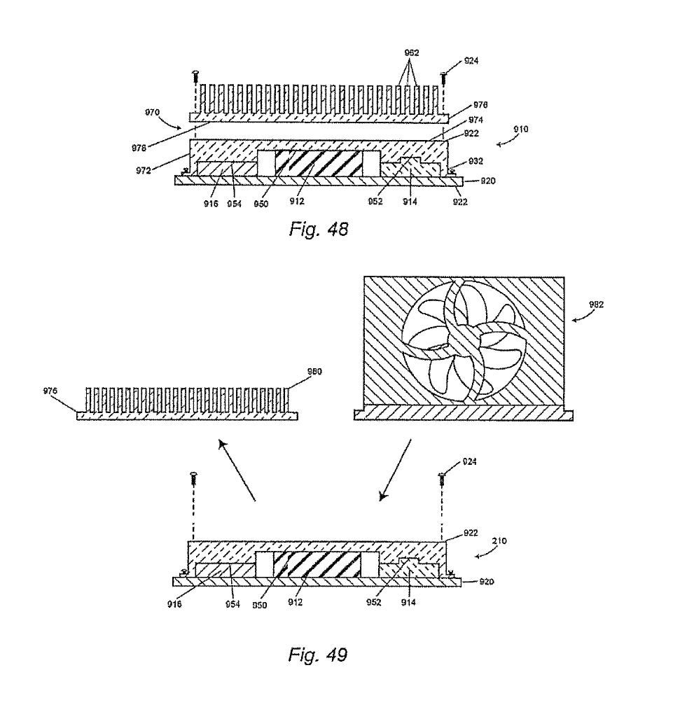

Referring now to FIG. 48, a modular heat sink device 970 is shown having a receiver 972 coupled to PCB 920 and forming interfaces with heat-producing components 912, 914 and 916. In some embodiments, receiver 972 comprises an adapter having a plurality of receiving surfaces 950, 952 and 954 correspondingly positioned relative to the locations of heat-producing components 912, 914 and 916, respectively. Receiver 972 further comprises an adapter surface 974 having a generally uniform plane on which to receive diffusing duct plate 976.

In some embodiments, receiving surfaces 950, 952 and 954 each define an independent plane corresponding to a distance from PCB 920, the distance being approximately equal to the height of the respective component 912, 914 and 916. In other embodiments, receiving surface 952 comprises multiple parallel and perpendicular planes to accommodate the non-linear top surface of heat-producing component 914. Thus, in some embodiments receiver 972 is designed and manufactured for a specific chip set configuration of computing device 910.

The effect of receiver 972 is to provide a heat dissipating adapter having a varied receiving surface 950, 952 and 954 to adapt to the various dimension, shapes and heights of the heat-producing components 912, 914 and 916, and an adapter surface having generally uniform surface for receiving a heat diffusing duct component 976. Thus, regardless of the specific height of the heat-producing components, receiver 970 provides a uniform adapter surface 974.

Modular heat sink 970 further comprises a diffusing duct plate 976. In some embodiments, duct plate 976 comprises an adapter surface 978 having a generally uniform plane for forming an interface with adapter surface 974 of receiver 972. Duct plate 976 further comprises a diffusing duct surface 980 having structures and features for dissipating heat from components 912, 914 and 916 via receiver 972.

The interface between duct plate 976 and receiver 972 is precisely fitted so as to eliminate voids created by surface roughness effects, defects and misalignment. In some embodiments, a thermal interface material (not shown) is further applied between the two adapter surfaces 974 and 978. Thermal interface materials may include those discussed above, as well as other materials known in the art.

In some embodiments, duct surface 980 comprises a plurality of pins or fins 962. In other embodiments, duct surface 980 comprises at least one of a water cooling system, a heat pipe system, and a phase-change cooling system. In some embodiments, duct surface 980 further comprises a cooling fan (not shown). In other embodiments, computing system 910 further includes an external fan (not shown) used in combination with unitary heat sink 970.

In some embodiments, duct plate 976 is directly coupled to receiver 972 via screws 924. For example, in some embodiments adapter surface 974 comprises a plurality of holes 922 arranged in a predetermined pattern to accommodate the fastening of duct plate 976. Thus, a user may interchangeably or modularly exchange duct plate 976 with another desired heat dissipating duct plate 982, as shown in FIG. 49.

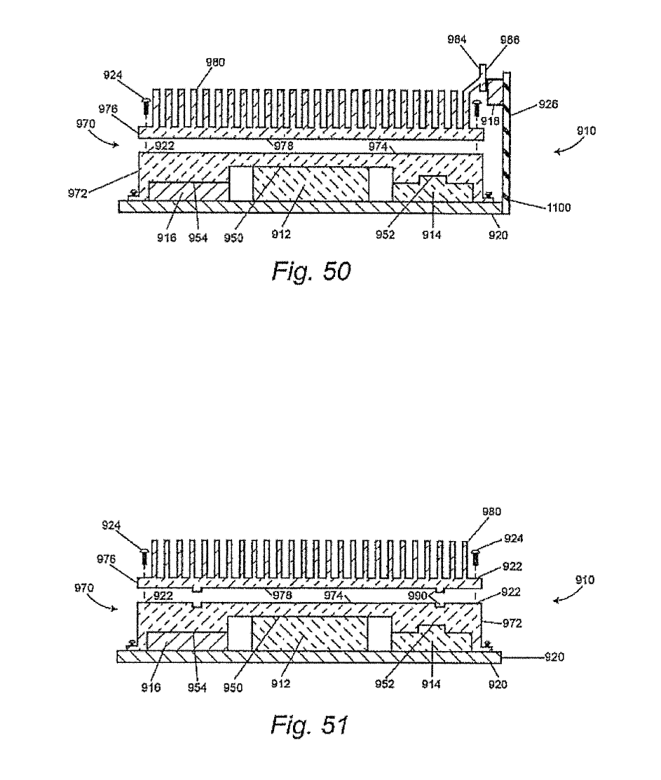

Referring now to FIG. 50, a PCB 1100 is shown having a first board 920 in a horizontal plane, and a second board 926 in a vertical plane. In some embodiments, second board 926 comprises a heat-producing component 918, such as an I/O processor or Southbridge. Therefore, in some embodiments diffusing duct plate 976 is modified to include an auxiliary contact pad 984 having an interface surface 986 for contacting component 918. The dimensions and height of contact pad 984 are selected such that when duct plate 976 is coupled to receiver 972, interface surface 986 is accurately aligned with heat-producing component 918. Thus, modular heat sink 970 is further implemented in dissipating unwanted heat created by component 918.

With reference to FIG. 51, in some embodiments adapter surfaces 974 and 978 are modified to include an alignment feature 990. Alignment feature 990 may include any combination of features to allow proper seating of duct plate 976 and receiver 972 wherein upon engaging alignment feature 990, holes 922 are properly aligned for insertion of screw 924.

While those skilled in the art will appreciate that the invention may be practiced in computing environments, those skilled in the art will also appreciate that the invention may be practiced in any area where heat dissipation is desired. For example, in some embodiments the present invention is used to remove unwanted heat from a refrigeration system. In other embodiments, the present invention is used to remove unwanted heat from an air conditioning system. Further, in some embodiments the present invention is used to remove unwanted heat from an optoelectronic device, such as a high-power laser or a light emitting diode.

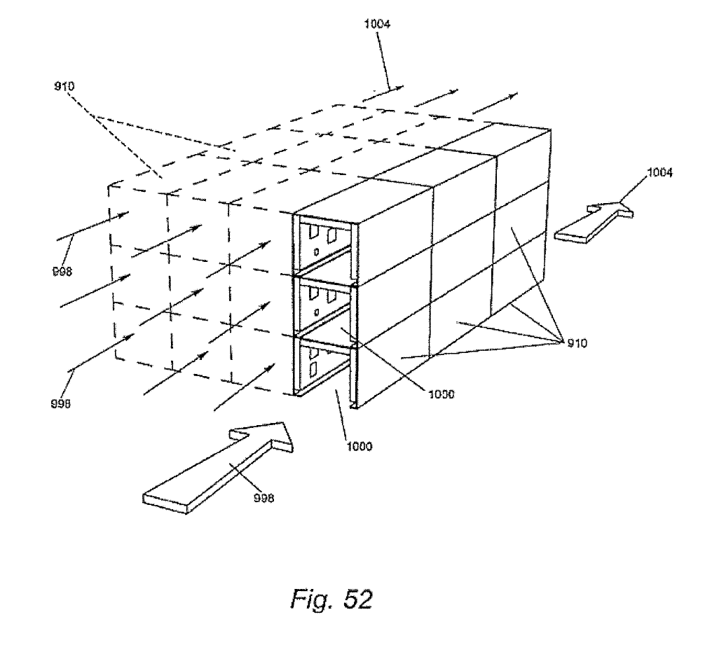

In some embodiments it is desirable to increase cooling of a computer system by increasing airflow around the heat-producing components. Referring now to FIG. 52, in some embodiments a plurality of operably interconnected computer devices 910 are arranged such that air channels 1000 are formed through the adjacent computer devices 910. In some embodiments, computer devices 910 are stacked, end-to-end following removal of endplates (not shown). As configured, the adjacent devices 910 form tunnels 1000 through which air 998 is forced to provide cooling to the various heat-producing components. In some embodiments, increased airflow further removes dust and other debris that may otherwise gather within the computer devices 910. As air is forced through tunnels or air channels 1000, heat 1004 within the air channels 1000 is removed and exhausted from the channels 1000. In some embodiments, a fan unit (not shown) is positioned exterior to channels 1000 to provide air flow 998. In other embodiments, a pressure gradient is provided across air channel 1000 whereby air is moved through the channels 1000 by means of a positive or negative air pressure.

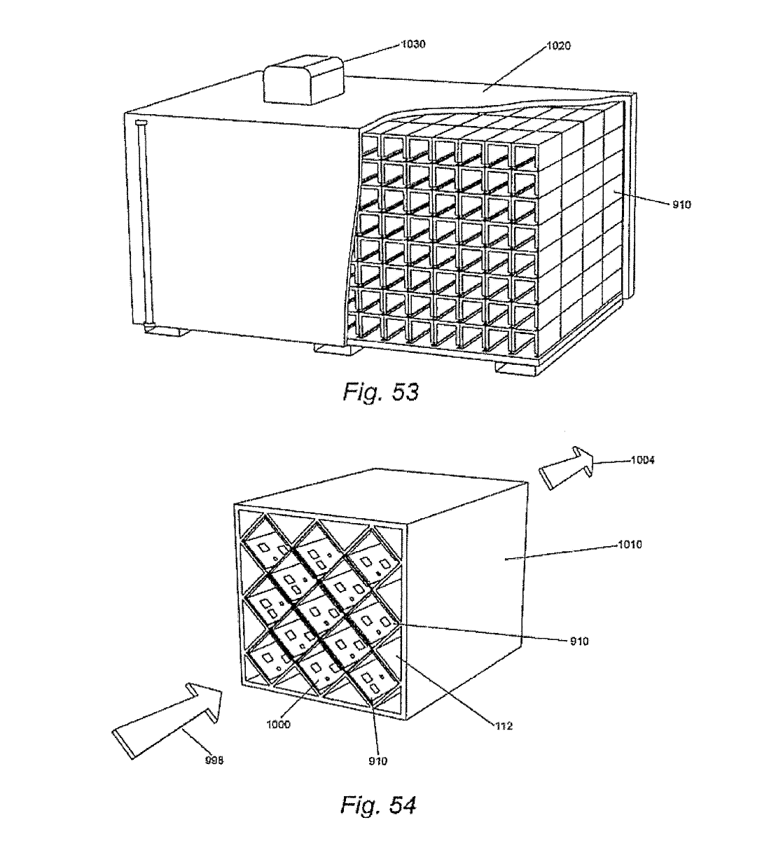

Referring now to FIG. 53, in some embodiments a plurality of operably connected computer devices 910 are arranged in a storage container 1020 having a cooling system 1030, such as an air conditioning unit. The cooling system 1030 and the storage container 1020 are thus optimized to provide adequate cooling and air flow to maintain an optimal operating temperature for the computer devices 910.

Referring now to FIG. 54, in some embodiments a plurality of operably connected computer devices 910 are arranged in a honeycomb pattern within an enclosure 1010. As thus configured, air flow is passed both through air channels 1000 and through a lumen 1102 interposed between computer devices 910 and enclosure 1010, thereby providing additional air flow and cooling.

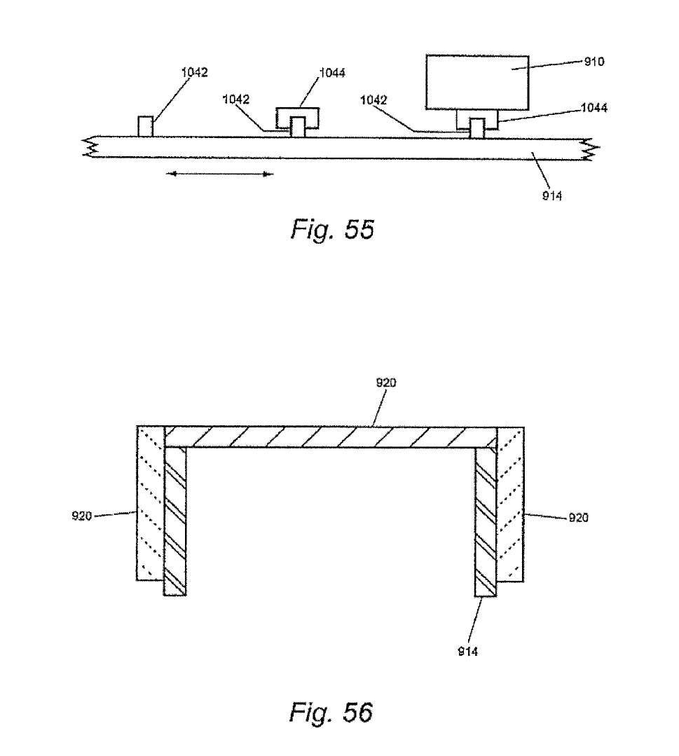

In some embodiments, computer device 910 is operably connected to additional computer devices (not shown) via a rail 1040, as shown in FIG. 55. In some embodiments a slidable mount 1042 is provided to provide infinite adjustment along rail 1040. In other embodiments an adapter 1044 is interposed between computer device 910 and mount 1042. In other embodiments, adapter 1044 is wiredly connected to mount 1042 and rail 1040. In other embodiments, computer device 910 is slidably and operably coupled to at least one of mount 1042 and adapter 1044 without the use of an external wire.

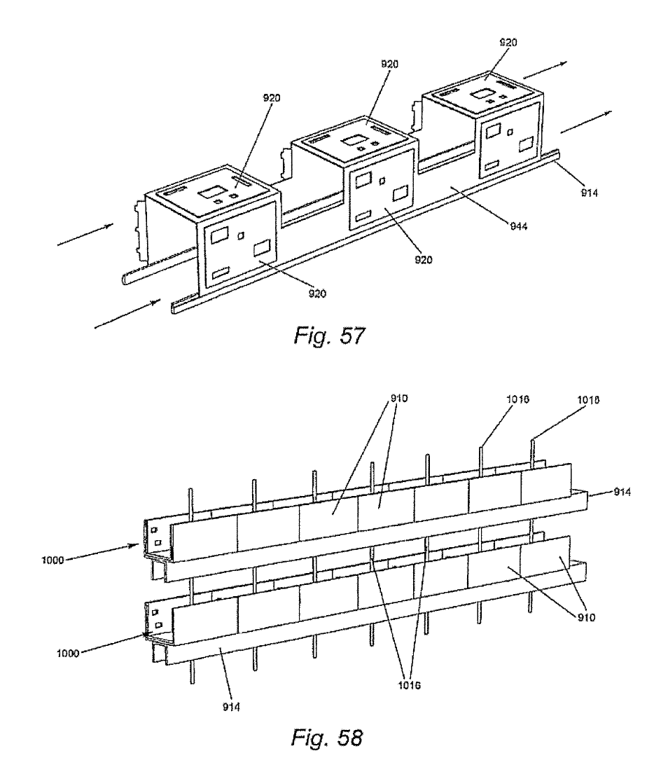

Referring now to FIG. 56, in some embodiments a plurality of PCBs 920 are directly coupled to a system of rails 914. As such, PCBs 920 are free from any enclosure thereby increasing the maximum expose to air flow and cooling. Further, in some embodiments a rack system 944 is implemented to operably couple a plurality of PCBs 920, as shown in FIG. 57. In some embodiments, rack system 44 is arranged within an enclosure (not shown) via alignment within rails 914.

With reference to FIG. 58, in some embodiments a plurality of computer devices 910 are arranged in a linear configuration to form air channels 1000, as discussed above. In some embodiments, devices 910 are coupled to a lower rail 914 by means of a compatible groove. In other embodiments, devices 910 are operable coupled via connection lines 1016 which are ran to the computer devices 910 from an overhead rail 914. Thus, the plurality of computer devices 910 are interchangeable or dynamically interconnected via lines 1016.

In one aspect, a heat sink, comprises: a receiver having a plurality of receiving surfaces for interfacing with a plurality of heat-producing components, the receiver further having an adapter surface; and a diffusing duct plate having an adapter surface for compatibly interfacing with the adapter surface of the receiver, the diffusing duct plate further having a diffusing duct surface.

### Systems and Methods for Mounting

As shown in FIG. 30, the encasement module 410 includes a plurality of slide receivers 482 designed to receive a corresponding insert located on one or more insert members, a dynamic backplane, or a mounting bracket of some sort used to couple two or more processing control units together, or to allow the processing control unit to be implemented into another structure, such as a Tempest superstructure. FIG. 30 also shows one or more inserts 466, 470, 474 comprises two insert engagement members 478 located at opposing ends of the insert. Engagement members 478 are designed to fit within a means for engaging or coupling with various external devices, systems, objects, etc. (hereinafter an external object), wherein the means for engaging is formed within main support chassis 414.

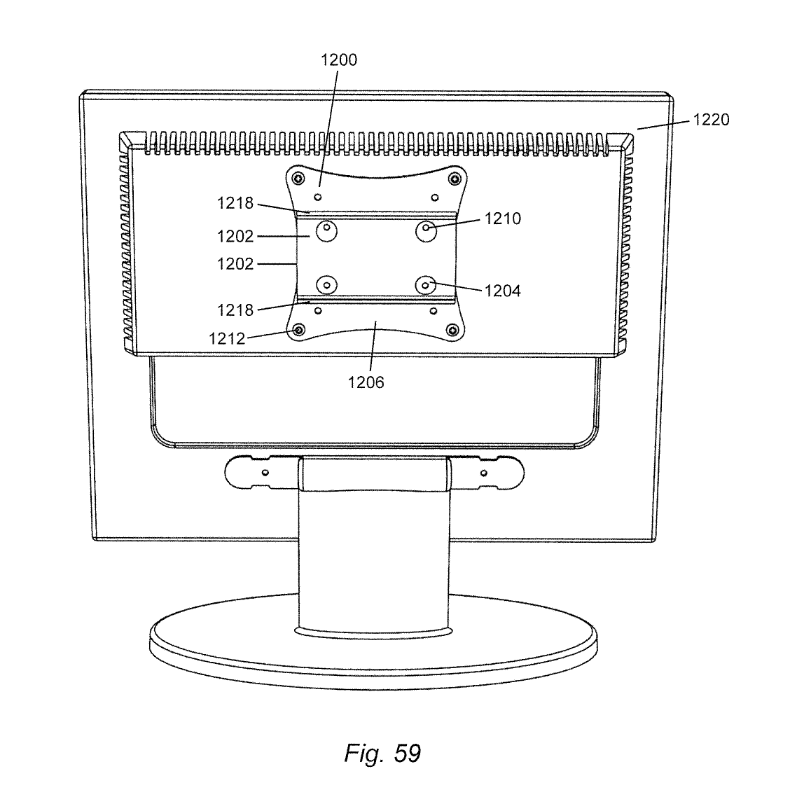

FIG. 59 depicts an embodiment of a mounting bracket 1200 that can be selectively inserted into the means for engaging an external object, and particularly slide receiver 482. The mounting bracket 1200 and the engagement means provides a process control unit 402 with the ability to be mounted to, or to have mounted onto it, any structure, device, or assembly using means for mounting and means for engaging an external object (each preferably comprising slide receiver 482, as existing on each wall support of main support chassis 414). Any external object having the ability to engage processing control unit 402 in any manner so that the two are operably connected is contemplated for protection herein. In addition, one skilled in the art will recognize that encasement module 410 may comprise other designs or structures as means for engaging an external object other than slide receivers 482.

In some instances, by providing mounting features to the processing control unit 402, no matter how this is achieved, is to be able to integrate processing control unit 402 into any type of environment as discussed herein, or to allow various items or objects (external objects) to be coupled or mounted to processing control unit 402. The unit is designed to be mounted to various inanimate items, such as multi-plex processing centers or transportation vehicles, as well as to receive various peripherals mounted directly to processing control unit 402, such as a monitor or LCD screen 1220.

The mountability feature is designed to be a built-in feature, meaning that processing control unit 402 comprises means for engaging an external object built directly into its structural components. Both mounting using independent mounting brackets (e.g. those functioning as adaptors to complete a host-processing control unit connection), as well as mounting directly to a host (e.g. mounting the unit in a car in place of the car stereo) are also contemplated for protection herein.

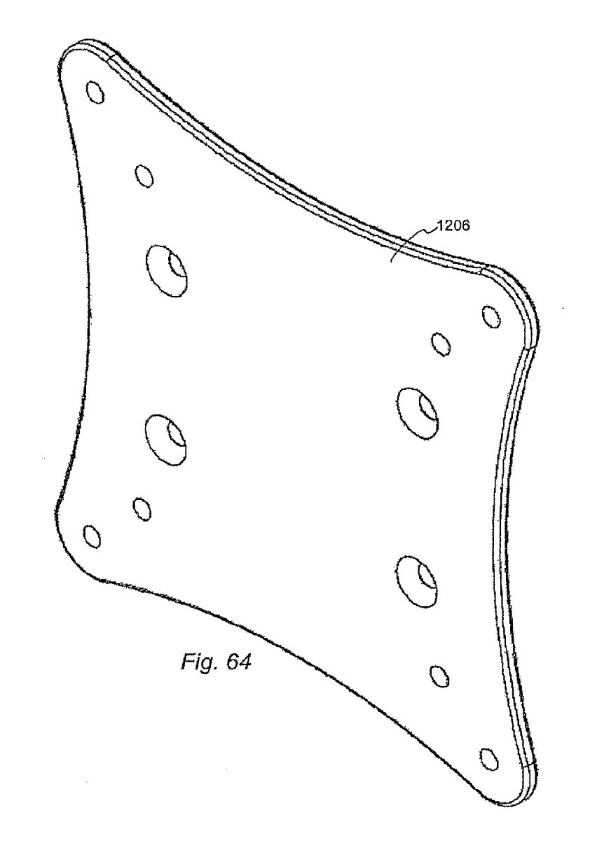

With more specific reference now made to FIGS. 59 to 65, representative embodiments of a mounting bracket assembly or structure 1200 for main support chassis 414 of processing control unit 402 are provided. As discussed briefly above, slide receivers 482 are capable of releasably coupling various types of external members, including mounting bracket assemblies or structures, to support chassis 414.

Generally, both mounting bracket assemblies 1200 depicted in FIGS. 59 to 65 preferably comprise an aluminum metal composition for the same reasons the chassis is comprised of such materials. Namely, to provide strong, yet light-weight characteristics as well as good heat conducting properties to mounting assembly 1202. Further, the aluminum finish maintains the aesthetic appearance of the processing control unit chassis 414, end plates 438, 442 and end caps 446, 450. To this end, mounting assembly 1200 can be anodized or otherwise finished or personalized to match or complement the chassis, which can also be anodized or otherwise similarly finished or personalized, if desired. Similarly, mounting assembly 1200 and back plates 1206 are curved or otherwise styled to complement chassis 414. In addition, the aluminum metal composition of mounting assembly 1200 maintains the structural integrity necessary to support the numerous applications and mounting configurations contemplated by the present invention.

However, while in some embodiments mounting assembly 1200 is preferably constructed of aluminum or various grades of aluminum and/or aluminum composites, in other embodiments mounting assembly 1200 may be constructed of other materials, such as titanium, copper, magnesium, the newly achieved hybrid metal alloys, steel, and other metals and metal alloys, as well as plastics, graphites, composites, nylon, or a combination of these depending upon the particular needs and/or desires of the user. Likewise, in some embodiments, mounting assembly 1200 could be constructed of a suitable material and subsequently coated in an insulative material where desired. For example, if it is desirable to electrically charge chassis 414 but it is undesirable to electrically charge the mounting assembly, or it is desirable to insulate the electrically charged chassis 1214 from the surrounding environment, this can be accomplished through constructing mounting assembly 1200 of, or coating mounting assembly 1200 in, an insulative material.

With specific reference to FIG. 59, a first representative mounting assembly 1200 is provided. As illustrated, mounting assembly 1200 includes an insert 1202 akin to first, second, and third inserts 466, 470, and 474 of FIG. 30. Specifically, mounting assembly insert 1202 comprise substantially the same radius of curvature as any of concave wall supports 418, 422, and 426 so that they may mate or fit together in a nesting or matching relationship. Indeed, mounting assembly 1200 could mate with anyone of wall supports 418, 422, or 426 as desired according to the most efficient or suitable orientation for the processing control unit 402 to be mounted. In addition, insert 1202 also includes engagement members 478 such that it may be slideably engaged or received in corresponding slide receivers 482 in a releasable manner so as to allow insert 1202 to slide in and out as needed.

In some embodiments, end plates 438, 442 and end caps 446, 450 must be removed before insert 1202 can be slid in or out of receivers 482 as needed. In other words, when chassis 414 is fully assembled, plates 438, 442 and end caps 446, 450 cover or otherwise preclude access to slide receivers 482 such that items can neither be inserted into nor removed from receivers 482 unless the plates/end caps are first removed. In this way, insert 1202 remains securely affixed to the chassis of processing control unit 402 during use. Further, end plates 438, 442 and end caps 446, 450 can be equipped with tamper proof features such that it becomes self-evident if someone removes the plates/end caps without authorization. Again, such features increase the security of processing control unit 402. However, upon removal of plates 438, 442 and end caps 446, 450, insert 1202 may be conveniently inserted or removed as desired.

As with inserts 466, 470, and 474, other means are also contemplated for coupling chassis 414 to insert 1202, such as utilizing various attachments ranging from snaps, screws, rivets, interlocking systems, and any others commonly known in the art beyond the two insert engagement members 78 located at opposing ends of insert 1202.

As depicted in the figures, insert 1202 has formed or machined holes 1204 which correspond to mounting holes 1208 found in back plates 1206. Further, attachment means 1210 are used to secure insert 1202 to back plates 1206. The holes 1204 are also countersunk such that attachment means 1210 do not protrude beyond the proximal surface of insert 1202, or the surface between the face of insert 1202 and wall supports 418, 422, or 426. In this manner attachment means 1210 do not interfere with the nesting engagement between insert 1202 and concave wall supports 418, 422, or 426 during use. Furthermore, holes 1208 are also countersunk into black plates 1206 such that it can be mounted flush on the surface of another object, such as a wall. In this fashion, attachment means 1210 securely hold mounting assembly 400 together without interfering with the surrounding environment or processing control unit 402.

FIGS. 59 to 65 also depict a number of holes 1212 located at various locations in back plates 1206. Holes 1212 are for convenience of mounting the assembly 1200 to an appropriate environment. Accordingly, depending on the intended application of mounting assembly 1200, holes 1212 can be located at any suitable location and any suitable number of holes can be provided. Through holes 1212 any suitable attachment means (not shown) may be employed to secure mounting assembly 1200, and thereby chassis 414, to a desired environment or location. As with holes 1204 and 1208, holes 1212 can be countersunk as desired.

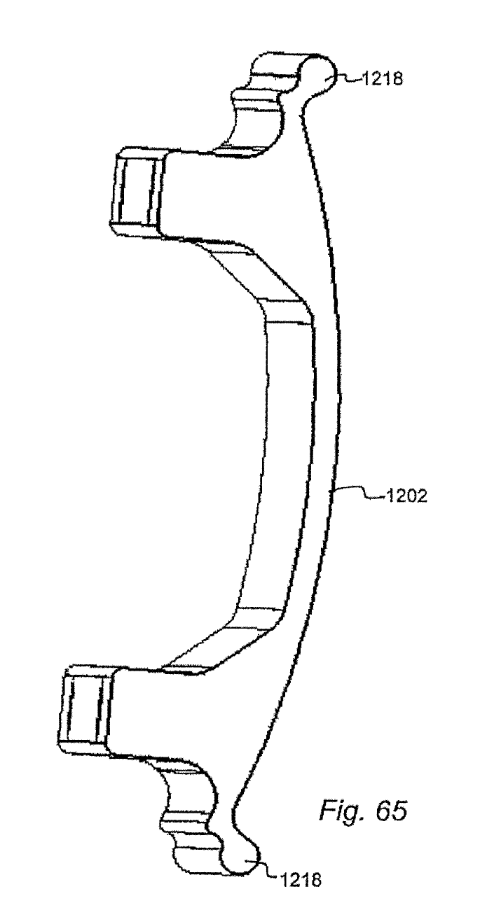

With reference to the mounting assembly depicted in FIGS. 459 to 65, a representative smaller back plate 1206 is illustrated. The size of back plate 1206 renders the holes 1212 inaccessible when chassis 414 is connected to insert 1202 because the body of chassis 414 covers the attachment means (not shown). In this way, processing control unit 402 can be mounted or otherwise secured to a particular location such that it cannot be easily removed or tampered with. For example, processing control unit 2 could be mounted to a computer monitor 1220 as shown or another surface during the assembly process and shipped that way to an end user such that processing control unit 402 cannot be easily disassembled from a corresponding computer monitor or other location. At a minimum, the tamper proof features would render unauthorized removal of or tampering with the mounting assembly self-evident. Again, such features increase the security of processing control unit 2. However, upon removal of plates 438, 442 and end caps 446, 450, insert 1202 may be conveniently inserted or removed as desired and back plate 1206 may be conveniently mounted or removed from a corresponding environment.

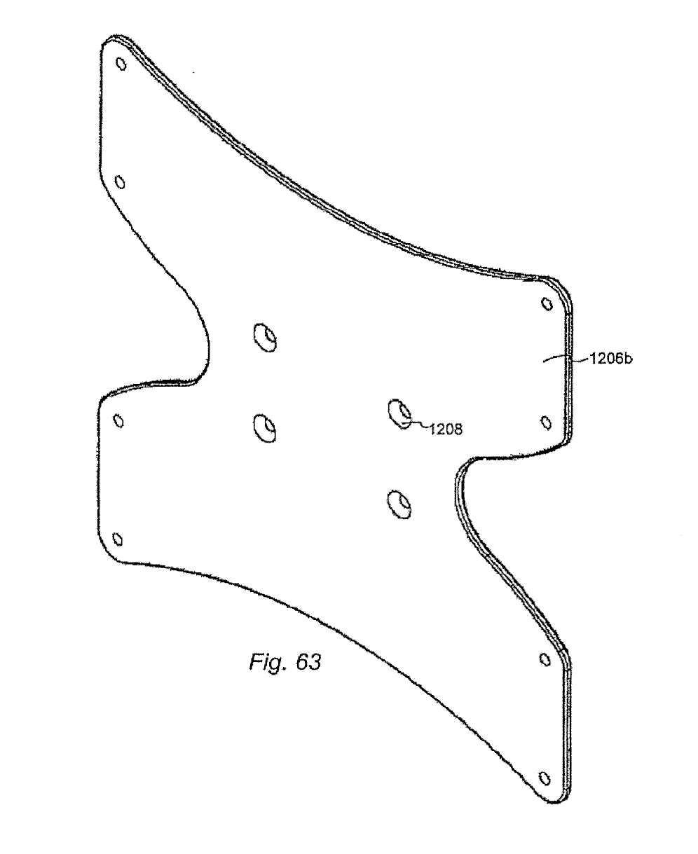

With reference now to FIG. 63, a representative embodiment of a larger back plate 1206b is provided. Back plate 1206b includes the same pattern of holes 1208 such that back plate 1206a of FIG. 59 and can be connected to insert 1202. However, as depicted, back plate 1206 is sufficient large that even when it is connected to chassis 414 via insert 1202 (neither of which is shown) the user can still access the attachment means (not shown) which would secure back plate 1206, and thereby the entire assembly, in a particular location or on a particular surface. In this way, the completed assembly, including chassis 414 and mounting assembly 1200, can be conveniently mounted or removed as a single unit from a particular location without the necessity of disassembling chassis 414.

With regard to either of the mounting assembly embodiments 1200 discussed above and other embodiments contemplated by this disclosure, chassis 414 can be mounted or attached to any suitable location including any stationary or dynamic location. Further, in some embodiments, back plates 1206a are each manufactured according to standards established by the Video Electronics Standards Association (VESA) such that they can be mounted directly to computer monitors and other computer components such that chassis 414 can be attached securely thereto. Further, while back plates 1206a and 1206b are depicted as substantially flat or planer, in some embodiments back plates 406a/406b may be curved or bent in any desired radius or configuration, size or shape such that they are suitable for their intended purpose.

Another capability of processing control unit 402 is its ability to be mounted and implemented within a super structure, such as a Tempest super structure, if additional hardening of the encasement module is effectuated. In such a configuration, processing control unit 2 is mounted within the structure as described herein, and functions to process control the components or peripheral components of the structure. Processing control unit 402 also functions as a load bearing member of the physical structure if necessary. All different types of super structures are contemplated herein, and can be made of any type of material, such as plastic, wooden, metal alloy, and/or composites of such.

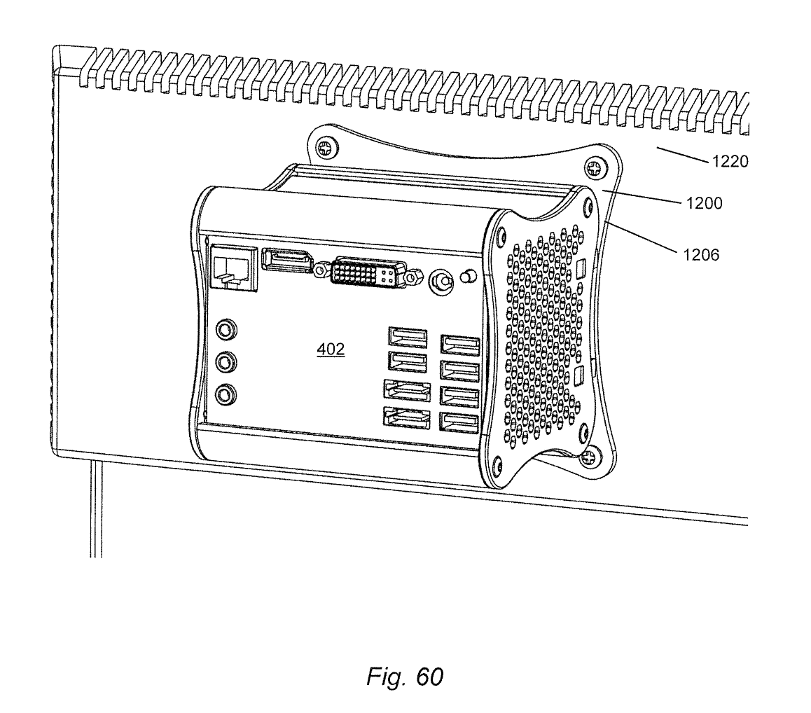

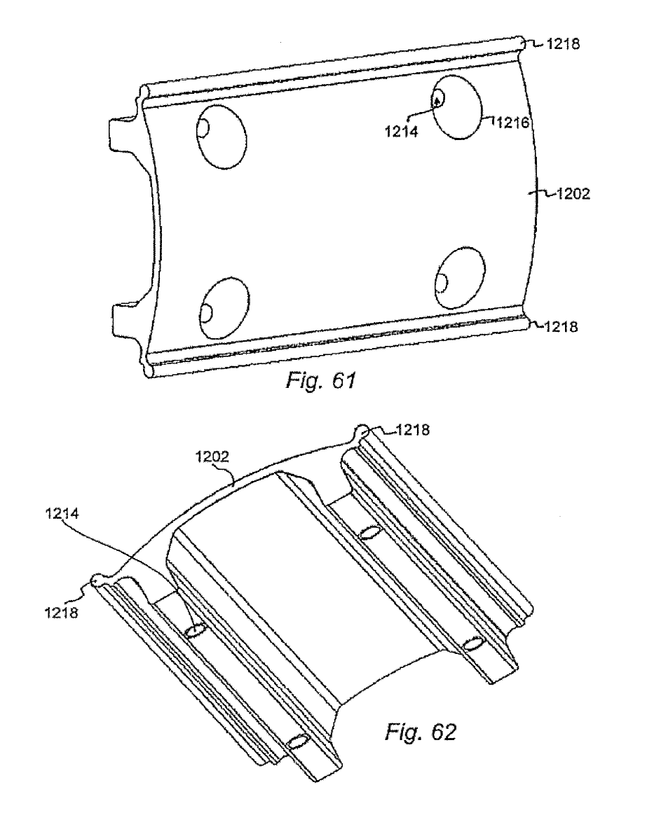

FIG. 60 depicts a backplate 1206 of a mount 1200 mounted on a computer device, such as a monitor or display screen 1220. A computer device/system, such as a process control unit 402 is mounted on the mount. FIG. 65 depicts another embodiment of a mount, which is thinner, according to some embodiments.

### Providing Computing Resources Using Modular Devices

Existing devices such as storage devices traditionally utilize a single bus system (e.g. PATA, SATA, PCIe, etc.) and are typically limited to a single medium (e.g. a spinning disk or a solid-state storage medium). These devices may be available in different storage sizes and/or capabilities, and different physical sizes and/or form factors. Currently, the choice of medium is commonly determined by balancing a variety of factors such as a desired speed of access, size of storage and physical size, and also cost.

The considerations involved in selecting among the available devices are further constrained in the context of selecting among external devices such as external storage systems. Such systems are commonly connected to a central computer device by an external cable (e.g. USB, IEEE 1394 (Firewire), PCIe, eSATA, etc.) and are often constrained or limited to a single device or function. The size constraints of such devices may be even more strict than the size constraints discussed above.

Many devices utilize a printed circuit board (PCB) or other functional and/or structural board to provide certain mounting functions. In such devices, it is normal for components of the device to be mounted exclusively on a single side of the PCB or other board.

Implementation of the invention provides a modular computing device having a housing defining an internal volume. A printed circuit board is mounted within the housing. The printed circuit board has a first major surface and an opposite second major surface, and a first computing component is communicatively connected to the printed circuit board and disposed along the first major surface. The printed circuit board is configured to receive a second computing component communicatively connected to the printed circuit board and disposed along the second major surface, and, optionally, a second computing component is communicatively connected to the printed circuit board and disposed along the second major surface.

Embodiments of the invention provide a modular computing device having a housing defining an internal volume. A printed circuit board is mounted within the housing. The printed circuit board has a first major surface and an opposite second major surface, and a first computing component is communicatively connected to the printed circuit board and disposed along the first major surface. The printed circuit board is configured to receive a second computing component communicatively connected to the printed circuit board and disposed along the second major surface, and, optionally, a second computing component is communicatively connected to the printed circuit board and disposed along the second major surface.

The following portion of the description is broken into several headings for purposes of increasing understanding of the description, and is not intended to be limiting in any way.

Representative Operating Environments

The following description of operating environments should be understood to be illustrative of the types of environments in which embodiments of the invention may be utilized and implemented, and it is not intended that all embodiments of the invention include every feature discussed herein or be utilized in environments containing every feature discussed herein. The following is therefore intended to assist in understanding the various embodiments of the invention only.

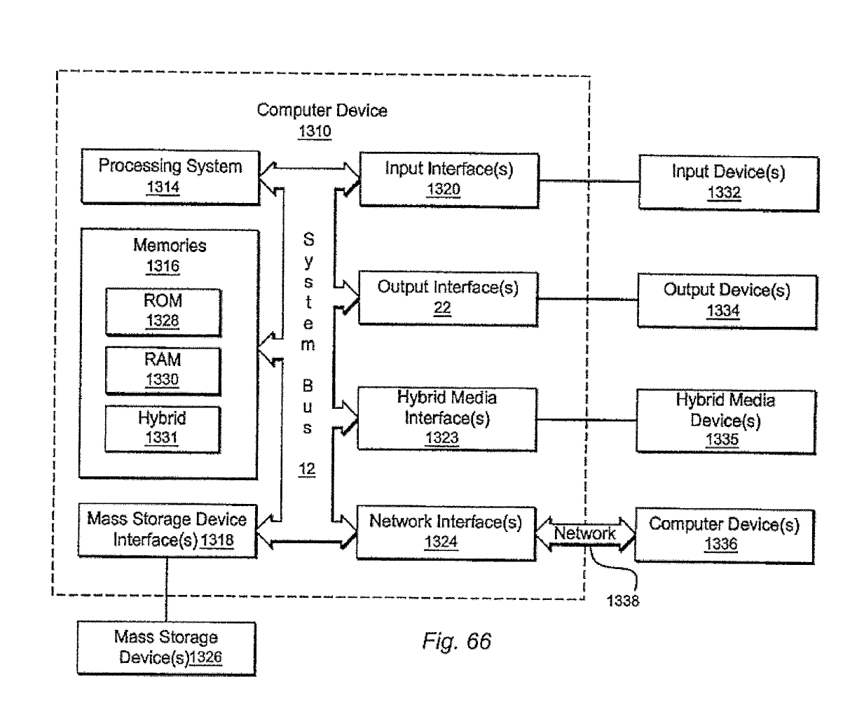

FIG. 66 and the corresponding discussion are intended to provide a general description of a suitable operating environment in which embodiments of the invention may be implemented, taken in conjunction with the disclosure of the related applications incorporated herein by reference. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 66, a representative system for implementing embodiments of the invention includes computer device 1310, which may be a general-purpose or special-purpose computer or any of a variety of consumer electronic devices. For example, computer device 1310 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, a modular computer as disclosed in the related applications or the like.

Computer device 1310 includes system bus 1312, which may be configured to connect various components thereof and enables data to be exchanged between two or more components. System bus 1312 may include one of a variety of bus structures including a memory bus or memory controller, a peripheral bus, or a local bus that uses any of a variety of bus architectures. Typical components connected by system bus 1312 include processing system 1314 and memories 1316. Other components may include one or more mass storage device interfaces 1318, input interfaces 1320, output interfaces 1322, and/or network interfaces 1324, each of which will be discussed below.

Processing system 1314 includes one or more processors, such as a central processor and optionally one or more other processors designed to perform a particular function or task. It is typically processing system 1314 that executes the instructions provided on computer-readable media, such as on memories 1316, a magnetic hard disk, a removable magnetic disk, a magnetic cassette, an optical disk, or from a communication connection, which may also be viewed as a computer-readable medium.

Memories 1316 includes one or more computer-readable media that may be configured to include or includes thereon data or instructions for manipulating data, and may be accessed by processing system 1314 through system bus 1312. Memories 1316 may include, for example, ROM 1328, used to permanently store information, RAM 1330, used to temporarily store information, and/or hybrid memories 1331. ROM 1328 may include a basic input/output system (“BIOS”) having one or more routines that are used to establish communication, such as during start-up of computer device 1310. RAM 1330 may include one or more program modules, such as one or more operating systems, application programs, and/or program data. Hybrid memories 1331 may have features and capabilities hybridized from those of ROM 1328 and RAM 1330.

One or more mass storage device interfaces 1318 may be used to connect one or more mass storage devices 1326 to system bus 1312. The mass storage devices 1326 may be incorporated into or may be peripheral to computer device 1310 and allow computer device 1310 to retain large amounts of data. Optionally, one or more of the mass storage devices 1326 may be removable from computer device 1310. Examples of mass storage devices include hard disk drives, magnetic disk drives, tape drives, solid state drives/flash drives, hybrid drives utilizing multiple storage types, and optical disk drives. A mass storage device 1326 may read from and/or write to a magnetic hard disk, a removable magnetic disk, a magnetic cassette, an optical disk, or another computer-readable medium. Mass storage devices 1326 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 1320 may be employed to enable a user to enter data and/or instructions to computer device 1310 through one or more corresponding input devices 1332. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 1320 that may be used to connect the input devices 1332 to the system bus 1312 include a serial port, a parallel port, a game port, a universal serial bus (“USB”), an integrated circuit, a firewire (IEEE 1394), or another interface. For example, in some embodiments input interface 1320 includes an application specific integrated circuit (ASIC) that is designed for a particular application. In a further embodiment, the ASIC is embedded and connects existing circuit building blocks.

One or more output interfaces 1322 may be employed to connect one or more corresponding output devices 1334 to system bus 1312. Examples of output devices include a monitor or display screen, a speaker, a printer, a multi-functional peripheral, and the like. A particular output device 1334 may be integrated with or peripheral to computer device 1310. Examples of output interfaces include a video adapter, an audio adapter, a parallel port, and the like.

One or more hybrid media interfaces 1323 may be employed to connect one or more hybrid media devices 1335 to the system bus 1312. A hybrid media interface 1323 may include multiple single input/output ports and/or buses combined on a single connector to provide added value. Non-limiting examples of the types of ports/buses that can be combined in the hybrid media interface(s) 1323 and/or associated buses/ports include PCIe, I2C, power, a proprietary secure bus, SATA, USB, and the like. The hybrid media devices 1335 so connected to the computer device 1310 may include a variety of peripheral devices, storage systems, PCIe devices, USB devices, SATA devices and the like.

One or more network interfaces 1324 enable computer device 1310 to exchange information with one or more other local or remote computer devices, illustrated as computer devices 1336, via a network 1338 that may include hardwired and/or wireless links. Examples of network interfaces include a network adapter for connection to a local area network (“LAN”) or a modem, wireless link, or other adapter for connection to a wide area network (“WAN”), such as the Internet. The network interface 1324 may be incorporated with or peripheral to computer device 1310. In a networked system, accessible program modules or portions thereof may be stored in a remote memory storage device. Furthermore, in a networked system computer device 1310 may participate in a distributed computing environment, where functions or tasks are performed by a plurality of networked computer devices.

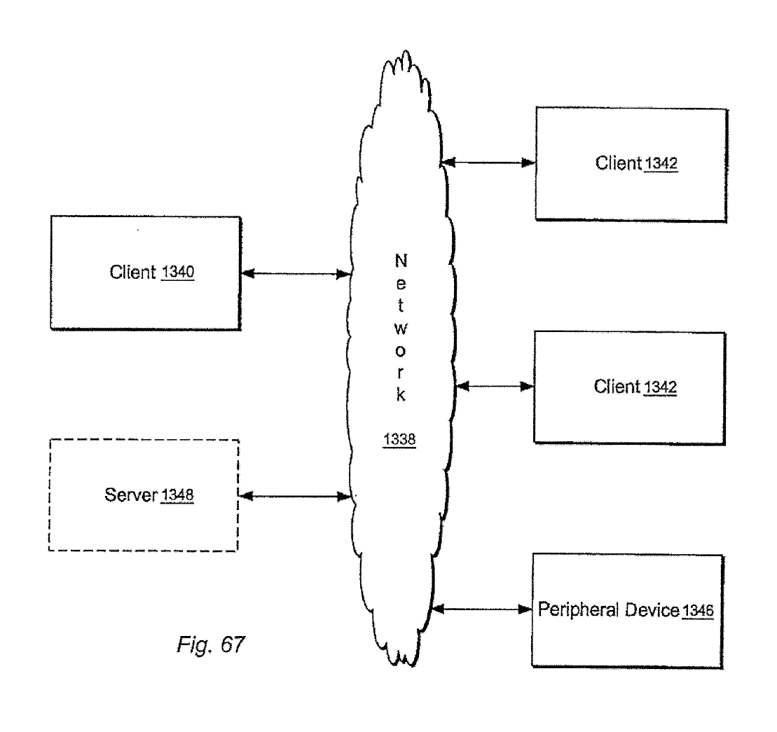

Thus, while those skilled in the art will appreciate that embodiments of the present invention may be practiced in a variety of different environments with many types of system configurations, FIG. 67 provides a representative networked system configuration that may be used in association with embodiments of the present invention. The representative system of FIG. 67 includes a computer device, illustrated as client 1340, which is connected to one or more other computer devices (illustrated as clients 1342) and one or more peripheral devices (illustrated as multifunctional peripheral (MFP) MFP 1346) across network 1338.

While FIG. 1367 illustrates an embodiment that includes a client 1340, two additional clients 1342, MFP 1346, and optionally a server 1348, which may be a print server, connected to network 1338, alternative embodiments include more or fewer clients, more than one peripheral device, no peripheral devices, no server 1348, and/or more than one server 1348 connected to network 1338. Any of the computer systems illustrated in FIG. 67 may utilize and/or incorporate features discussed in any of the related applications such as base modules and peripheral modules as discussed in co-pending provisional application Ser. No. 61/407,904 (Attorney Docket Number: 11072.268) titled “MODULAR VIRTUALIZATION IN COMPUTER SYSTEMS” filed Oct. 28, 2010. Thus, any of the computer device 1310, the client 1340, the client 1342, the server 1348, etc. may include or consist of a base module and/or a peripheral module as disclosed in that application. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Provision of Computing Resources Using Modular Device(s)

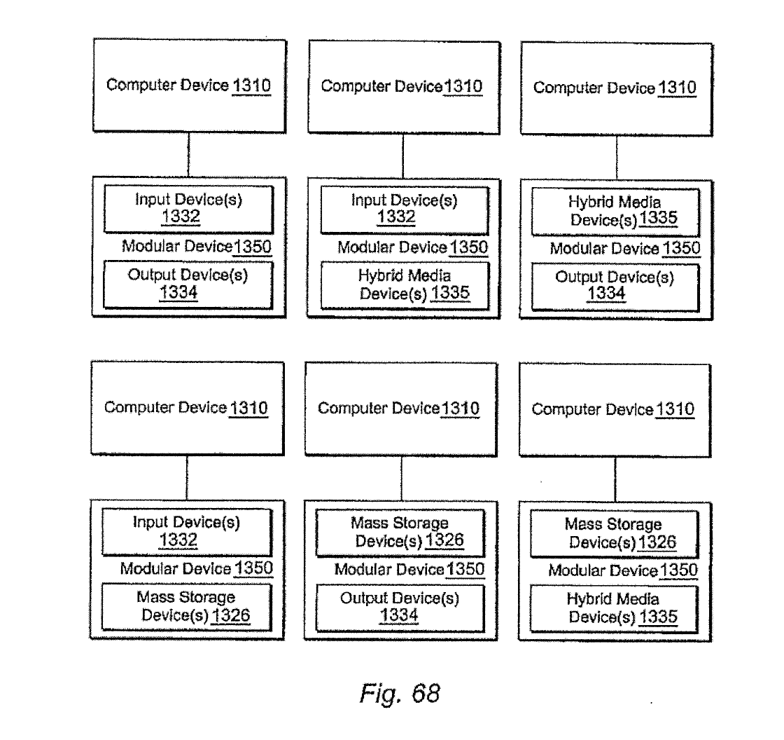

Certain embodiments of the invention permit the unification of multiple devices in a single modular device 1350 as illustrated in FIG. 68. Modular devices 1350 may include different devices and may be configured in a variety of ways, as is also illustrated in the depiction of FIG. 68. FIG. 68 depicts six different conceptual configurations of modular devices 1350, each of which is further representative of potentially several different types of modular devices 1350. Each modular device 1350 may be selectively attached to the computer device 1310 using any of a variety of communicative connections (e.g. wired connections such as USB, PCIe, IEEE 1394, eSATA, hybrid media bus, fiber optic, or any other standard or proprietary wired connection, wireless connections such as WiFi, WiMAX, infrared, other optical, or any other standard or proprietary wireless connection, and any other type of communicative connection now existing or later invented). The modular device 1350 may be communicatively connected to the computer device 1310 directly or through one or more additional communicative connections, such as through a network or modular computer system as discussed in some of the related applications.

Each modular device 1350 includes one or more devices providing some functionality to the computer device. For example, as illustrated in the upper left depiction of FIG. 68, the modular device 1350 may include one or a combination of one or more of the input devices 1332 and one or more of the output devices 1334. Alternatively, as illustrated in the upper central depiction of FIG. 68, the modular device 1350 may include one or a combination of one or more of the input devices 1332 and one or more of the hybrid media devices 1335. Alternatively, as illustrated in the upper right depiction of FIG. 68, the modular device 1350 may include one or a combination of one or more of the output devices 1334 and one or more of the hybrid media devices 1335. Alternatively, as illustrated in the lower left depiction of FIG. 68, the modular device 1350 may include one or a combination of one or more of the input devices 1332 and one or more of the mass storage devices 1326. Alternatively, as illustrated in the lower central depiction of FIG. 68, the modular device 1350 may include one or a combination of one or more of the output devices 1334 and one or more of the mass storage devices 1326. Alternatively, as illustrated in the lower right depiction of FIG. 68, the modular device 1350 may include one or a combination of one or more of the mass storage devices 1326 and one or more of the hybrid media devices 1335. The specific modular devices 1350 depicted and discussed with respect to FIG. 68 are intended to be illustrative only.

In at least some embodiments, the modular device 1350 is “modular” in that it includes a single chassis or housing containing some, a majority, or all of the components making up the modular device. By communicatively connecting the modular device 1350 to the computer device 1310, resources of the modular device 1350 are made available to the computer device 1310. Because embodiments of the modular device 1350 include or have the capability to include multiple devices, the resources of these multiple devices may be made available to the computer device 1310 using a single communicative connection and using a single effective modular device.

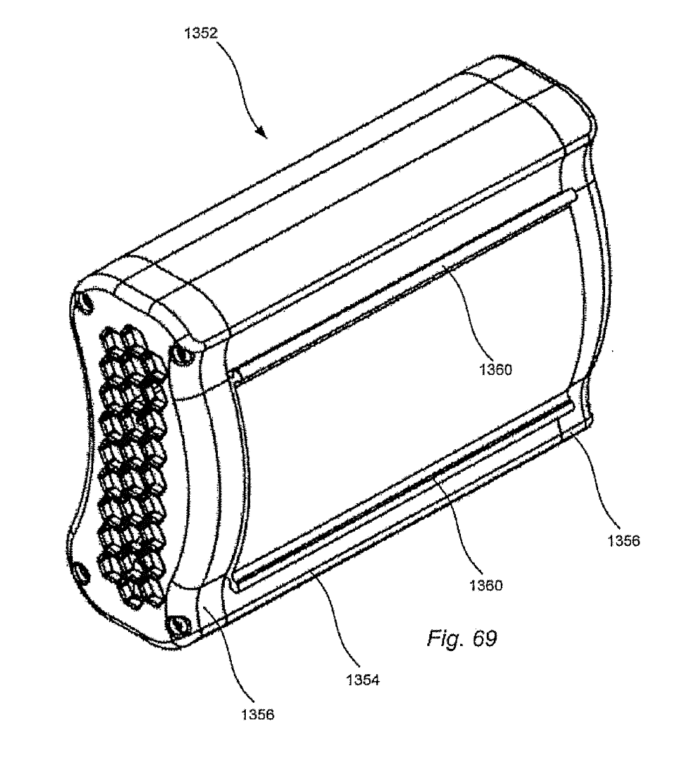

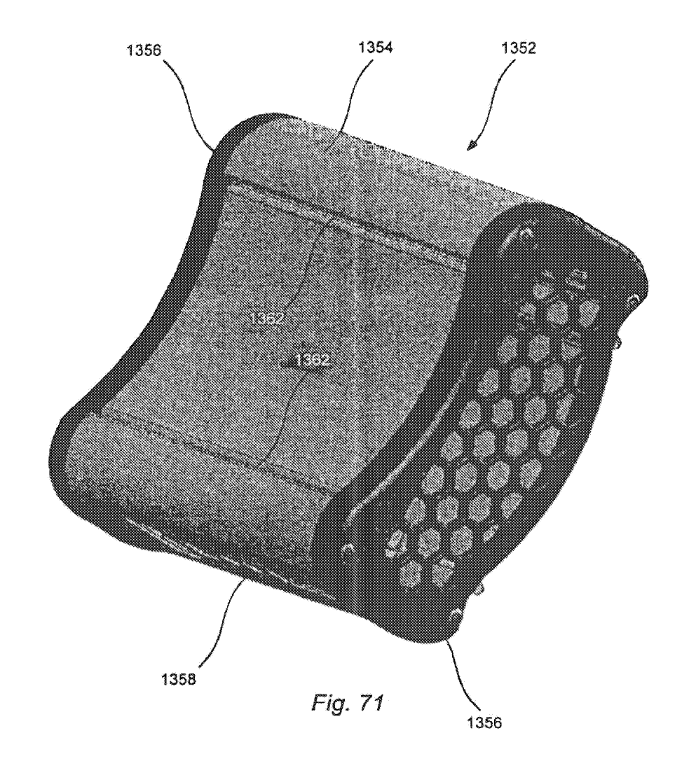

FIG. 69 shows a perspective view of one illustrative embodiment of a housing 1352 that may be used for the modular device 1350. As may be seen in this Figure, the housing 1352 includes an outer structural shell 1354 and two end caps 1356. The structural shell 1354 and end caps 1356 serve to enclose and protect components of the modular device 1350. The structural shell 1354 may be made of a variety of materials, including plastics and metals, including aluminum and/or metal alloys, and may be formed in a way so as to provide structural functions as discussed in the related applications. Additionally, the structural shell 1354 may be formed so as to mate with the structure of other modular devices 1350 or other computer components as is illustrated in FIG. 8. Any ports provided to the modular device 1350 may be provided at either end (e.g. by passing through one or more of the end caps 1356) or along one of the edges of the modular device (e.g. by passing through an open end of the shell 1354 or through an opening in a cover plate 58 closing an open end of the shell 1354, as shown in FIG. 71.

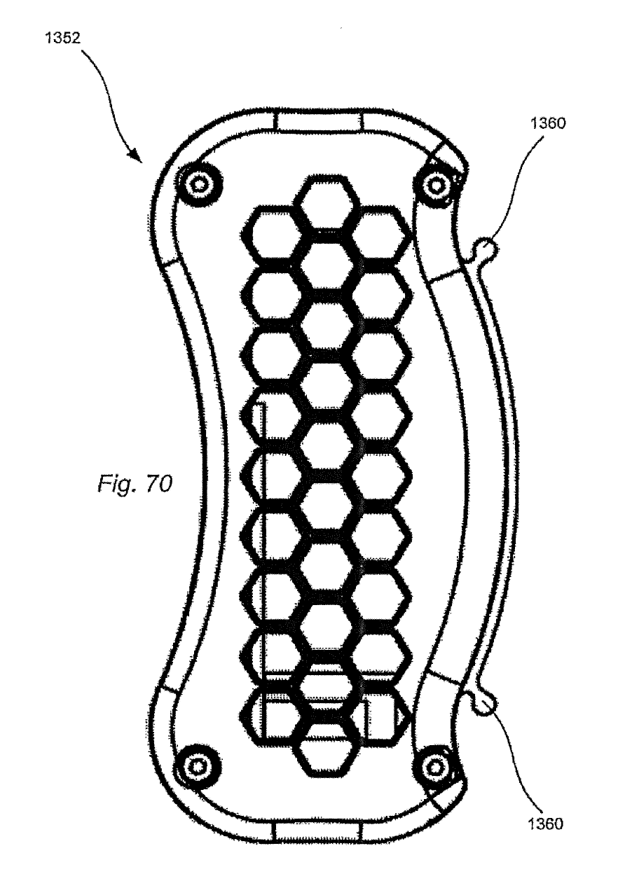

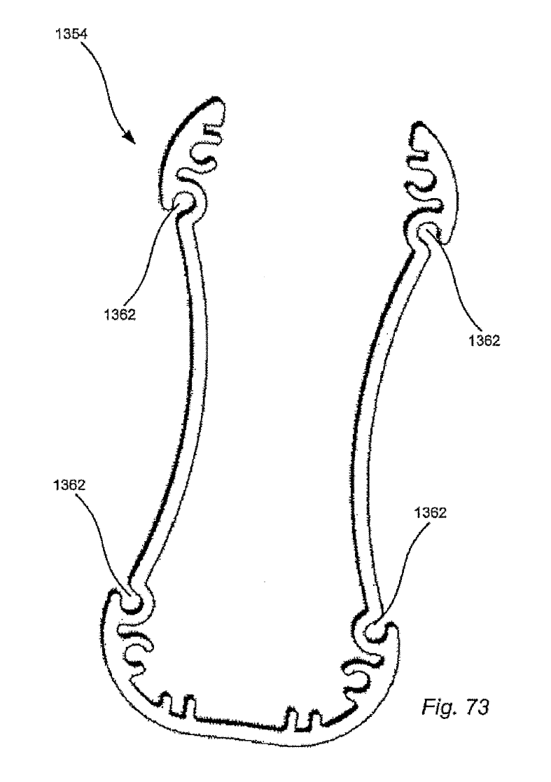

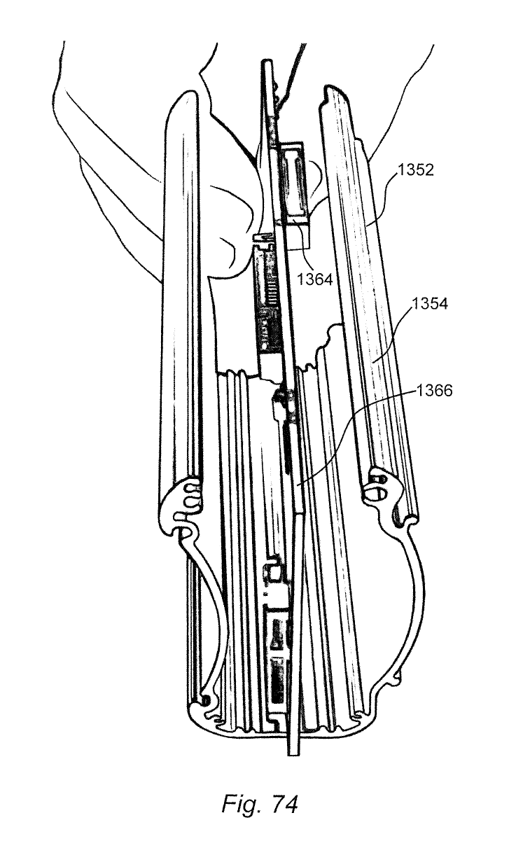

FIGS. 70 and 71 show end and perspective views of the housing 1352, respectively. In these views and in the view of FIG. 69, some features of the structural shell 1354 are visible that show one way in which mating with other devices may be accomplished. As may be seen in FIGS. 69 and 70, the structural shell 1354 may be formed (e.g. extruded) to have a pair of mating protrusions 1360 on one major side of the housing 1352. As may be seen in FIG. 71, the opposite major side of the structural shell 1354 in this embodiment is formed to have a corresponding pair of mating channels 1362 that can accept the mating protrusions 1360. As may also be seen in FIGS. 69 through 71, the end caps 1356 do not include either the mating protrusions 1360 or the corresponding mating channels 1362. The other device includes corresponding mating channels 1362 or mating protrusions 1360 on at least one of its sides (but again, not on its corresponding end caps), as illustrated in FIG. 73.

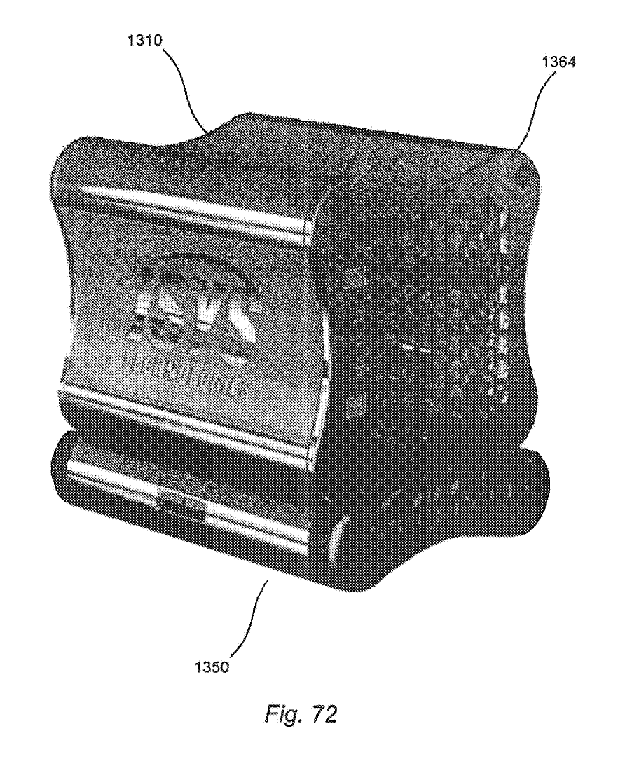

To structurally attach the modular device 1350 to some other device, such as computer device 1310 in the manner shown in FIG. 72, an end cap 1364 of the computer device 1310 is removed (tamper-resistant fasteners may be used to deter theft or vandalism), and the mating protrusions 1360 of the modular device 1350 are slidingly engaged with the corresponding mating channels 1362 of the computer device 1310. The modular device 1310 slides until it is fully mated with the computer device 1310. The end cap 1364 of the computer device 1310 is reattached to the computer device 1310 and thereby locks the modular device 1350 to the computer device 1310. Additional modular devices 1350 or other components may be attached to the system using the mating channels 1362 of either the modular device 1350 or of other sides of the computer device 1310 as desired, with the corresponding end cap (1356 or 1380) being removed to facilitate such attachment.

The illustrated embodiments shown in FIGS. 69-72 are merely illustrative of ways that embodiments may be constructed to permit structural connections between modules and with other devices. Thus, for example, while the illustrated housing 1352 has mating protrusions 1360 on one major side and mating channels 1362 on another major side, another embodiment may have mating channels 1362 on both major sides, as illustrated in the end view depiction of an alternate outer structural shell 1354 shown in FIG. 73.

The structural shell 1354 of the may be load bearing as disclosed in one or more of the related applications. The modular device 1350 may therefore be used as a mount from which to hang a monitor or other device, may be embedded or mounted in a wall, may be a part of a frame, and may perform any of the structural functions disclosed in the related applications. For example, a plate may be mounted to a wall and another plate may be mounted to a monitor, and the two plates may be connected together through the structural features of the modular device.

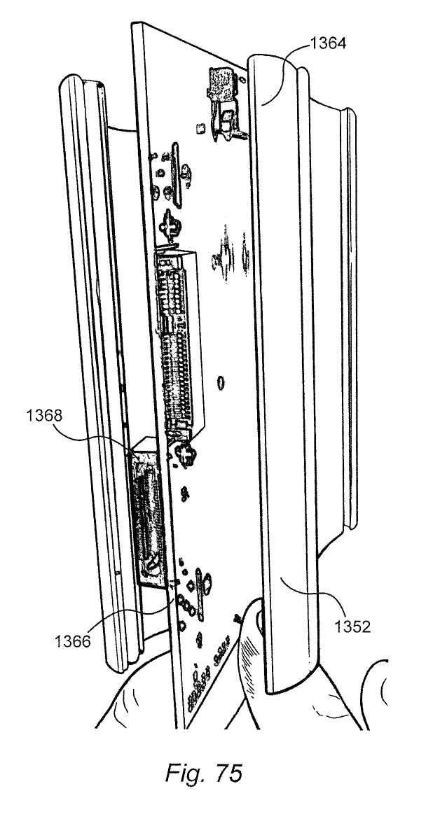

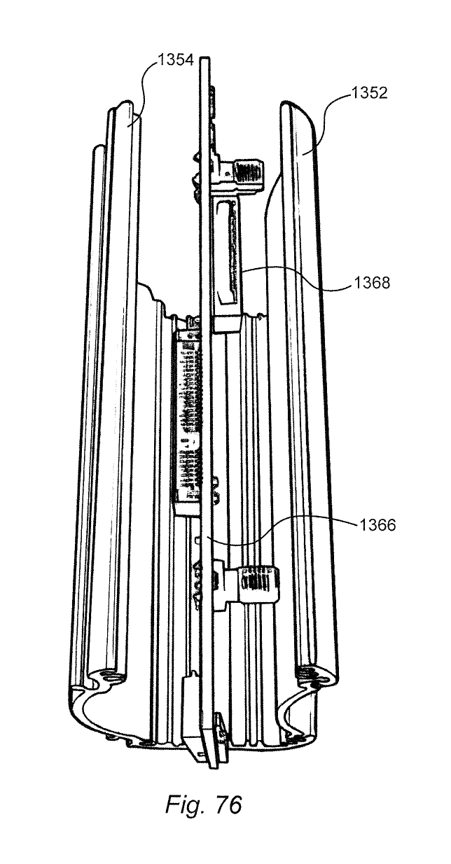

To allow the housing 1352 to contain multiple devices as illustrated in FIG. 68, embodiments of the invention utilize a bilateral printed circuit board (PCB 1366) that can be mounted within the housing 1352 as illustrated in FIGS. 74 through 76. The PCB 1366 may be mounted in a channel (not shown) or other mounting structure provided in the interior of the shell 1354 so as to be more-or-less centrally mounted within the housing 1352. The PCB 1366 provides both structural support for mounting any components or devices thereon and communicative coupling between any components or devices mounted thereon and to one or more ports 1368 or other communicative devices providing communication between the components or devices and any computer device communicatively connected to the modular device 1350.

The centralized mounting of the PCB 1366 permits mounting of components and/or devices on both sides of the PCB 1366 in a novel fashion. This mounting facilitates compact modular devices 1350 providing functionality not available in current devices. For example, in a modular device 1350 providing primarily storage functionality, mass storage devices 1326 may be mounted on both sides of the PCB 1366, thus providing for two mass storage devices 1326 within the same housing a single PCB 1366 in a compact amount of space. Meanwhile, if the storage capabilities of multiple mass storage devices 1326 are not needed, the same PCB 1366 may be used in conjunction with a single mass storage device 1326.

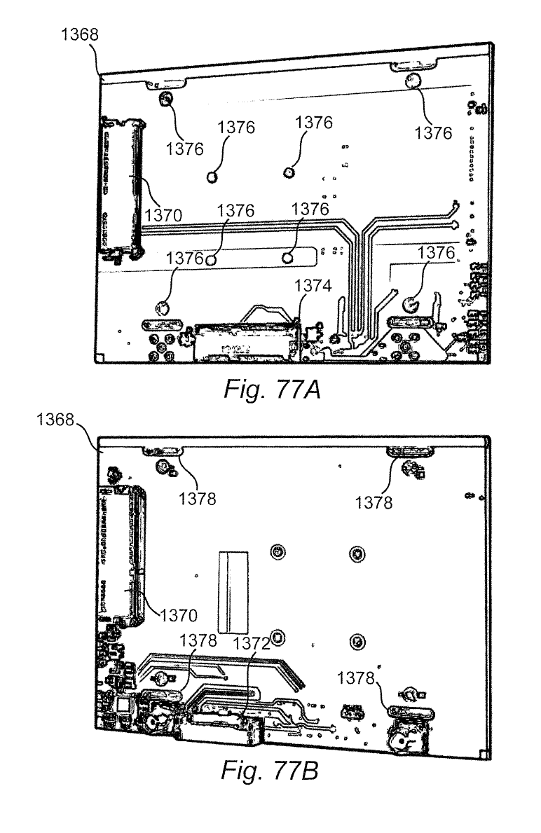

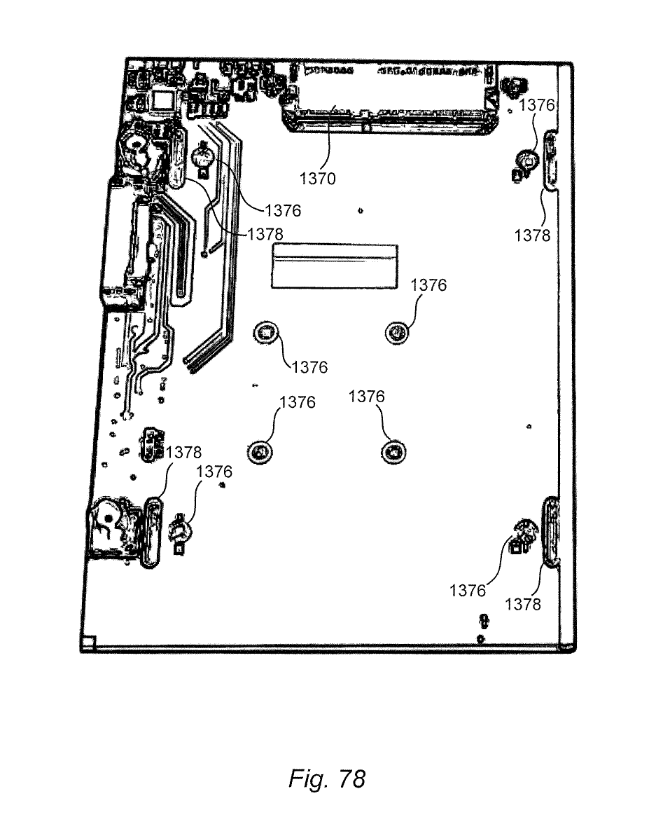

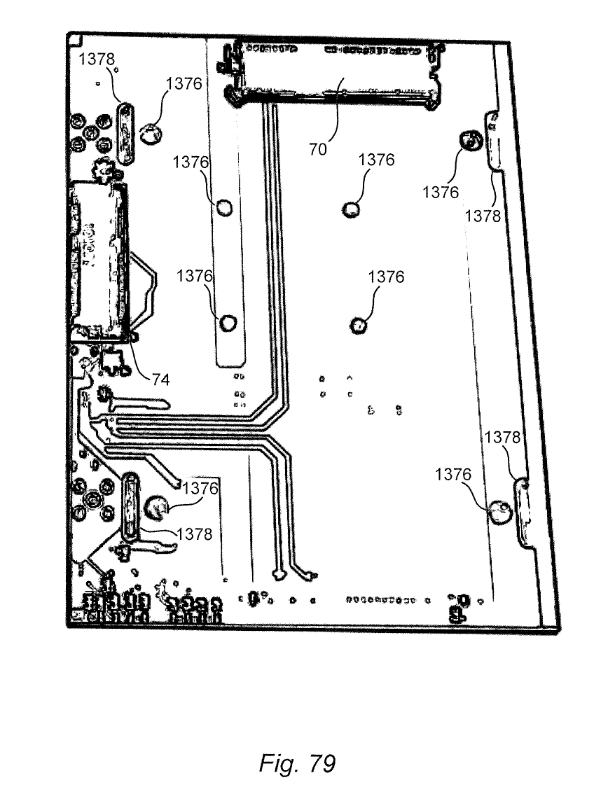

One manner in which this may be achieved may be appreciated by reference to FIGS. 77A through 79, which provide depictions of an exemplary embodiment of the PCB 1366. FIGS. 77A and 77B show a side-by-side comparison of front (FIG. 77B) and back (FIG. 77A) views of the PCB 1366, while FIG. 78 shows a larger view of just the front side and FIG. 79 show a larger view of just the back side of the PCB 1366. As may be seen in these Figures, a connector 1370 for connecting a mass storage device (such as a hard drive, solid-state drive, hybrid drive, and the like) is provided on each of the front and back sides of the PCB 1366. In the illustrated embodiment, the connectors 1370 are disposed to be on opposite longitudinal ends of the PCB 1366 as well as on opposite faces of the PCB 1366, but in other embodiments, the connectors 1370 may be disposed on a single longitudinal end.

One face of the PCB 1366 also includes a port connector 1372 that provides the port 1368 discussed previously. It should be noted that the illustrated port 1368 and/or port connector 1372 is merely intended to be illustrative: multiple ports 1368 and/or port connectors 1372 may be provided, these port(s) 68 and/or port connector(s) 1372 may be provided at other locations and/or sides of the PCB 1366, and any desirable type of port 1368 and/or port connector 1372 may be provided, or no port 1368 or port connector 1372 may be provided when some other communicative mechanism is to be used.

The other face of the PCB 1366 in the illustrated embodiment is provided with an additional device connector 1374 that may be similar or different from the connectors 1372. For example, the device connector 1374 may be of a type optimized for connection of devices other than mass storage devices. As with the port connector(s) 1372, the type, location, and number of the device connector(s) 1374 illustrated in FIGS. 77 to 79 is merely illustrative, and varying types and numbers of device connectors 1374 may be provided, including embodiments with no device connectors 1374.

To facilitate mounting of one or more devices to the PCB 1366, the PCB 1366 of the illustrated embodiment is provided with several features. The first feature is a plurality of direct mounting holes 1376 passing through the PCB 1366. The number and placement of the direct mounting holes 1376 illustrated in FIG. 77A is merely illustrative, and may be varied according to the specific needs of each embodiment. In certain embodiments, no direct mounting holes 1376 are provided, and in other embodiments, any number of direct mounting hole(s) 1376 greater than zero may be present.

The direct mounting holes 1376 may be used to mount a component or device directly to the PCB 1366. For example, in the illustrated example, the more-centrally located direct mounting holes 1376 may be used to mount a smaller component to one side of the PCB 1366 by way of inserting fasteners such as threaded fasteners through the direct mounting holes 1376 into corresponding threaded holes on the smaller component. The more-exterior direct mounting holes 1376 may be used to mount a larger component to the other side of the PCB 1366 by way of inserting fasteners through the direct mounting holes 1376 in the opposite direction into corresponding threaded holes on the larger component. As long as any potential short-circuit issues that could be potentially caused by contact of one of the mounted components to the fasteners are avoided (such as by spacers, insulation, etc., the direct mounting holes 1376 may be used to directly attach two components or devices in this fashion on opposite sides or faces of the PCB 1366.

Of course, it will be realized that where only a single component or device is needed, only one set of the direct mounting holes 1376 would be used and a component or device would only be located on a single side of the PCB 1366. The other side of the PCB 1366 would remain available for mounting of another device at a later time. Depending on the type of device(s) or component(s) and its/their communicative and/or power connection(s) to the PCB 1366, the mounting procedure may entail first inserting the device/component into the applicable connector(s) (e.g. connector 1370) and then securing the device/component to the PCB 1366, or it may entail separately making a communicative/power connection between the device/component and the applicable connector(s) either before or after mounting the device/component to the PCB 1366.

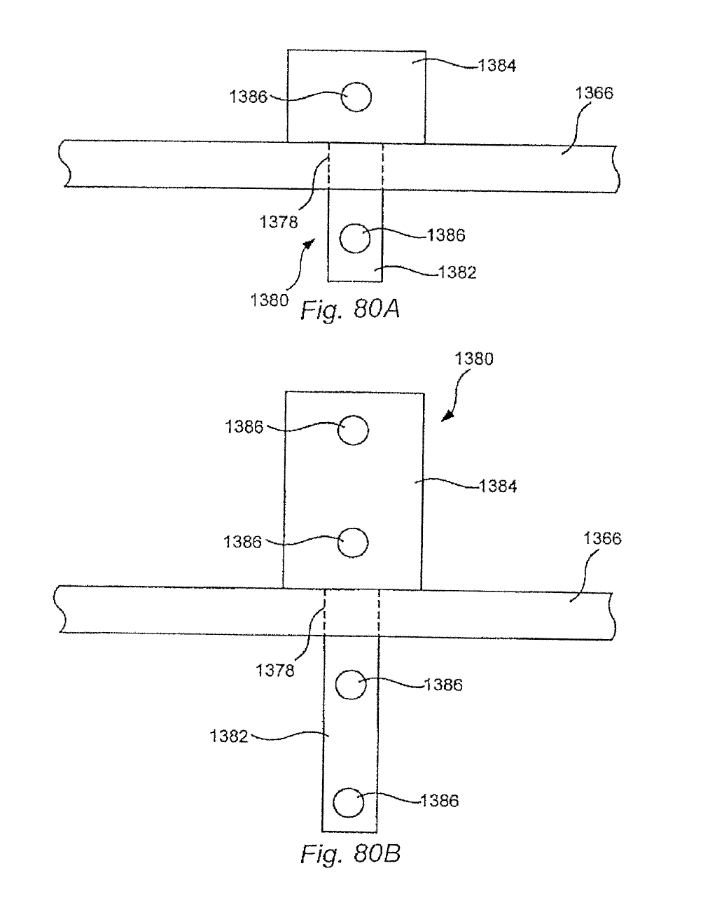

While the direct mounting holes 1376 may permit mounting of a wide variety of devices to the PCB 1366 and may even permit mounting of devices on both sides or faces of the PCB as discussed above, it is anticipated that it may not be possible to use the direct mounting holes 1376 to mount devices on both sides of the PCB 1366 in all circumstances. For example, the first-mounted component or device may obscure one or more needed direct mounting holes 1376, thereby preventing mounting of the second component or device. Therefore, embodiments of the invention utilize an indirect mounting slot 1378 as shown in FIGS. 77 to 79. The mounting slot 1378 is adapted to receive a T-shaped connector 1380 as shown in FIGS. 80A and 80B. The T-shaped connector 1380 is a flat element having a narrow end 1382 adapted to be inserted into and received by the indirect mounting slot 1378 and a wide end 1384 that is wider than the indirect mounting slot 1378. Thus, the narrow end 1382 of the T-shaped connector can be inserted into the indirect mounting slot 1378 until the wide end 1384 contacts the PCB 1366, stopping further entry of the T-shaped connector. In at least some embodiments, the T-shaped connector may be soldered into place after insertion into the indirect mounting slot 1378.

Both the narrow end 1382 and the wide end 1384 have at least one connector mounting hole 1386 therein. As illustrated in FIGS. 80A and 80B, different embodiments of the T-shaped connector may be provided with more or fewer connector mounting holes 1386 placed to be on each side of the PCB 1366. Of course, it will be appreciated that while the lower version of the T-shaped connector 1380 shown in FIG. 80B may permit the mounting of additional component(s) or device(s) on each side of the PCB 1366, it will require a housing 1352 of greater internal volume than the upper version of the T-shaped connector 1380 shown in FIG. 80A. The connector mounting holes 86 accept fasteners such as threaded fasteners therethrough and into one or more components to be mounted on the PCB 1366 indirectly by way of the T-shaped connector 80. While two embodiments of the T-shaped connector 1380 are shown in FIGS. 80A and 80B, other embodiments may have more connector mounting holes 1386 than the number shown, and still other embodiments may have differing numbers of connector mounting holes 1386 on the narrow end 1382 compared with the wide end 1384.

In certain embodiments, the T-shaped connectors 1380 may be used in conjunction with the direct mounting holes 1376 to mount multiple devices/components to opposite sides of the PCB 1366, or may be used independently from the direct mounting holes 1376 (if even present) to mount multiple devices/components to opposite sides of the PCB 1366. If the direct mounting holes 1376 are used, the first component is mounted to the PCB 1366 using the direct mounting holes 1376 first. Afterward, the T-shaped connectors 1380 are used to mount a second device on an opposite side of the PCB 1366. If the T-shaped connectors 1380 allow mounting of additional device(s)/component(s), it or they may be mounted in like fashion.

Many hard drives, for example, have threaded receptacles in both the bottom and sides of the hard drives. The bottom threaded receptacles may be used in conjunction with at least some of the direct mounting holes 1376, and the side threaded receptacles may be used in conjunction with at least some of the T-shaped connectors 1380. Of course, placement of the direct mounting holes 1376 and the indirect mounting slots 1378 may be chosen to facilitate mounting in the described fashions. As will be appreciated, the size of the modular device 1350, the PCB 1366, and the placement of the various holes and connectors may be varied as desired and selected in accordance with the anticipated devices/components to be used in the modular device 1350.

Embodiments of the invention may be used in a wide variety of fashions to provide advantages not currently available in the art. The additional three-dimensional connection arrangements provided by embodiments of the invention reduce the volume needed for equipment while still permitting adequate air flow and cooling capability. Additionally, such arrangements permit the connection of multiple devices of varying types within a single component as discussed above with respect to FIG. 68.

As another example, a modular device 1350 may be configured as a storage device. While the modular device 1350 may function essentially as a standard enclosure for a single mass storage device, the modular device 1350 may also provide, in a single package, storage options not currently available. For example, if the modular device 1350 is configured to contain up to two mass storage devices, a first mass storage device may be chosen according to first desirable performance or other characteristics, while the second mass storage device may be chosen according to second desirable performance or other characteristics. As one specific example, some users may desire the high performance characteristics of solid-state drives for storing operating systems (OSs) and application programs, while desiring the inexpensive large storage capability of spinning magnetic drives for storing all other data. Other users may desire only maximum capacity, while still other users may desire only maximum performance.

Embodiments of the invention cater to these specific desires in a flexible fashion. The modular device is simply provided with two drives: a solid state drive of appropriate capacity for the OS and application programs, and a spinning magnetic drive of appropriate size for the other data. Of course, different users may need different sizes of the two drives and may customizably select their drive capacities differently accordingly. Additional benefits are available as well: where existing hybrid drives usually have limited solid state capacity and can never have that capacity changed, any size of solid state drive may be initially chosen for the modular device 1350, and can easily be swapped out at a later point in time for a drive of a different size without requiring replacement of the entire modular device 1350. Similarly, if a user later needs additional capacity of the spinning magnetic drive or later desires the higher performance of a solid state drive, a similar change is made.

Another example may be realized by the combination of differing types of devices or components within the modular device 1350. For example, an embodiment may be provided that provides features associated with digital video recording (DVR) technology. Thus, one of the devices or components within the modular device 1350 may be a mass storage device, and another device or component may be a video capture component. In such an embodiment, a port may be provided to receive video signals (e.g. from an antenna or from a cable device), or an internal or external antenna may be attached to the modular device 1350.

As another example, a wireless card or device could be mounted on one side of the PCB 1366, and could allow the modular device 1350 to communicate wirelessly with one or more remote devices. Some embodiments may be provided with a graphics card or device mounted on one side of the PCB 1366 for outputting video signals. Indeed, any device that could be plugged into any port or connector provided on the PCB 1366 (e.g. mini PCI, mini PCIe, etc.). Supporting mechanical and electronic devices can be connected to the modular device 1350 as desired to provide additional features and functionality.

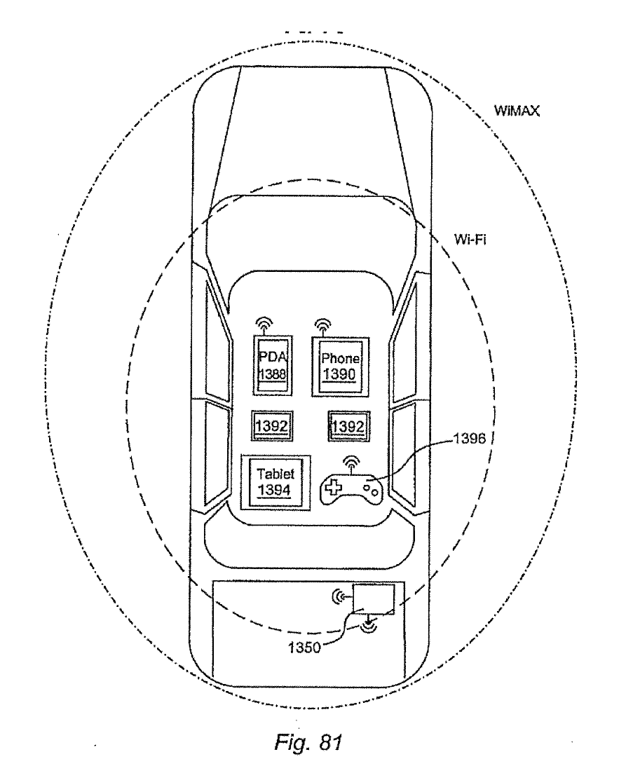

As another example, a modular device 1350 could be provided with a mass storage device and a dual-band wireless device on opposite sides of the PCB 1366. The dual-band wireless device may provide local WiFi connections to other devices in proximity of the modular device 1350 (e.g. PDA 1388, phone 1390, display 1392, tablet computer 1394 (or any other computing device), and controller 1396) while simultaneously providing longer-range WiMAX connections to permit accessing of external content, as illustrated in FIG. 81. Meanwhile, the mass storage device could provide storage and applications, including to external modules relying on the modular device 1350 for providing computing capabilities.

Thus, embodiments of the invention are capable of customization to provide the best of price and performance in a single package. Embodiments also permit pairing of functions within a single modular component that might not normally be available. Embodiments of the invention may be particularly useful with systems and methods described in some of the related applications.

### Software Installed on a Portable Hardware Device

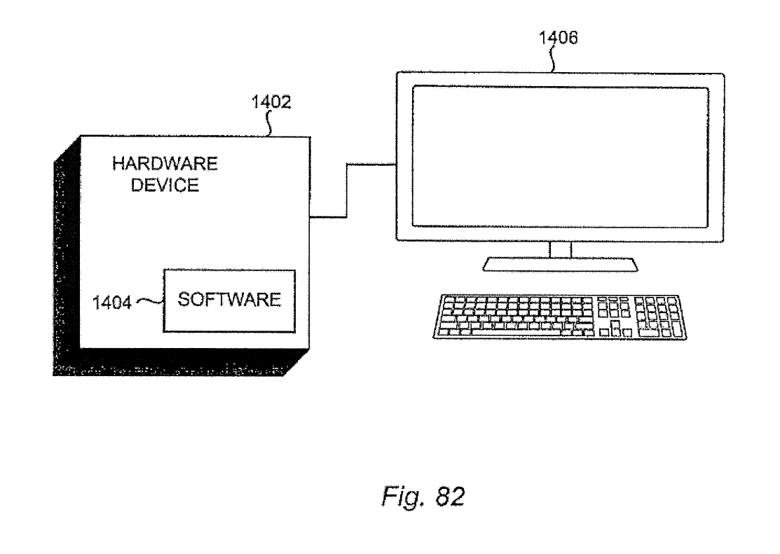

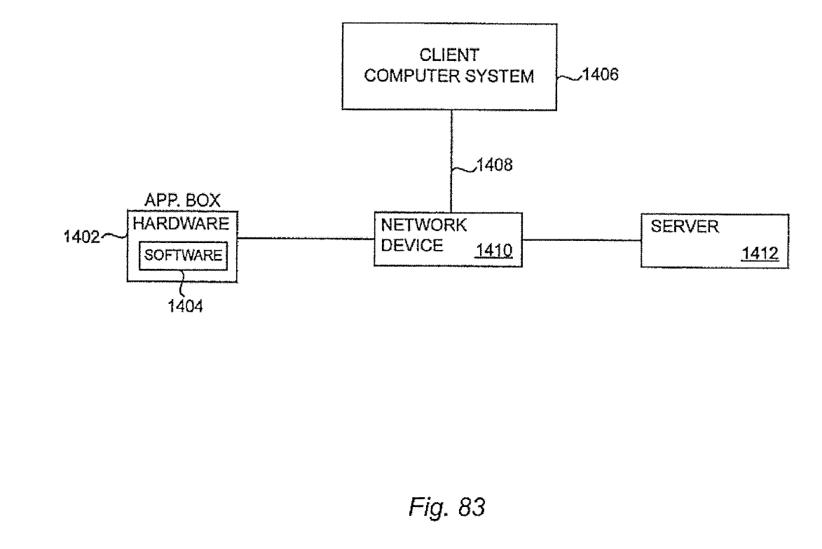

Reference will now be made to FIG. 82. This figure depicts a hardware device 1402 that is installed with a software application 1404. One advantage of this system is that the software application 1404 and the hardware device 1402 can be mobile, being able to connect and disconnect for various computer systems 1406 that can access the software application 1404 while it is connected to the hardware device 1402. Thus, the hardware device 1402 can connect to an individual computer system 1406 (as shown in FIG. 82) or a network computer system 1406 (as shown in FIG. 83) and provide each system with the ability to run the software application 1404 therefrom. In some embodiments, a process control unit 402, a modular device 1350, and/or other hardware device 1402 is preinstalled with the software application 1404. The software application 1404 can be installed onto a storage device or other component of the hardware device 1402.

In some embodiments, the software application 1404 has one or more security features which require it to remain on that specific hardware device 1402. For example, the one or more security features may disable the software application 1404 if it is removed from that specific hardware device 1402. In some instances, a software license of the software application 1404. is programmed to recognize the specific hardware device 1420 and disable it if it is tampered with or removed from that specific hardware device 1402. In other instances, the preinstalled software application 1404 can be removed from the hardware device 1402 and transferred to another hardware device 1402.

In some embodiments, the hardware device 1402 includes two or more software applications 1404 installed thereon. These software applications 1404 can be related. For instance, the two or more software applications 1404 can be related to finances, design, email, etc. The inclusion of two or more software applications 1404 on a single hardware device 1402 can maximize the use of the single hardware device 1402 and organize the network resources into a single device. Furthermore, the two or more software applications 1404 can be interdependent or used together.

As shown in FIG. 1, in some embodiments, the hardware device 1402 is electronically connected to another computer system 1406, such as a personal computer. For example, the hardware device 1402 can be connected to the computer system 1406 via a USB port or other like port. The computer system 1406 can access the hardware device 1402 and run the software application 1404 from the hardware device 1402 without the need of installing the software application 1404 on the hardware device 1402. In some configurations, the computer system 1406 recognizes the hardware device 1402 as a separate drive, which communicates the software application 1404 to the personal computer system 1406. Additionally, the hardware device 1042 can be disconnected from this first computer system 1406 and connected to a second computer system 1406. In this way, the hardware device 1402 can provide mobile software that may be used by any computer system 1406 that is connected to the hardware device 1402. This system can be particularly useful with expensive software programs or hardware intensive programs (as explained below) that are expensive to install on multiple computers.

The functionality described above can be enhanced when the hardware device includes processing capabilities and the software application 1204 is run on the hardware device 1402. In some embodiments, as stated above, the hardware device 1402 is a process control unit 402, as described herein, having a processor, memory, storage, BIOS, and an operating system. As such, the hardware device 1402 is capable of running the software application 1404 independently from the computer system 1406. In some embodiments, the hardware device 1402 is customized to have the necessary components needed to run the software application. Thus, with simple software applications that have low hardware requirements, the hardware device 1402 can be configured with components that meet but not substantially exceed these low requirements, thus saving cost. In other instances, other programs may be hardware intensive, requiring relatively large amounts of processing power, storage, memory, video processing, etc In such instances, the hardware device 1402 can be configured with the necessary components. As such, in some configurations, the hardware device 1402 is customized, or customizeable to be software application specific. Thus, this system can be used to run hardware intensive software programs 1404 on systems that would not be independently capable of running such programs.

In a non-limiting example, the hardware device 1402 is a process control unit 402 having a processor, memory, storage, and I/O. The process control unit 402 is coupled to the computer system 1406 via a port, such as a USB port, and connection 1408. The hardware device 1402 stores and runs a hardware intensive software application 1404, such as an engineering drawing software application 1404. The hardware device 1402 is configured with the necessary components needed to run the software application, which might include processing and memory intensive functions. Thus configured, the hardware device 1402 can the connected to the computer system 1406, which access the software application 1404 and use the software application 1404 as it runs on the hardware device 1402. In this example, the hardware device 1402 runs the software application 1404, which is merely displayed on the computer system 1406 and controlled via the computer system 1406. In some instances, a user can store engineering drawing files, or other data related to the software application 1404 on the hardware device 1402. One of the benefits of the hardware device 1402 is that it can be disconnected from the computer system 1406 and connected to a separate computer system 1406, which subsequently run the software application 1404. Thus, as stated above, this system can be useful with expensive software applications, since the single software application can be used on multiple computer system 1406 with only a single license.

In some embodiments, as will be understood, a user may upgrade the entire hardware device 1402 rather than upgrade the software application 1402. Alternatively, the user may upgrade the software application 1402 or upgrade a portion of the hardware device 1402, such as one of the modular motherboard components, as described above.

FIG. 83 illustrates an embodiment of the hardware device 1402 in a network system. When used in a network, the hardware device 1402 can be accessed by multiple client computer systems 1406 either simultaneously or one at a time. The software application 1404 can function as if it were running on a traditional network device, such as a server 1412 when connected to the client computer systems 1406. The separation of this software application 1404 from the server 1412 can provide numerous benefit to the network, as explained below.

As shown, the hardware device 1402, which may be referred to as an App Box, is indirectly connected to a client computer system 1406. A network device 1410 is disposed between the hardware device 1402 and the client computer system 1406. The network device 1410 may direct network traffic between devices on the network. In some embodiments, the network device 1410 is a switch or other such device. The network also includes a server 1412 that is also in communication with the network device 1410.

Since the software application 1404 is installed on a separate hardware device 1402, rather than on the server 1412, the software application 1402 can avoid the many software and/or hardware conflicts that can result in networking systems running on multiple devices and running multiple software applications. This is due to the fact that the software application 1404 is run on a separate device, the hardware device 1402. This separation can limit or eliminate the likelihood that the software application 1404 and/or the hardware device 1402 is infected by computer viruses, worms, Trojan horses, spyware, dishonest adware, scare ware, crime ware, or other form of malware or unwanted software or program.

In some embodiments, a large part of entire network system, or the entire network system itself could be replaced with multiple hardware devices 1402, each having one or more network software applications 1404 used by client computer systems 1406. Thus, in some configuration, one hardware device 1402 contains hardware components and software applications 1404 for a network email system, while another hardware device 1402 contains hardware components and software applications 1404 for a document storage system. Other such network systems can be made to reduce the need or demand on a single serve 1412. Thus, in some instances, the need for a server room is replaced by the ability to locate various App Boxes at various location on a network.

### Providing a Search Appliance Using Modular Devices

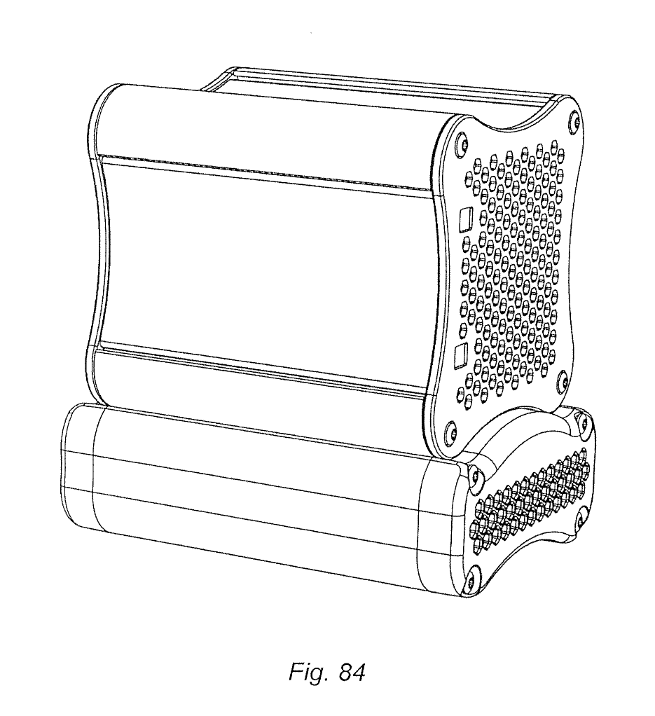

In according with at least some embodiments of the present invention, a dynamic search appliance is provided. By way of example, reference is made to FIG. 84, which provides a representative application search appliance in accordance with an embodiment of the present invention. In FIG. 84 a computer device is operably connected to a modular device, which provides storage.

In accordance with at least some embodiments, a search appliance comprises a gathering component, a standardizing component, a data storage area, a search component, a user interface component, and a management interface component. The gathering component is, for example, a network (including web) or file crawler that goes out on a network or the Internet and gathers files and data from specified locations. This may include shared directories, personal directories, databases, web pages, and other locations were a user, group, entity or enterprise would store data, files or information. The crawler can copy files to the search appliance or may only copy the metadata about the files/information. A standardizing component takes the data from the gathering component and transposes it into a standardized format for storage in the data storage component. It then places it in the data storage area. The data storage component holds metadata about the files and can also contain copies of the actual files or data as well as the metadata about the files. The search component searches through the stored metadata from the files and provides the information to the search interface in the form of query results. It also provides links to the copies of the files stored on the search appliance, or provides links to the original files in the source locations. The search interface is the component where users compose their search queries. It provides instructions to the search component and displays query results to the user. The management interface lets the user or administrator(s) manage accounts, permissions, adding and deleting search indexes, crawl job scheduling, and other relevant functions.

In at least some embodiments, a personal search appliance is provided for a particular user, device, company, group, or entity. The search appliance provides a search on private and/or public networks and/or data locations and provides results for the particular user, device, company, group, or entity. In some embodiments, the search appliance is accessed remotely. In other embodiments, the search appliance is accessed remotedly, such as over a network—such as a public or private network. In one embodiment, a user utilizes a first device to access the personal search appliance over a network, for example through the use of an address or identification. In some embodiments, the personal search appliance requires authentication of the particular use to allow for access, such as providing a user name and password, or other authentication methodology. The personal search appliance performs the search and displays the results. For example, the personal search appliance gathers information from private and/or public locations and provides the search results to the user. The personal search appliance searches, for example, websites the user visits, data that only the user can obtain, personal data (pictures, videos, media, music, files, text, documents, information, etc.), and other information or locations that are particular to the user, device, company, group, or entity. In another example, the personal search appliance gathers information from private and/or public locations of a particular entity and provides the search results to the authenticated user. Examples include accounting information, websites of the entity, data that only the entity can obtain (whether locally or remotely), personal data of the entity (pictures, videos, media, music, files, text, documents, information, etc.), and other information or locations that are particular to the entity. The search appliance is controlled by the particular user, device, company, group, or entity.

In at least some embodiments, the personal search appliance includes the appliance, index software, a management console, a crawler, and access data types.

### Providing Computing Resources Using Modular Devices

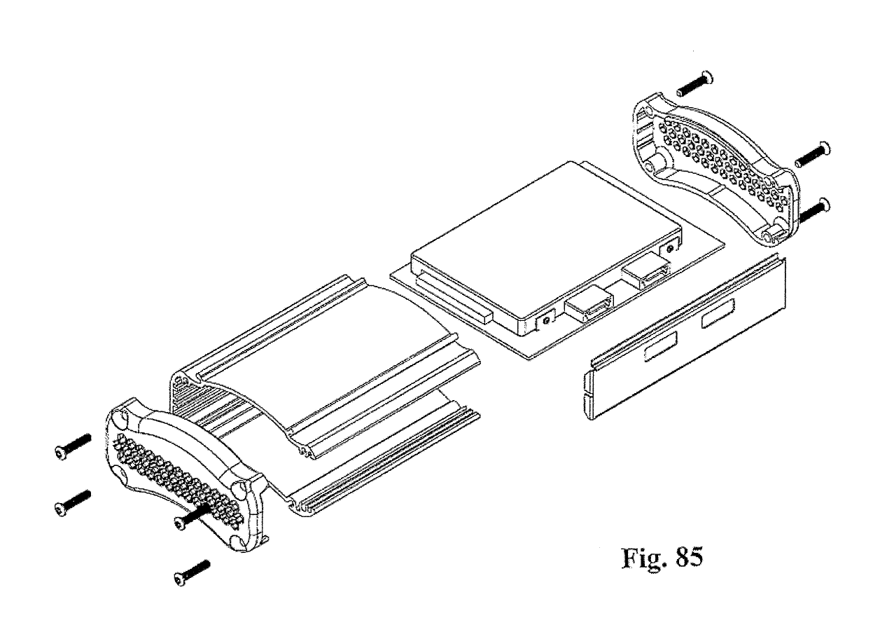

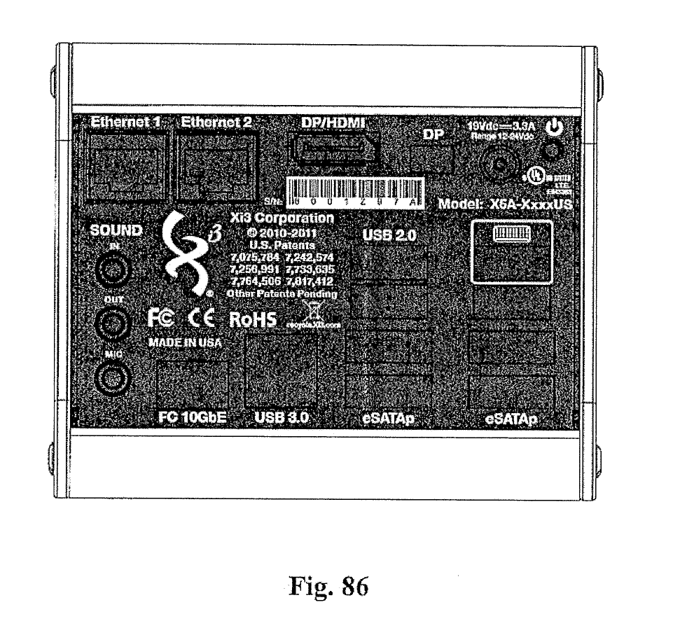

With reference now to FIG. 85, an exploded view of a representative modular device is provided. As provided above, at least some modular devices are configured as storage devices. The modular device of FIG. 85 includes a chassis, endplates, and a back plane having one or more ports, interfaces and/or logic. The modular device may function essentially as a standard enclosure for a single mass storage device. The modular device may also provide, in a single package, storage options not currently available. For example, if the modular device is configured to contain up to two mass storage devices, a first mass storage device may be chosen according to first desirable performance or other characteristics, while the second mass storage device may be chosen according to second desirable performance or other characteristics. As one specific example, some users may desire the high performance characteristics of solid-state drives for storing operating systems and application programs, while desiring the inexpensive large storage capability of spinning magnetic drives for storing all other data. Other users may desire only maximum capacity, while still other users may desire only maximum performance.

Embodiments of the present invention cater to these specific desires in a flexible fashion. The modular device is simply provided with two drives: a solid state drive of appropriate capacity for the operating system and application programs, and a spinning magnetic drive of appropriate size for the other data. Of course, different users may need different sizes of the two drives and may customizably select their drive capacities differently accordingly. Additional benefits are available as well: where existing hybrid drives usually have limited solid state capacity and can never have that capacity changed, any size of solid state drive may be initially chosen for the modular device, and can easily be swapped out at a later point in time for a drive of a different size without requiring replacement of the entire modular device. Similarly, if a user later needs additional capacity of the spinning magnetic drive or later desires the higher performance of a solid state drive, a similar change is made.

### Dynamic Computer Device with Efficient and Useful I/O

FIG. 86 is a representative embodiment of a dynamic computer device. The representative device comprises a plurality of network cards. Additionally, the device comprises ports that allow for multiple functionality and/or connection. For example a of ports are provided that allow for eSATA or USB connection via a single port. Similarly a single port is provided that allows for display port or HDMI connection. Increased density, functionality, and customizability is provided.

The representative devices includes audio input and output ports, optical input and/or output ports, lazerwire ports, and other ports as desired for particular functionality.

In at least some embodiments, the particular ports and/or connections are selected and provided on a dynamic backplane that allows for customizability and ease of use.

In some embodiments, the illustrated device is used as a server device. In some embodiments, a plurality of devices are operably connected to provide a server system.

### Limiter or Delay Circuit

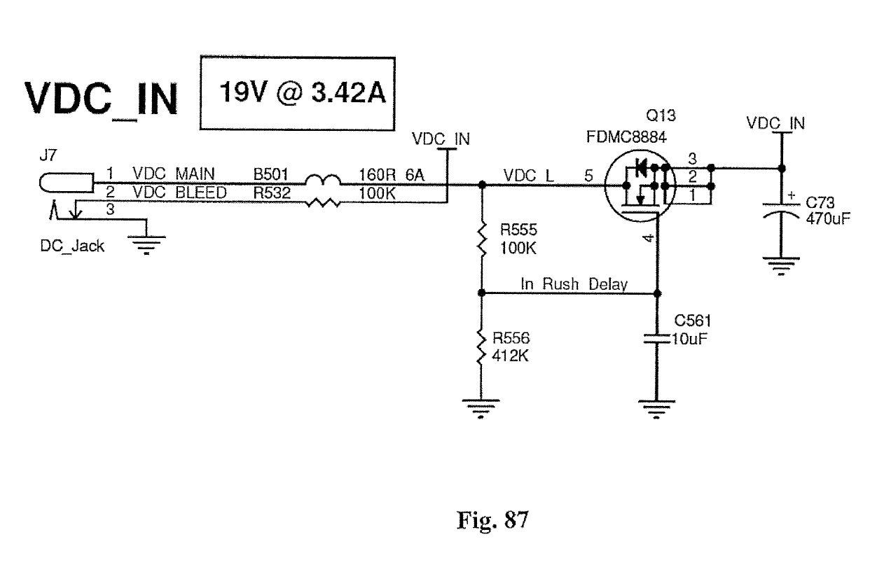

FIG. 87 is a representative circuit to limit in-rush current n accordance with an embodiment of the present invention. When a circuit is plugged into a power source, there is an in-rush of current to charge all of the discharged capacitors on that connection. When discharged, Capacitors have 0-ohm resistance so this incoming DC power sees the capacitor as a direct short to ground. Accordingly, when plugging in the power cord a spark can be seen jumping to the plug contacts. Thus, a switch or open circuit is introduced between the power plug and the circuits capacitors until the plug can be plugged in completely. At that point the switch is closed to allow the power to charge the capacitors. This delays the in-rush current until the plug can be fully inserted and places the in-rush current at the switch source.

In one embodiment, a high-current MOSFET (Q13) is used which acts like a switch with very low resistance when turned on so that it doesn't drop the incoming voltage and reduces the heat generated by the part. The “Gate” of the MOSFET is attached to a Resistor-Capacitor Charge circuit (R555/C561) which requires time for the voltage to pass through the high-resistance to charge the capacitor. This high-resistance prevents the Gate capacitor itself from being a source of in-rush current. Once the capacitor charges up to the voltage required for the MOSFET to turn on, it switches on and power then flows from the power connector to the circuit. Voltage divider resistors (R555/R556) are used to set the gate voltage on the MOSFET to get the minimum Resistance between the Drain and Source of the MOSFET when switched on (Rds-On) and prevent exceeding the maximum gate voltage and causing damage to the MOSFET. Another embodiment uses a op-amp to gradually enable the MOSFET or other switching source so that the incoming power is slowly enabled.

A bleed resistor (R532) allows the capacitors in the circuit to discharge to ground should the power plug be removed while the circuit is powered up. A high-current ferrite bead (B501) helps block high-frequency noise from leaving the circuit and running into the incoming power. This is prevents circuit noise from coupling to the external power source by the FCC. A large incoming power capacitor (C73) provides a excess of energy to smooth out power fluctuations and for low frequency noise to couple to ground.

These illustrations are merely exemplary of the capabilities of one or more modular processing units in accordance with embodiments of the present invention. Indeed, while illustrative embodiments of the invention have been described herein, the present invention is not limited to the various preferred embodiments described herein, but rather includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” is expressly recited; and b) a corresponding function is expressly recited.

The present invention may be embodied in other specific forms without departing from its spirit or essential characteristics. The described embodiments and examples are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A modular motherboard comprising:
a first electronic circuit board performing a first function; and
a second electronic circuit board performing a second function, wherein the first and second boards are operably connected to provide an integrated logic board for a computer system.
